(19) United States
(12) Patent Application Publication
(10) Pub. No.: US 2008/0280779 A1
(43) Pub. Date: Nov. 13, 2008

(54) Gene expression profiling based identification of genomic signatures of multiple myeloma and uses thereof

(76) Inventors: John D. Shaughnessy, JR., Roland, AR (US); Bart Barlogie, Little Rock, AR (US); Fenghuang Zhan, Little Rock, AR (US)

Correspondence Address: Benjamin Aaron Adler;ADLER & ASSOCIATES, 8011 Candle Lane, Houston, TX, 77071, US

(21) Appl. No.: 11/904,151

(22) Filed: Sep. 26, 2007

Related U.S. Application Data
(60) Provisional application No. 60/847,220, filed on Sep. 26, 2006.

(51) Int. Cl. C40B 30/06

(52) U.S. Cl. 506/10

(57) ABSTRACT

Monoclonal gammopathy of undetermined significance can progress to multiple myeloma. Applying significance analysis of microarrays, 52 genes, involved in important pathways related to cancer, were differentially expressed between plasma cells from healthy subjects and patients with stringently defined monoclonal gammopathy of undetermined significance/smoldering multiple myeloma and symptomatic multiple myeloma. Unsupervised hierarchical clustering of 351 multiple myeloma and 44 cases of monoclonal gammopathy of undetermined significance and 16 cases of multiple myeloma with a monoclonal gammopathy of undetermined significance history, created two major cluster branches, one containing 82% of the monoclonal gammopathy of undetermined significance cases and 28% of the multiple myeloma, termed monoclonal gammopathy of undetermined significance-like multiple myeloma. Using the same clustering approach on an independent cohort of 213 cases of multiple myeloma revealed 27% with monoclonal gammopathy of undetermined significance-like multiple myeloma which, despite a lower incidence of complete remission, was associated with low-risk clinical and molecular features and superior survival. The monoclonal gammopathy of undetermined significance-like multiple myeloma signature was also seen in patients surviving more than 10 years after autotransplant.

### CROSS REFERENCE TO RELATED APPLICATION

This non-provisional application claims benefit of provisional application U.S. Ser. No. 60/847,220 filed on Sep. 26, 2006 now abandoned.

### FEDERAL FUNDING LEGEND

This invention was produced using funds under grant no. CA55819 and CA97513 from the National Institutes of Health. Accordingly, the Federal government has certain rights in this invention.

### BACKGROUND OF THE INVENTION

1. Field of the Invention

The present invention generally relates to the field of cancer research. More specifically, the present invention relates to the use of gene expression profiling to identify genomic signatures specific for benign monoclonal gammopathy of undetermined significance present in multiple myeloma useful for predicting clinical outcome and survival.

2. Description of the Related Art

Multiple myeloma is a prototypical clonal B-cell malignancy with a terminally differentiated plasma cell phenotype. According to longitudinal follow-up of residents of Olmsted County, there is a 1% annual rate of progression to multiple myeloma from monoclonal gammopathy of undetermined significance. This clinically benign condition, with distinct neoplastic features such as aneuploidy, increases in frequency with advancing age reaching 5.3% in persons 70 yr and older. Although the median age is approximately 70 yr, multiple myeloma has been diagnosed in teenagers with clinical features and clinical course resembling those of the elderly. Family clusters of multiple myeloma have also been reported, but exposure to chemical and physical carcinogens is generally considered etiological in multiple myeloma; however Human herpesvirus 8 infection of dendritic cells could not be confirmed. In the case of the nuclear fall-out from the atomic bombs, a long latency phase of 15 to 20 years passed before an increase in multiple myeloma incidence was documented in Japan. Thus, it is plausible to assume that younger patients are likely to develop multiple myeloma more acutely while a smoldering clinical course has been frequently documented to precede the onset of symptomatic multiple myeloma in the elderly. Smoldering multiple myeloma can be considered as an advanced phase of monoclonal gammopathy of undetermined significance; even at the time of progression, smoldering multiple myeloma-evolved multiple myeloma usually lacks osteolytic lesions or other cardinal features of symptomatic multiple myeloma. Multiple myeloma remains hypo-proliferative with a long life span of malignant B-cells that assumes high-grade proliferative features only in the terminal phase, from which all human multiple myeloma cell lines have been derived. The majority of genetic lesions typical of multiple myeloma are already present at the monoclonal gammopathy of undetermined significance stage.

While these genetic abnormalities can only be detected in interphase cells in monoclonal gammopathy of undetermined significance, their detection by metaphase karyotyping in one-third of cases with multiple myeloma reflects an increased mitotic activity (possibly reflecting the ability of cells to proliferate outside the confines of the bone marrow milieu) and confers an adverse prognosis. While gene expression profiling of CD138-selected cells from bone marrow aspirates can discern between plasma cells from normal subjects and those from patients with multiple myeloma, it has been difficult to distinguish between plasma cells from multiple myeloma and monoclonal gammopathy of undetermined significance.

Although, monoclonal gammopathy of undetermined significance progression to multiple myeloma is reported to occur at a very low annual frequency (˜1%), little is known about the proportion of patients whose multiple myeloma has evolved from this precursor condition. The prior art is deficient in methods of identifying these distinct and prognostically relevant clinical subgroups of multiple myeloma. The present invention fulfills this long-standing need and desire in the art.

### SUMMARY OF THE INVENTION

The present invention is directed to a method of gene expression profiling to identify genomic signatures specific for a disease by hybridization of nucleic acid obtained from normal individuals, individuals diagnosed with monoclonal gammopathy of undetermined significance and individuals diagnosed with multiple myeloma, with a DNA microarray and performing comparative analysis on data thus obtained where the analysis identifies specific genomic signatures for said disease.

The present invention is further directed to a method of predicting clinical outcome and survival of an individual, based on the genomic signature of multiple myeloma and monoclonal gammopathy of undetermined significance, its precursor form. The genomic signature is identified by gene expression profiling as discussed supra. The data obtained from the gene expression profiling in said individual is subjected to significance analysis of microarray and unsupervised hierarchical clustering analysis. This analysis classifies subsets of multiple myeloma as monoclonal gammopathy of undetermined significance-like multiple myeloma (MGUS-L MM), non-monoclonal gammopathy of undetermined significance-like multiple myeloma (non-MGUS-L MM) or multiple myeloma-like monoclonal gammopathy of undetermined significance (MM-L MGUS), thereby predicting clinical outcome and survival of the individual. Furthermore, the present invention teaches a method of correlating genomic signatures of multiple myeloma to the molecular classification of the disease to identify subsets of disease evolved from its precursor form, monoclonal gammopathy of undetermined significance or smoldering multiple myeloma.

The present invention is further directed to a method of predicting, clinical outcome and survival in an individual diagnosed with multiple myeloma or relapsed multiple myeloma by correlating the gene expression signature of multiple myeloma with amplification of gene copy number on various chromosomes, where the correlation predicts the clinical outcome and survival of said individual. Furthermore, the present invention is directed to a method of selecting treatment for an individual diagnosed with a disease, by identifying a specific genomic signature for the disease, based on gene expression profiling, to determine a treatment strategy for the disease.

### BRIEF DESCRIPTION OF THE DRAWINGS

FIG. 1. Expression patterns of 52 genes differentially expressed in plasma cells of normal donors and subjects with monoclonal gammopathy of undetermined significance. Two-dimensional unsupervised hierarchical cluster analysis of 52 genes (rows) in CD138-enriched plasma cells from 22 healthy donors (normal plasma cells, NPC) and 24 monoclonal gammopathy of undetermined significance cases (columns). A mean-centered gene expression is depicted by a normalized-signal pseudo-color scale as described (Eisen M, 1998). Red and green indicate over-expressed and under-expressed genes, respectively. The sample dendrogram at the top, reflecting relatedness among samples, consists of two major branches defined by over-expressed and under-expressed genes. The left branch consists of 22 monoclonal gammopathy of undetermined significance samples (horizontal blue bar) and two normal plasma cells cases (green arrows) while the right branch contains all normal plasma cells (horizontal green bar) and a subset of two monoclonal gammopathy of undetermined significance samples (blue arrows).

FIG. 2. Expression patterns of 52 genes segregate monoclonal gammopathy of undetermined significance and monoclonal gammopathy of undetermined significance-like-L multiple myeloma from non-monoclonal gammopathy of undetermined significance-like-L multiple myeloma. Two-dimensional unsupervised hierarchical cluster analysis of 52 monoclonal gammopathy of undetermined significance genes (rows) in CD138-enriched plasma cells of monoclonal gammopathy of undetermined significance (n=56), multiple myeloma evolved from monoclonal gammopathy of undetermined significance (n=16) and newly diagnosed multiple myeloma (n=351) (columns). The left branch consists of monoclonal gammopathy of undetermined significance monoclonal gammopathy of undetermined significance and monoclonal gammopathy of undetermined significance-like multiple myeloma samples (green bar) while the right branch contains the non-monoclonal gammopathy of undetermined significance-like multiple myeloma samples (red bar). The green arrows in the non-monoclonal gammopathy of undetermined significance-like multiple myeloma branch represent monoclonal gammopathy of undetermined significance cases.

FIG. 3. Expression levels of the 52 monoclonal gammopathy of undetermined significance genes in plasma cells of normal donors, and subjects with monoclonal gammopathy of undetermined significance and multiple myeloma. A color-gram is shown of the expression of the 52 genes in normal plasma cells (n=22), monoclonal gammopathy of undetermined significance and multiple myeloma from monoclonal gammopathy of undetermined significance (n=72) and multiple myeloma (n=351) (based on their location in either of the two major branches of the dendrogram in FIG. 2) and multiple myeloma cell lines (MMCL) (n=22). “monoclonal gammopathy of undetermined significance” and “multiple myeloma from monoclonal gammopathy of undetermined significance” on the left side of the figure represent those cases clustering in the monoclonal gammopathy of undetermined significance-like multiple myeloma branch of FIG. 2, while those on the right side are those clustering with the non-monoclonal gammopathy of undetermined significance-like multiple myeloma branch. Genes are indicated along the vertical axis and samples on the horizontal axis. The normalized expression value for each gene is indicated by a color, with red representing high expression and blue representing low expression. Note that normal plasma cells have a distinct pattern of over-expressed and under-expressed genes that progressively inverts with transition to monoclonal gammopathy of undetermined significance, monoclonal gammopathy of undetermined significance-like multiple myeloma, and non-monoclonal gammopathy of undetermined significance-like multiple myeloma and finally to multiple myeloma cell lines.

FIG. 4. Box plots of expression profiles of genes exhibiting common patterns. The expression levels of select genes exhibiting progressive loss (top three panels), progressive increase (middle three panels), or increased followed by decreased expression (bottom three panels) across the sample groups as ordered in FIG. 2. Sample groups are along the x-axis and the natural log transformed Affymetrix derived “signal” is plotted on the y-axis. The top, bottom and middle lines of each box correspond to the 75^{th} percentile (top quartile), 25^{th} percentile (bottom quartile) and 50^{th} percentile (median), respectively. The whiskers extend from the 10^{th} percentile (bottom decile) and top 90^{th} percentile (top decile). Open circles denote outliers within each group. The “monoclonal gammopathy of undetermined significance” and “multiple myeloma from monoclonal gammopathy of undetermined significance” on the left side of the figure represent those cases clustering in the monoclonal gammopathy of undetermined significance-like multiple myeloma branch of FIG. 2, while those on the right side are those clustering with the non-monoclonal gammopathy of undetermined significance-like multiple myeloma branch.

FIG. 5A-5B. Superior overall survival in monoclonal gammopathy of undetermined significance-like multiple myeloma and non-monoclonal gammopathy of undetermined significance-like multiple myeloma lacking amp1q21. FIG. 5A shows Kaplan-Meier estimates of overall survival in monoclonal gammopathy of undetermined significance-like multiple myeloma and non-monoclonal gammopathy of undetermined significance-like multiple myeloma demonstrated superior 5-yr actuarial probabilities of event-free survival (64% v. 44%, P=0.001) and overall survival (76% v. 59%, P=0.009) in patients with monoclonal gammopathy of undetermined significance signature. FIG. 5B shows Kaplan-Meier estimates of overall survival in monoclonal gammopathy of undetermined significance-like and non-monoclonal gammopathy of undetermined significance-like multiple myeloma according to the presence of amp1q21 by inter-phase fluorescence in situ hybridization. Amp1q21 was not a significant adverse parameter in monoclonal gammopathy of undetermined significance-like multiple myeloma but identified a high-risk group among patients with non-monoclonal gammopathy of undetermined significance-like multiple myeloma.

FIG. 6. Monoclonal gammopathy of undetermined significance-like signature is discernable in a test cohort of newly diagnosed multiple myeloma enrolled in Total Therapy 3. As in FIG. 2, a two-dimensional unsupervised hierarchical cluster analysis of 52 genes (rows) in CD138-enriched plasma cells from monoclonal gammopathy of undetermined significance (n=56), multiple myeloma evolved from monoclonal gammopathy of undetermined significance (n=16) and newly diagnosed multiple myeloma (n=213). Green arrows represent monoclonal gammopathy of undetermined significance cases clustering with so-called non-monoclonal gammopathy of undetermined significance-like multiple myeloma.

FIG. 7. Monoclonal gammopathy of undetermined significance-like signature is present in the majority of plasma cells of greater than 10 year survivors of Total Therapy 1. As in FIG. 2, a two-dimensional unsupervised hierarchical cluster analysis of 52 genes (rows) in CD138-enriched plasma cells from monoclonal gammopathy of undetermined significance (n=56), multiple myeloma from monoclonal gammopathy of undetermined significance (n=16) and newly diagnosed multiple myeloma (n=351, training cohort) and 20 long-term survivors (columns). Green arrows indicate the samples from the 20 long-term survivor.

### DETAILED DESCRIPTION OF THE INVENTION

This is the first report on genomic differences recognized by global gene expression profiling using a comparative analysis between multiple myeloma and its precursor conditions monoclonal gammopathy of undetermined significance and smoldering multiple myeloma. In an earlier report with a smaller number of cases and utilizing a first generation microarray, normal plasma cells could be distinguished from plasma cells of multiple myeloma and monoclonal gammopathy of undetermined significance combined, however the gene expression profiling was indistinguishable using plasma cells of multiple myeloma and monoclonal gammopathy of undetermined significance.

The similarity in the transcriptome between monoclonal gammopathy of undetermined significance and multiple myeloma was puzzling, as most cases of monoclonal gammopathy of undetermined significance remain clinically benign (Kyle R A, et al., 2002; Kyle R A, et al., 2006). Upon application of more sophisticated data mining approaches to a larger sample number utilizing a third generation microarray with more than 54,000 gene features, we identified differential expression of genes with roles in pathways related to cancer in normal plasma cells, and those with monoclonal gammopathy of undetermined significance and with multiple myeloma.

Although monoclonal gammopathy of undetermined significance progresses to multiple myeloma at a low annual frequency of 1%, little is known about the proportion of patients whose multiple myeloma has evolved from this precursor condition. Using unsupervised hierarchical clustering of the 52 genes differentially expressed in monoclonal gammopathy of undetermined significance and multiple myeloma, a subset of monoclonal gammopathy of undetermined significance-like multiple myeloma with favorable clinical features and longer survival was identified and further validated; the lower complete response rate may be consistent with the reestablishment of a monoclonal gammopathy of undetermined significance condition, assuming its plasma cells to be highly resistant to cytotoxic therapies (similar to normal plasma cells present at the time of bone marrow aplasia after induction therapy for acute leukemia). These results are supported by the observation of a monoclonal gammopathy of undetermined significance-like signature in the majority of patients surviving more than 10 years after initiation of Total Therapy 1 (Barlogie B, et al., 2006). Only 5% of the Total Therapy 1 long-term survivors were greater than 65 years of age at diagnosis

In addition to identifying a low-risk multiple myeloma entity with features of monoclonal gammopathy of undetermined significance, analytical clustering of monoclonal gammopathy of undetermined significance cases with non-monoclonal gammopathy of undetermined significance-like multiple myeloma may pertain to a monoclonal gammopathy of undetermined significance subset at high risk of conversion to multiple myeloma. As well subjects with multiple myeloma-like monoclonal gammopathy of undetermined significance may benefit from early therapeutic intervention in the absence of symptoms, whereas treatment may be held or deferred in patients with monoclonal gammopathy of undetermined significance-like multiple myeloma.

A “spiked” expression of MMSET (MS) and MAF/MAFB and PROLIFERATION (PR) molecular signatures together constituted high-risk disease, whereas HYPERDIPLOIDY, LOW BONE DISEASE and CCND1/CCND3 translocations represented low-risk multiple myeloma (Zhan F, et al. 2006). In this context of molecular classification of multiple myeloma, nearly 50% of monoclonal gammopathy of undetermined significance-like multiple myeloma cases and 37% of monoclonal gammopathy of undetermined significance were characterized by CCND1- or CCND3-activating translocations and CD20 expression (CD-2 designation); as opposed to only 4% of non-monoclonal gammopathy of undetermined significance-like multiple myeloma (Zhan F, et al., 2006). In contrast, the other molecular class of t(11;14)(q13;q32)-positive disease, characterized by CCND1 or CCND3 spikes and lacking CD20 expression (CD-1 designation), was significantly underrepresented in both monoclonal gammopathy of undetermined significance and monoclonal gammopathy of undetermined significance-like multiple myeloma. As expected, the molecular PROLIFERATION class was rare in monoclonal gammopathy of undetermined significance and monoclonal gammopathy of undetermined significance-like multiple myeloma (Table 1). The lower frequency of a HYPERDIPLOID molecular signature in monoclonal gammopathy of undetermined significance-like multiple myeloma relative to non-monoclonal gammopathy of undetermined significance-like multiple myeloma may suggests differences in multiple myeloma evolving or not evolving through a monoclonal gammopathy of undetermined significance state (refer to Table 1).

TABLE 1
Comparison of molecular subgroup distribution of MGUS, SMM, MM from MGUS,
and newly diagnosed MM of the training set

| 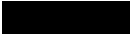 | 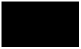 | 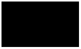 | 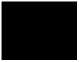 | 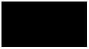 | 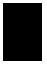 |
|---|---|---|---|---|---|
| PROLIFERATION | 0 | 0 | 6 | 14 | >.001 |
| 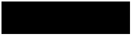 | 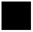 | 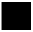 | 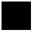 | 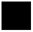 | 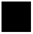 |
| MMSET | 2 | 0 | 13 | 13 | >.001 |
| 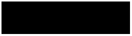 | 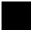 | 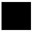 | 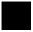 | 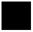 | 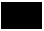 |
| CCND1-1 | 0 | 0 | 6 | 7 | .001* |
| 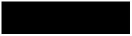 | 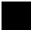 | 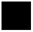 | 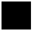 | 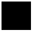 | 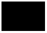 |
| MAF | 13 | 17 | 12 | 6 | NS |

Additionally, the infrequent presence of high-risk PROLIFERATION and MMSET genetic subtypes in monoclonal gammopathy of undetermined significance-like multiple myeloma may explain the superior survival of such patients in comparison with those exhibiting non-monoclonal gammopathy of undetermined significance-like multiple myeloma. The possibility, however, of the eventual acquisition of a non-monoclonal gammopathy of undetermined significance-like and PROLIFERATION signature with progression has to be considered. The presence of a CD-2 signature, originally recognized in multiple myeloma, in many cases of monoclonal gammopathy of undetermined significance and monoclonal gammopathy of undetermined significance-like multiple myeloma, will be helpful in ascertaining whether other multiple myeloma subtypes may have evolved from a monoclonal gammopathy of undetermined significance phase. Conversely, we can investigate whether a shift occurs to a non-monoclonal gammopathy of undetermined significance-like signature with progression. Longitudinal studies on a case-by-case basis will reveal insight into the molecular changes accompanying progression in an individual patient.

Due to technical limitations, it is not clear whether the gene expression profiling differences between monoclonal gammopathy of undetermined significance, monoclonal gammopathy of undetermined significance-like multiple myeloma and non-monoclonal gammopathy of undetermined significance-like multiple myeloma are due to a dilution effect caused by co-purification of normal plasma cells or heterogeneity among clonally related tumor cells. Support for the latter possibility comes from the observation that TNFSF7/CD27, one of the genes in the current list of 52, is progressively down regulated in the transition from normal plasma cells to monoclonal gammopathy of undetermined significance to multiple myeloma (Guikema J E, et al., 2003). Using flow cytometry, Moreau et al. noted CD27 expression in plasma cells of all normal donors, its absence in 36% of patients with multiple myeloma at diagnosis and in 47% at relapse, as well as in 92% of human glomerular mesangial cell line (HMCL); survival was superior in CD27-positive versus CD27-negative multiple myeloma (Moreau P, et al., 2006). The agreement between the gene expression profiling data here and previously published protein expression studies supports our contention that the observed differences in plasma cells of normal donors and patients with monoclonal gammopathy of undetermined significance and patients with multiple myeloma are specific to the disease process rather than due to contamination by normal plasma cells.

A high-resolution map of recurrent, minimal common regions of gain/amplification and loss/deletion was recently reported along with the genes residing in these minimal common regions, whose expression was strongly correlated with changes in copy number. Over-expression of genes in multiple myeloma relative to monoclonal gammopathy of undetermined significance pertained to CCT3 and HIST2H2AA mapping to minimal common regions at 1q21-1q22. It was recently shown that fluorescent in situ hybridization-defined amplification of 1q21 was absent in monoclonal gammopathy of undetermined significance; its presence in some patients with smoldering multiple myeloma was associated with a higher risk of conversion to multiple myeloma, and its presence in multiple myeloma conferred short survival (Hanamura I, et al., 2006). Other genes included SLC39A8 mapping to 4q22.3-4q24 and ASK/DBF4 mapping to 7q21.12. Genes mapping to minimal common regions with loss/deletion and reduced expression in multiple myeloma relative to monoclonal gammopathy of undetermined significance included the Caspase Recruitment Domain-Containing Protein 15 (CARD15) mapping at 16q11.2 and the fork-head box O1A (FOXO1A) transcription factor mapping near the peak of a minimal common region at 13q14.1. The identification of genes, whose expression level is copy number-sensitive in multiple myeloma, as being differentially expressed in a comparison of monoclonal gammopathy of undetermined significance and multiple myeloma, again suggests that differences are not likely to simply reflect the degree of contamination of normal plasma cells in the CD138-selected fractions and that the altered expression of this small subset of genes is important in disease progression.

In conclusion, genomic profiling was used to identify a subset of genes whose expression patterns differentiate plasma cells from normal donors and subjects with monoclonal gammopathy of undetermined significance and multiple myeloma. Patients with monoclonal gammopathy of undetermined significance, exhibiting molecular features of multiple myeloma and deemed at higher risk of conversion to overt multiple myeloma, could be selected for secondary prevention trials. The prevalence of a monoclonal gammopathy of undetermined significance-like signature in plasma cells of long-term survivors of Total Therapy 1 raises the question whether these superior results could have been achieved with less aggressive treatment strategies. Investigation of the functional pathways of genes with differential expression levels in the various plasma cell dyscrasias may provide valuable insights into the enigmatic mechanisms of the multi-step molecular pathogenesis of multiple myeloma.

In one embodiment of the present invention there is a method of gene expression profiling for the identification of genomic signatures specific for a disease by performing a comparative analysis on data obtained from hybridization of nucleic acid isolated from an individual, to a DNA microarray. Specifically, the genomic signature may be defined by a gene(s) that is differentially expressed in plasma cells from the precursor form(s) of the disease in comparison to the expression of the gene in plasma cell of normal and/or plasma cell of the disease. Preferably, the disease is multiple myeloma and its precursor state is monoclonal gammopathy of undetermined significance or smoldering multiple myeloma. In general, the genes may be selected from a group of 52 consisting of ABCC10, ASK, ATP11B, ATP13A3, AVEN, BCL11A, C11orf1, C12orf11, C15orf24, C1QBP, C9orf41, CARD15, CCT3, DKC1, FOXO1A, GPI, HIST1H1C, HIST1H2AC, HIST2H2AA, HIST2H2BE, HSPA9B, IPO7, KIAA0179, KIAA049, KLF2, LARS, LOC15909, LOC550643, MED28, MRPL32, MYO6, NBEA, NIFIE14, NME1, OTUD6B, PAIC, PDE4B, RANBP2L1, RCN2, RIPK3, RPL37A, SLC39A8, SMAD5, SSBP1, TCERG, TMEM57, TNFRSF7, TXN, UXS1, VDAC1, ZA20D2, and ZNF131.

In another embodiment of the present invention genes involved in various cellular processes comprised of cell cycle control, DNA synthesis, chromosome assembly, nuclear protein import, gene transcription, cell aging, cell signaling, metabolism, energy production, ion transport, reactive oxygen metabolism, drug resistance or programmed cell death/apoptosis, are significantly differentially expressed in normal plasma cells and plasma cells of monoclonal gammopathy of undetermined significance and/or multiple myeloma (Tables 2 and 3).

TABLE 2
Genes Significantly Differentially Expressed between normal plasma cells and
plasma cells of monoclonal gammopathy of undetermined significance

| Probe Set | Symbol | Map Location | SAM SCORE |
|---|---|---|---|
| 1555852_at | — | 06 | 6.56 |
| 224820_at | FAM36A | 1q44 | 6.20 |
| 205383_s_at | ZBTB20 | 3q13.2 | 6.18 |
| 221875_x_at | HLA-F | 6p21.3 | 5.92 |
| 213158_at | — | 03 | 5.65 |
| 227527_at | MLL2 | 12q12-q14 | 5.41 |
| 209398_at | HIST1H1C | 6p21.3 | 5.39 |
| 232304_at | PELI1 | 2p13.3 | 5.36 |
| 213720_s_at | SMARCA4 | 19p13.2 | 5.27 |
| 217436_x_at | HLA-G /// HLA-H | 6p21.3 | 5.26 |
| 202081_at | IER2 | 19p13.13 | 5.21 |
| 228465_at | — | 01 | 5.19 |
| 232431_at | NR3C1 | 5q31 | 5.11 |
| 225256_at | — | 19 | 5.08 |
| 201531_at | ZFP36 | 19q13.1 | 5.05 |
| 216321_s_at | NR3C1 | 5q31.3 | 5.00 |
| 212137_at | LARP1 | 5q33.2 | 4.99 |
| 228053_s_at | C9orf105 | 9p13.1 | 4.97 |
| 230003_at | — | 12 | 4.90 |
| 201074_at | SMARCC1 | 3p23-p21 | 4.85 |
| 227749_at | — | 19 | 4.84 |
| 225917_at | — | 12 | 4.82 |
| 1553704_x_at | FLJ90396 | 19p13.2-p13.13 | 4.81 |
| 212130_x_at | SUI1 | 17q21.2 | 4.79 |
| 225547_at | — | 08 | 4.78 |
| 214143_x_at | RPL24 /// SLC36A2 | 3q12 /// 5q33.1 | 4.76 |
| 201788_at | DDX42 | 17q23.3 | 4.75 |
| 204806_x_at | HLA-F | 6p21.3 | 4.73 |
| 200840_at | KARS | 16q23-q24 | 4.71 |
| 201263_at | TARS | 5p13.2 | 4.70 |
| 210110_x_at | HNRPH3 | 10q22 | 4.67 |
| 203080_s_at | BAZ2B | 2q23-q24 | 4.66 |
| 200830_at | PSMD2 | 3q27.1 | 4.61 |
| 208956_x_at | DUT | 15q15-q21.1 | 4.60 |
| 226981_at | MLL | 11q23 | 4.60 |
| 214317_x_at | RPS9 | 19q13.4 | 4.60 |
| 202284_s_at | CDKN1A | 6p21.2 | 4.58 |
| 214356_s_at | KIAA0368 | 9q31.3 | 4.56 |
| 225431_x_at | ACY1L2 | 6q15 | 4.55 |
| 1558956_s_at | WDR56 | 3q25.33 | 4.54 |
| 1553703_at | FLJ90396 | 19p13.2-p13.13 | 4.53 |
| 225390_s_at | KLF13 | 15q12 | 4.53 |
| 212665_at | TIPARP | 3q25.31 | 4.48 |
| 200085_s_at | TCEB2 | 16p12.3 | 4.48 |
| 218797_s_at | SIRT7 | 17q25 | 4.48 |
| 200072_s_at | HNRPM | 19p13.3-p13.2 | 4.46 |
| 224610_at | RNU22 | 11q13 | 4.45 |
| 224579_at | SLC38A1 | 12q13.11 | 4.44 |
| 235308_at | ZBTB20 | 3q13.2 | 4.43 |
| 225190_x_at | RPL35A | 3q29-qter | 4.43 |
| 200019_s_at | FAU | 11q13 | 4.42 |
| 218319_at | PELI1 | 2p13.3 | 4.42 |
| 201498_at | USP7 | 16p13.3 | 4.41 |
| 227121_at | — | 03 | 4.41 |
| 202946_s_at | BTBD3 | 20p12.2 | 4.40 |
| 202649_x_at | RPS19 | 19q13.2 | 4.40 |
| 209806_at | HIST1H2BK | 6p21.33 | 4.40 |
| 219762_s_at | RPL36 | 19p13.3 | 4.39 |
| 225097_at | HIPK2 | 7q32-q34 | 4.38 |
| 201405_s_at | COPS6 | 7q22.1 | 4.38 |
| 227878_s_at | SPATA11 | 19p13.3 | 4.38 |
| 203038_at | PTPRK | 6q22.2-23.1 | 4.37 |
| 203538_at | CAMLG | 5q23 | 4.35 |
| 228690_s_at | NDUFA11 | 19p13.3 | 4.34 |
| 218263_s_at | LOC58486 | 11p15.3 | 4.34 |
| 224604_at | LOC401152 | 4q26 | 4.33 |
| 213801_x_at | RPSA /// LOC388524 /// | 3p22.2 /// 19p12 /// 1p21.1 | 4.31 |
| | LOC388654 | | |
| 221791_s_at | HSPC016 | 3p21.31 | 4.31 |
| 218557_at | NIT2 | 3q12.2 | 4.30 |
| 201226_at | NDUFB8 | 10q23.2-q23.33 | 4.28 |
| 201119_s_at | COX8A | 11q12-q13 | 4.28 |
| 212971_at | CARS | 11p15.5 | 4.27 |
| 204918_s_at | MLLT3 | 9p22 | 4.27 |
| 226620_x_at | DAZAP1 | 19p13.3 | 4.27 |
| 213857_s_at | CD47 | 3q13.1-q13.2 | 4.27 |
| 220966_x_at | ARPC5L | 9q33.3 | 4.26 |
| 219863_at | HERC5 | 4q22.1-q23 | 4.26 |
| 218286_s_at | RNF7 | 3q22-q24 | 4.25 |
| 218280_x_at | HIST2H2AA | 1q21.2 | 4.24 |
| 203525_s_at | APC | 5q21-q22 | 4.23 |
| 202309_at | MTHFD1 | 14q24 | 4.23 |
| 222735_at | TMEM38B | 9q31.2 | 4.22 |
| 225814_at | XRN1 | 3q23 | 4.22 |
| 211698_at | CRI1 | 15q21.1-q21.2 | 4.21 |
| 201258_at | RPS16 | 19q13.1 | 4.18 |
| 212428_at | KIAA0368 | 9q31.3 | 4.18 |
| 224702_at | MGC23909 | 5q14.2 | 4.18 |
| 203190_at | NDUFS8 | 11q13 | 4.18 |
| 201892_s_at | IMPDH2 | 3p21.2 | 4.18 |
| 211799_x_at | HLA-C | 6p21.3 | 4.18 |
| 205659_at | HDAC9 | 7p21.1 | 4.18 |
| 205569_at | LAMP3 | 3q26.3-q27 | 4.17 |
| 226225_at | MCC | 5q21-q22 | 4.17 |
| 214988_s_at | SON | 21q22.1-q22.2\|21q22.11 | 4.15 |
| 212450_at | KIAA0256 | 15q21.1 | 4.14 |
| 212826_s_at | SLC25A6 | Xp22.32 and Yp | 4.12 |
| 200843_s_at | EPRS | 1q41-q42 | 4.11 |
| 212276_at | LPIN1 | 2p25.1 | 4.11 |
| 212959_s_at | MGC4170 | 12q23.3 | 4.09 |
| 224439_x_at | RNF7 | 3q22-q24 | 4.09 |
| 200899_s_at | MGEA5 | 10q24.1-q24.3 | 4.08 |
| 201030_x_at | LDHB | 12p12.2-p12.1 | 4.08 |
| 202243_s_at | PSMB4 | 1q21 | 4.07 |
| 211730_s_at | POLR2L | 11p15 | 4.07 |
| 202839_s_at | NDUFB7 | 19p13.12-p13.11 | 4.07 |
| 202818_s_at | TCEB3 | 1p36.1 | 4.06 |
| 202779_s_at | UBE2S | 19q13.43 | 4.06 |
| 200691_s_at | HSPA9B | 5q31.1 | 4.05 |
| 225434_at | DEDD2 | 19q13.2 | 4.05 |
| 218205_s_at | MKNK2 | 19p13.3 | 4.05 |
| 224741_x_at | GAS5 | 1q23.3 | 4.05 |
| 209685_s_at | PRKCB1 | 16p11.2 | 4.05 |
| 200089_s_at | RPL4 | 15q22 | 4.04 |
| 224719_s_at | GRCC10 | 12p13.31 | 4.04 |
| 200632_s_at | NDRG1 | 8q24.3 | 4.04 |
| 201306_s_at | ANP32B | 9q22.32 | 4.03 |
| 201086_x_at | SON | 21q22.1-q22.2\|21q22.11 | 4.03 |
| 213041_s_at | ATP5D | 19p13.3 | 4.03 |
| 203113_s_at | EEF1D | 8q24.3 | 4.02 |
| 200786_at | PSMB7 | 9q34.11-q34.12 | 4.01 |
| 221290_s_at | MUM1 | 19p13.3 | 4.01 |
| 203725_at | GADD45A | 1p31.2-p31.1 | 4.00 |
| 209058_at | EDF1 | 9q34.3 | 3.99 |
| 225321_s_at | PILRB | 7q22.1 | 3.99 |
| 217853_at | TENS1 | 7p13-p12.3 | 3.99 |
| 226370_at | KLHL15 | Xp22.1-p21 | 3.99 |
| 226873_at | — | 15 | 3.99 |
| 203449_s_at | TERF1 | 8q13 | 3.99 |
| 214290_s_at | HIST2H2AA | 1q21.2 | 3.98 |
| 202244_at | PSMB4 | 1q21 | 3.98 |
| 222389_s_at | WAC | 10 | 3.98 |
| 213510_x_at | LOC220594 | 17p11.2 | 3.96 |
| 212254_s_at | DST | 6p12-p11 | 3.96 |
| 200631_s_at | SET | 9q34 | 3.95 |
| 226252_at | — | 03 | 3.94 |
| 232889_at | LOC153561 | 5q13.2 | 3.94 |
| 228702_at | FLJ43663 | 7q32.3 | 3.94 |
| 226385_s_at | C7orf30 | 7p15.3 | 3.94 |
| 226447_at | ASH1L | 1q22 | 3.93 |
| 200055_at | TAF10 | 11p15.3 | 3.93 |
| 217810_x_at | LARS | 5q32 | 3.92 |
| 202110_at | COX7B | Xq21.1 | 3.91 |
| 217828_at | FLJ13213 | 15q21.3 | 3.91 |
| 211752_s_at | NDUFS7 | 19p13.3 | 3.91 |
| 204093_at | CCNH | 5q13.3-q14 | 3.90 |
| 201952_at | ALCAM | 3q13.1 | 3.90 |
| 204254_s_at | VDR | 12q13.11 | 3.90 |
| 218306_s_at | HERC1 | 15q22 | 3.90 |
| 203529_at | PPP6C | 9q33.3 | 3.90 |
| 226465_s_at | SON | 21q22.1-q22.2\|21q22.11 | 3.89 |
| 228046_at | LOC152485 | 4q31.21-q31.22 | 3.89 |
| 213309_at | PLCL2 | 3p24.3 | 3.88 |
| 212048_s_at | YARS | 1p35.1 | 3.88 |
| 200807_s_at | HSPD1 | 2q33.1 | 3.87 |
| 200002_at | RPL35 | 9q34.1 | 3.87 |
| 225421_at | ACY1L2 | 6q15 | 3.87 |
| 215696_s_at | KIAA0310 | 9q34.3 | 3.86 |
| 218882_s_at | WDR3 | 1p13-p12 | 3.85 |
| 226720_at | KIAA1935 | 5q33.3 | 3.85 |
| 202396_at | TCERG1 | 5q31 | 3.85 |
| 213025_at | THUMPD1 | 16p12.3 | 3.84 |
| 211623_s_at | FBL | 19q13.1 | 3.83 |
| 225028_at | LOC550643 | Xp11.1 | 3.83 |
| 201164_s_at | PUM1 | 1p35.2 | 3.83 |
| 203752_s_at | JUND | 19p13.2 | 3.82 |
| 225429_at | PPP6C | 9q33.3 | 3.81 |
| 202682_s_at | USP4 | 3p21.3 | 3.81 |
| 219371_s_at | KLF2 | 19p13.13-p13.11 | 3.81 |
| 202657_s_at | SERTAD2 | 2p14 | 3.80 |
| 212066_s_at | USP34 | 2p15 | 3.79 |
| 218533_s_at | UCKL1 | 20q13.33 | 3.79 |
| 40189_at | SET | 9q34 | 3.78 |
| 201967_at | RBM6 | 3p21.3 | 3.78 |
| 225956_at | LOC153222 | 5q35.1 | 3.78 |
| 226505_x_at | USP32 | 17q23.2 | 3.78 |
| 200999_s_at | CKAP4 | 12q23.3 | 3.78 |
| 211075_s_at | CD47 | 3q13.1-q13.2 | 3.77 |
| 225153_at | GFM1 | 3q25.1-q26.2 | 3.77 |
| 223193_x_at | E2IG5 | 3q21.1 | 3.77 |
| 225951_s_at | — | 15q26.1 | 3.76 |
| 212716_s_at | EIF3S12 | 19q13.2 | 3.76 |
| 39729_at | PRDX2 | 19p13.2 | 3.76 |
| 241775_at | SCFD1 | 14q12 | 3.75 |
| 212733_at | KIAA0226 | 3q29 | 3.73 |
| 222427_s_at | LARS | 5q32 | 3.73 |
| 213414_s_at | RPS19 | 19q13.2 | 3.73 |
| 200014_s_at | HNRPC | 14q11.2 | 3.72 |
| 226116_at | — | 01 | 3.72 |
| 206158_s_at | ZNF9 | 3q21 | 3.72 |
| 217491_x_at | COX7C | 5q14 | 3.72 |
| 226915_s_at | ARPC5L | 9q33.3 | 3.71 |
| 221847_at | LOC440123 | 12p13.33 | 3.70 |
| 225477_s_at | MRPS25 | 3p25 | 3.70 |
| 1555945_s_at | C9orf10 | 9q22.31 | 3.69 |
| 239893_at | MCTP2 | 15q26.2 | 3.69 |
| 217726_at | COPZ1 | 12q13.2-q13.3 | 3.69 |
| 213737_x_at | LOC283768 /// LOC388080 /// | 15q13.1 /// 15q11.2 /// | 3.69 |
| | LOC388189 /// LOC390535 /// | 15p13 | |
| | LOC400304 /// LOC440234 /// | | |
| | DKFZp434P162 | | |
| 208729_x_at | HLA-B | 6p21.3 | 3.69 |
| 208873_s_at | C5orf18 | 5q22-q23 | 3.68 |
| 221267_s_at | C19orf27 | 19p13.3 | 3.68 |
| 222200_s_at | BSDC1 | 1p35.1 | 3.68 |
| 202021_x_at | SUI1 | 17q21.2 | 3.67 |
| 226109_at | C21orf91 | 21q21.1 | 3.67 |
| 225698_at | TIGA1 | 5q21-q22 | 3.66 |
| 200995_at | IPO7 | 11p15.4 | 3.66 |
| 1553979_at | — | | 3.66 |
| 208623_s_at | VIL2 | 6q25.2-q26 | 3.66 |
| 208691_at | TFRC | 3q29 | 3.66 |
| 222589_at | NLK | 17q11.2 | 3.66 |
| 212205_at | H2AFV | 7p13 | 3.65 |
| 235381_at | HBXAP | 11q13.5 | 3.65 |
| 200094_s_at | EEF2 | 19pter-q12 | 3.64 |
| 222992_s_at | NDUFB9 | 8q13.3 | 3.64 |
| 207769_s_at | PQBP1 | Xp11.23 | 3.64 |
| 203880_at | COX17 | 3q13.33 | 3.64 |
| 222428_s_at | LARS | 5q32 | 3.64 |
| 212132_at | FAM61A | 19q13.11 | 3.63 |
| 224841_x_at | GAS5 | 1q23.3 | 3.63 |
| 212640_at | PTPLB | 3q21.1 | 3.63 |
| 217707_x_at | SMARCA2 | 9p22.3 | 3.62 |
| 207996_s_at | C18orf1 | 18p11.2 | 3.62 |
| 203832_at | SNRPF | 12q23.1 | 3.62 |
| 200022_at | RPL18 | 19q13 | 3.62 |
| 214280_x_at | HNRPA1 | 12q13.1 | 3.62 |
| 226453_at | AYP1 | 11q13.1 | 3.61 |
| 223008_s_at | C9orf5 | 9q31 | 3.61 |
| 218239_s_at | GTPBP4 | 10p15-p14 | 3.59 |
| 223003_at | MGC2803 | 19p13.13 | 3.59 |
| 208101_s_at | C9orf74 | 9q34.11 | 3.59 |
| 218149_s_at | ZNF395 | 8p21.1 | 3.59 |
| 213864_s_at | NAP1L1 | 12q21.2 | 3.59 |
| 203133_at | SEC61B | 9q22.32-q31.3 | 3.58 |
| 203556_at | ZHX2 | 8q24.13 | 3.58 |
| 221692_s_at | MRPL34 | 19p13.1 | 3.58 |
| 225517_at | FLJ20582 | 15q14 | 3.58 |
| 206055_s_at | SNRPA1 | 15q26.3 | 3.58 |
| 201577_at | NME1 | 17q21.3 | 3.57 |
| 228341_at | FLJ31265 | 3q21.3 | 3.57 |
| 226340_x_at | LOC349338 /// FLJ25222 /// | Xq28; Yq12 /// 15q26.3 /// | 3.57 |
| | MGC52000 | 2q14.1 | |
| 212301_at | RTF1 | 15q15.1 | 3.57 |
| 202090_s_at | UQCR | 19p13.3 | 3.56 |
| 214351_x_at | RPL13 /// LOC388344 | 16q24.3\|17p11.2 /// | 3.55 |
| | | 17p11.2 | |
| 207957_s_at | PRKCB1 | 16p11.2 | 3.55 |
| 214687_x_at | ALDOA | 16q22-q24 | 3.55 |
| 226352_at | JMY | 5q14.1 | 3.55 |
| 225229_at | AFF4 | 5q31 | 3.55 |
| 215359_x_at | ZNF44 | 19p13.2 | 3.54 |
| 208988_at | FBXL11 | 11q13.2 | 3.54 |
| 223480_s_at | MRPL47 | 3q26.33 | 3.54 |
| 200774_at | C9orf10 | 9q22.31 | 3.54 |
| 201153_s_at | MBNL1 | 3q25 | 3.54 |
| 221475_s_at | RPL15 | 3p24.2 | 3.53 |
| 209059_s_at | EDF1 | 9q34.3 | 3.53 |
| 200013_at | RPL24 | 3q12 | 3.53 |
| 217936_at | ARHGAP5 | 14q12 | 3.53 |
| 201611_s_at | ICMT | 1p36.21 | 3.53 |
| 201460_at | MAPKAPK2 | 1q32 | 3.52 |
| 224722_at | MIB1 | 18q11.2 | 3.51 |
| 213891_s_at | TCF4 | 18q21.1 | 3.51 |
| 200797_s_at | MCL1 | 1q21 | 3.51 |
| 230261_at | ST8SIA4 | 5q21 | 3.51 |
| 202314_at | CYP51A1 | 7q21.2-q21.3 | 3.51 |
| 228988_at | ZNF6 | Xq21.1-q21.2 | 3.50 |
| 210942_s_at | ST3GAL6 | 3q12.1 | 3.50 |
| 201676_x_at | PSMA1 | 11p15.1 | 3.50 |
| 208827_at | PSMB6 | 17p13 | 3.50 |
| 225610_at | UHRF2 | 9p24.1 | 3.50 |
| 1552519_at | ACVR1C | 2q24.1 | 3.50 |
| 210347_s_at | BCL11A | 2p16.1 | 3.48 |
| 207573_x_at | ATP5L | 11q23.3 | 3.48 |
| 228345_at | CHIC1 | Xq13-q21 | 3.48 |
| 226191_at | GSK3B | 3q13.3 | 3.48 |
| 204917_s_at | MLLT3 | 9p22 | 3.48 |
| 229813_x_at | DAZAP1 | 19p13.3 | 3.48 |
| 226052_at | BRD4 | 19p13.1 | 3.47 |
| 215071_s_at | HIST1H2AC | 6p21.3 | 3.47 |
| 213331_s_at | NEK1 | 4q33 | 3.47 |
| 1555837_s_at | POLR2B | 4q12 | 3.47 |
| 226939_at | CPEB2 | 4p15.33 | 3.47 |
| 226941_at | ATF6 | 1q22-q23 | 3.46 |
| 204571_x_at | PIN4 | Xq13 | 3.46 |
| 204020_at | PURA | 5q31 | 3.46 |
| 213726_x_at | TUBB2 | 9q34 | 3.46 |
| 207761_s_at | DKFZP586A0522 | 12q13.12 | 3.45 |
| 200770_s_at | LAMC1 | 1q31 | 3.45 |
| 211800_s_at | USP4 | 3p21.3 | 3.45 |
| 208634_s_at | MACF1 | 1p32-p31 | 3.45 |
| 217969_at | C11orf2 | 11q13 | 3.45 |
| 218194_at | DKFZP566E144 | 11q23.1-q23.2 | 3.45 |
| 235005_at | MGC4562 | 15q22.31 | 3.45 |
| 209911_x_at | HIST1H2BD | 6p21.3 | 3.45 |
| 202646_s_at | CSDE1 | 1p22 | 3.45 |
| 213360_s_at | POM121 /// LOC340318 /// | 7q11.23 | 3.45 |
| | LOC441253 | | |
| 218381_s_at | U2AF2 | 19q13.42 | 3.44 |
| 200823_x_at | RPL29 | 3p21.3-p21.2 | 3.44 |
| 214394_x_at | — | 06 | 3.44 |
| 221773_at | ELK3 | 12q23 | 3.44 |
| 211946_s_at | BAT2D1 | 1q23.3 | 3.43 |
| 211784_s_at | SFRS1 | 17q21.3-q22 | 3.43 |
| 225361_x_at | LOC159090 | Xq26.3 | 3.43 |
| 230836_at | ST8SIA4 | 5q21 | 3.43 |
| 214800_x_at | BTF3 /// LOC345829 | 5q13.2 /// 6q25.1 | 3.43 |
| 238761_at | MED28 | 4p16 | 3.43 |
| 232213_at | PELI1 | 2p13.3 | 3.43 |
| 209903_s_at | ATR | 3q22-q24 | 3.43 |
| 210346_s_at | CLK4 | 5q35 | 3.43 |
| 221207_s_at | NBEA | 13q13 | 3.42 |
| 212227_x_at | SUI1 | 17q21.2 | 3.42 |
| 229353_s_at | NUCKS1 | 1q32.1 | 3.42 |
| 209267_s_at | SLC39A8 | 4q22-q24 | 3.41 |
| 211671_s_at | NR3C1 | 5q31.3 | 3.41 |
| 214894_x_at | MACF1 | 1p32-p31 | 3.41 |
| 226312_at | AVO3 | 5p13.1 | 3.41 |
| 208113_x_at | PABPC3 | 13q12-q13 | 3.41 |
| 1555844_s_at | HNRPM | 19p13.3-p13.2 | 3.40 |
| 200715_x_at | RPL13A | 19q13.3 | 3.39 |
| 222978_at | SURF4 | 9q34.2 | 3.39 |
| 200772_x_at | PTMA | 2q35-q36 | 3.39 |
| 208692_at | RPS3 | 11q13.3-q13.5 | 3.39 |
| 1557820_at | AFG3L2 | 18p11 | 3.39 |
| 226283_at | WDR51B | 12q21.33 | 3.38 |
| 211746_x_at | PSMA1 | 11p15.1 | 3.38 |
| 208659_at | CLIC1 | 6p22.1-p21.2 | 3.38 |
| 228956_at | UGT8 | 4q26 | 3.38 |
| 218265_at | SECISBP2 | 9q22.2 | 3.38 |
| 202941_at | NDUFV2 | 18p11.31-p11.2 | 3.37 |
| 227370_at | KIAA1946 | 2q32.1 | 3.37 |
| 209503_s_at | PSMC5 | 17q23-q25 | 3.37 |
| 211911_x_at | HLA-B | 6p21.3 | 3.37 |
| 209329_x_at | MGC2198 | 5q35.2 | 3.36 |
| 209143_s_at | CLNS1A /// C3orf4 | 11q13.5-q14 /// 3p11-q11 | 3.36 |
| 202983_at | SMARCA3 | 3q25.1-q26.1 | 3.36 |
| 213077_at | YTHDC2 | 5q22.2 | 3.36 |
| 222415_at | MLL3 | 7q34-q36 | 3.36 |
| 201397_at | PHGDH | 1p12 | 3.36 |
| 202824_s_at | TCEB1 | 8q21.11 | 3.36 |
| 200877_at | CCT4 | 2p15 | 3.35 |
| 203688_at | PKD2 | 4q21-q23 | 3.35 |
| 200000_s_at | PRPF8 | 17p13.3 | 3.35 |
| 226344_at | ZMAT1 | Xq21 | 3.35 |
| 201134_x_at | COX7C | 5q14 | 3.34 |
| 212967_x_at | NAP1L1 | 12q21.2 | 3.34 |
| 214853_s_at | SHC1 | 1q21 | 3.34 |
| 201031_s_at | HNRPH1 | 5q35.3 | 3.34 |
| 208771_s_at | LTA4H | 12q22 | 3.33 |
| 36553_at | ASMTL | Xp22.3; Yp11.3 | 3.33 |
| 226808_at | KIAA0543 | 7q36.1 | 3.33 |
| 211036_x_at | ANAPC5 | 12q24.31 | 3.33 |
| 218134_s_at | RBM22 | 5q33.1 | 3.33 |
| 211445_x_at | FKSG17 /// LOC389240 | 8q22.3 /// 4q32.3 | 3.33 |
| 201865_x_at | NR3C1 | 5q31.3 | 3.32 |
| 205644_s_at | SNRPG | 2p13.3 | 3.32 |
| 213588_x_at | RPL14 | 3p22-p21.2 | 3.32 |
| 200990_at | TRIM28 | 19q13.4 | 3.31 |
| 213893_x_at | PMS2L5 | 7q11-q22 | 3.31 |
| 201678_s_at | DC12 | 3q21.3 | 3.31 |
| 1558142_at | TNRC6B | 22q13.1 | 3.31 |
| 210453_x_at | ATP5L | 11q23.3 | 3.30 |
| 208746_x_at | ATP5L | 11q23.3 | 3.30 |
| 226496_at | ZCCHC7 | 9p13.2 | 3.30 |
| 217798_at | CNOT2 | 12q15 | 3.30 |
| 223245_at | STRBP | 9q33.3 | 3.29 |
| 225368_at | HIPK2 | 7q32-q34 | 3.29 |
| 218236_s_at | PRKD3 | 2p21 | 3.29 |
| 213846_at | COX7C | 5q14 | 3.29 |
| 238436_s_at | LOC390980 | 19q13.43 | 3.29 |
| 201473_at | JUNB | 19p13.2 | 3.28 |
| 200662_s_at | TOMM20 | 1q42 | 3.28 |
| 204172_at | CPOX | 3q12 | 3.28 |
| 208916_at | SLC1A5 | 19q13.3 | 3.28 |
| 201754_at | COX6C | 8q22-q23 | 3.27 |
| 203753_at | TCF4 | 18q21.1 | 3.27 |
| 221700_s_at | UBA52 | 19p13.1-p12 | 3.27 |
| 229394_s_at | GRLF1 | 19q13.3 | 3.27 |
| 201876_at | PON2 | 7q21.3 | 3.26 |
| 218772_x_at | TMEM38B | 9q31.2 | 3.26 |
| 204244_s_at | ASK | 7q21.3 | 3.25 |
| 223101_s_at | ARPC5L | 9q33.3 | 3.25 |
| 209606_at | PSCDBP | 2q11.2 | 3.25 |
| 223705_s_at | GPBP1 | 5q11.2 | 3.25 |
| 202265_at | PCGF4 | 10p11.23 | 3.24 |
| 224679_at | MESDC2 | 15q13 | 3.24 |
| 242691_at | — | 19 | 3.24 |
| 201637_s_at | FXR1 | 3q28 | 3.24 |
| 222669_s_at | SBDS | 7q11.21 | 3.24 |
| 218281_at | MRPL48 | 11q13.4 | 3.24 |
| 227189_at | CPNE5 | 6p21.1 | 3.24 |
| 225093_at | UTRN | 6q24 | 3.23 |
| 205934_at | PLCL1 | 2q33 | 3.23 |
| 211921_x_at | PTMA | 2q35-q36 | 3.23 |
| 212773_s_at | TOMM20 | 1q42 | 3.23 |
| 221829_s_at | TNPO1 | 5q13.2 | 3.23 |
| 201803_at | POLR2B | 4q12 | 3.23 |
| 225065_x_at | MGC40157 | 17p11.2 | 3.23 |
| 215016_x_at | DST | 6p12-p11 | 3.23 |
| 212155_at | RNF187 | 1q42.13 | 3.23 |
| 209703_x_at | DKFZP586A0522 | 12q13.12 | 3.22 |
| 210231_x_at | SET | 9q34 | 3.22 |
| 225526_at | MKLN1 | 7q32 | 3.22 |
| 218200_s_at | NDUFB2 | 7q34 | 3.22 |
| 226449_at | FLJ36090 | 5q23.2 | 3.22 |
| 200810_s_at | CIRBP | 19p13.3 | 3.22 |
| 226392_at | — | 03 | 3.22 |
| 201517_at | NCBP2 | 3q29 | 3.22 |
| 225973_at | TAP2 | 6p21.3 | 3.21 |
| 226626_at | THOC2 | Xq25-q26.3 | 3.21 |
| 229686_at | P2RY8 | Xp22.33; Yp11.3 | 3.21 |
| 229742_at | LOC145853 | 15q23 | 3.21 |
| 203366_at | POLG | 15q25 | 3.21 |
| 202737_s_at | LSM4 | 19p13.11 | 3.21 |
| 211969_at | HSPCA | 14q32.33 | 3.20 |
| 217747_s_at | RPS9 | 19q13.4 | 3.20 |
| 226914_at | ARPC5L | 9q33.3 | 3.20 |
| 213005_s_at | ANKRD15 | 9p24.3 | 3.20 |
| 217773_s_at | NDUFA4 | 7p21.3 | 3.20 |
| 218459_at | TOR3A | 1q25.2 | 3.20 |
| 201281_at | ADRM1 | 20q13.33 | 3.20 |
| 208713_at | HNRPUL1 | 19q13.2 | 3.19 |
| 222673_x_at | TMEM57 /// LOC159090 | 1p36.11 /// Xq26.3 | 3.19 |
| 222891_s_at | BCL11A | 2p16.1 | 3.19 |
| 208887_at | EIF3S4 | 19p13.2 | 3.19 |
| 225290_at | — | 12 | 3.19 |
| 202887_s_at | DDIT4 | 10pter-q26.12 | 3.19 |
| 204976_s_at | AMMECR1 | Xq22.3 | 3.18 |
| 211961_s_at | RAB7 | 3q21.3 | 3.18 |
| 203189_s_at | NDUFS8 | 11q13 | 3.18 |
| 213564_x_at | LDHB | 12p12.2-p12.1 | 3.18 |
| 227284_at | LOC90321 | 19q13.41 | 3.18 |
| 209654_at | KIAA0947 | 5p15.32 | 3.18 |
| 212247_at | NUP205 | 7q33 | 3.17 |
| 221434_s_at | C14orf156 | 14q24.3 | 3.17 |
| 212018_s_at | RSL1D1 | 16p13.13 | 3.17 |
| 229460_at | — | 02 | 3.17 |
| 201268_at | NME2 | 17q21.3 | 3.17 |
| 223084_s_at | CCNDBP1 | 15q14-q15 | 3.17 |
| 225304_s_at | NDUFA11 | 19p13.3 | 3.17 |
| 210776_x_at | TCF3 | 19p13.3 | 3.17 |
| 213485_s_at | ABCC10 | 6p21.1 | 3.17 |
| 204461_x_at | RAD1 | 5p13.2 | 3.17 |
| 224345_x_at | E2IG5 | 3q21.1 | 3.16 |
| 228961_at | — | 05 | 3.16 |
| 54632_at | THADA | 2p21 | 3.16 |
| 217768_at | C14orf166 | 14q22.1 | 3.16 |
| 205690_s_at | G10 | 7q22.1 | 3.16 |
| 227538_at | CRSP7 | 19p13.11 | 3.16 |
| 204559_s_at | LSM7 | 19p13.3 | 3.16 |
| 209974_s_at | BUB3 | 10q26 | 3.15 |
| 200050_at | ZNF146 | 19q13.1 | 3.15 |
| 209579_s_at | MBD4 | 3q21-q22 | 3.14 |
| 224511_s_at | TXNL5 | 17p13.1 | 3.14 |
| 224624_at | LRRC8A | 9q34.11 | 3.14 |
| 217980_s_at | MRPL16 | 11 | 3.14 |
| 201038_s_at | ANP32A | 15q22.3-q23 | 3.13 |
| 209323_at | PRKRIR | 11q13.5 | 3.13 |
| 216570_x_at | RPL29 /// LOC283412 /// | 3p21.3-p21.2 /// 12q22 /// | 3.13 |
| | LOC284064 /// LOC389655 /// | 17q21.31 /// 8q11.21 /// | |
| | LOC391738 /// LOC401911 | 5p15.2 /// 19q13.11 | |
| 209302_at | POLR2H | 3q28 | 3.13 |
| 224932_at | C22orf16 | 22q11.23 | 3.13 |
| 208647_at | FDFT1 | 8p23.1-p22 | 3.13 |
| 225155_at | C6orf160 | 6q14.3 | 3.13 |
| 215823_x_at | PABPC3 /// PABPC1 /// | 13q12-q13 /// 8q22.2-q23 | 3.13 |
| | LOC341315 | /// 12q14.2 | |
| 225223_at | SMAD5 | 5q31 | 3.12 |
| 200874_s_at | NOL5A | 20p13 | 3.12 |
| 207760_s_at | NCOR2 | 12q24 | 3.12 |
| 202956_at | ARFGEF1 | 8q13 | 3.12 |
| 201587_s_at | IRAK1 | Xq28 | 3.11 |
| 212248_at | LYRIC | 8q22.1 | 3.11 |
| 225144_at | BMPR2 | 2q33-q34 | 3.11 |
| 211928_at | DNCH1 | 14q32.3-qter\|14q32 | 3.11 |
| 212501_at | CEBPB | 20q13.1 | 3.11 |
| 218570_at | KBTBD4 | 11p11.2 | 3.11 |
| 202329_at | CSK | 15q23-q25 | 3.11 |
| 218320_s_at | NDUFB11 | Xp11.3 | 3.11 |
| 211710_x_at | RPL4 | 15q22 | 3.10 |
| 202419_at | FVT1 | 18q21.3 | 3.10 |
| 221494_x_at | EIF3S12 | 19q13.2 | 3.10 |
| 200816_s_at | PAFAH1B1 | 17p13.3 | 3.10 |
| 224961_at | SCYL2 | 12q23.1 | 3.10 |
| 224664_at | C10orf104 | 10q22.1 | 3.10 |
| 201221_s_at | SNRP70 | 19q13.3 | 3.09 |
| 226098_at | WDR56 | 3q25.33 | 3.09 |
| 201726_at | ELAVL1 | 19p13.2 | 3.09 |
| 206542_s_at | SMARCA2 | 9p22.3 | 3.09 |
| 211933_s_at | HNRPA3 | 2q31.2 | 3.09 |
| 225764_at | ETV6 | 12p13 | 3.09 |
| 221891_x_at | HSPA8 | 11q24.1 | 3.08 |
| 225415_at | DTX3L | 3q21.1 | 3.08 |
| 219497_s_at | BCL11A | 2p16.1 | 3.08 |
| 207551_s_at | MSL3L1 | Xp22.3 | 3.08 |
| 235035_at | SLC35E1 | 19p13.11 | 3.08 |
| 203621_at | NDUFB5 | 3q26.33 | 3.08 |
| 212842_x_at | RANBP2L1 /// DKFZp686P0288 | 2q13 /// 2q12.3 | 3.07 |
| | /// LOC375258 | | |
| 213251_at | — | 4q31.21 | 3.07 |
| 219097_x_at | MGC2747 | 19p13.11 | 3.07 |
| 200818_at | ATP5O | 21q22.1-q22.2\|21q22.11 | 3.07 |
| 225179_at | HIP2 | 4p14 | 3.07 |
| 213166_x_at | FLJ14346 | 2q21.1 | 3.06 |
| 200063_s_at | NPM1 | 5q35 | 3.06 |
| 218053_at | FNBP3 | 2q23.3 | 3.06 |
| 235879_at | MBNL1 | 3q25 | 3.06 |
| 235360_at | — | 02 | 3.05 |
| 213186_at | DZIP3 | 3q13.13 | 3.05 |
| 200873_s_at | CCT8 | 21q22.11 | 3.05 |
| 200959_at | FUS | 16p11.2 | 3.05 |
| 208693_s_at | GARS | 7p15 | 3.05 |
| 200097_s_at | HNRPK | 9q21.32-q21.33 | 3.04 |
| 210891_s_at | GTF2I /// GTF2IP1 | 7q11.23 | 3.04 |
| 235372_at | FCRLM1 | 1q23.3 | 3.04 |
| 223134_at | BBX | 3q13.1 | 3.04 |
| 201812_s_at | TOMM7 /// LOC201725 | 7p15.3 /// 4q32.1 | 3.03 |
| 200017_at | RPS27A | 2p16 | 3.03 |
| 222465_at | C15orf15 /// LOC284288 | 15q21 /// 18q21.31 | 3.03 |
| 239258_at | PIGF | 2p21-p16 | 3.03 |
| 209932_s_at | DUT | 15q15-q21.1 | 3.03 |
| 212058_at | SR140 | 3q23 | 3.03 |
| 237475_x_at | — | 05 | 3.03 |
| 223034_s_at | C1orf43 | 1q21.2 | 3.03 |
| 220755_s_at | C6orf48 | 6p21.3 | 3.03 |
| 227624_at | KIAA1546 | 4q24 | 3.03 |
| 226789_at | — | 01 | 3.02 |
| 45828_at | FLJ10241 | 19q13.2 | 3.02 |
| 212689_s_at | JMJD1A | 2p11.2 | 3.02 |
| 205771_s_at | AKAP7 | 6q23 | 3.02 |
| 200629_at | WARS | 14q32.31 | 3.02 |
| 218334_at | NIF3L1BP1 | 3p14.1 | 3.01 |
| 212467_at | DNAJC13 | 3q22.1 | 3.01 |
| 203818_s_at | SF3A3 | 1p34.3 | 3.01 |
| 207320_x_at | STAU | 20q13.1 | 3.01 |
| 217759_at | TRIM44 | 11p13 | 3.01 |
| 223042_s_at | FUNDC2 | Xq28 | 3.01 |
| 226662_at | STX17 | 9q31.1 | 3.01 |
| 203227_s_at | SAS | 12q13.3 | 3.01 |
| 217926_at | HSPC023 | 19p13.13 | 3.01 |
| 203685_at | BCL2 | 18q21.33\|18q21.3 | 3.00 |
| 208986_at | TCF12 | 15q21 | 3.00 |
| 233929_x_at | FLJ25222 | 15q26.3 | 3.00 |
| 226110_at | PTAR1 | 9q21.11 | 3.00 |
| 222997_s_at | MRPS21 | 01 | 3.00 |
| 212566_at | MAP4 | 3p21 | 3.00 |
| 201154_x_at | RPL4 | 15q22 | 2.99 |
| 223061_at | MGC3234 | 11p15.5 | 2.99 |
| 228574_at | DKFZp762A217 | 12q21.31 | 2.99 |
| 208697_s_at | EIF3S6 | 8q22-q23 | 2.99 |
| 222414_at | MLL3 | 7q34-q36 | 2.99 |
| 227186_s_at | MRPL41 | 9q34.3 | 2.99 |
| 226077_at | FLJ31951 | 5q33.3 | 2.98 |
| 211931_s_at | HNRPA3 | 2q31.2 | 2.98 |
| 212840_at | KIAA0794 | 3q29 | 2.97 |
| 226684_at | C14orf103 | 14q32.2 | 2.97 |
| 217733_s_at | TMSB10 | 2p11.2 | 2.97 |
| 213762_x_at | RBMX | Xq26.3 | 2.97 |
| 200834_s_at | RPS21 | 20q13.3 | 2.97 |
| 201186_at | LRPAP1 | 4p16.3 | 2.96 |
| 220864_s_at | NDUFA13 | 19p13.2 | 2.96 |
| 200093_s_at | HINT1 | 5q31.2 | 2.96 |
| 224599_at | CGGBP1 | 3p12-p11.1 | 2.96 |
| 200023_s_at | EIF3S5 | 11p15.4 | 2.96 |
| 224581_s_at | NUCKS | 1q32.1 | 2.96 |
| 213128_s_at | UBE3A | 15q11-q13 | 2.96 |
| 224565_at | TncRNA | 11q13.1 | 2.96 |
| 214271_x_at | RPL12 | 9q34 | 2.96 |
| 228332_s_at | C11orf31 | 11q12.1 | 2.95 |
| 203252_at | CDK2AP2 | 11q13 | 2.95 |
| 229861_at | LOC440426 | 17q12 | 2.95 |
| 203396_at | PSMA4 | 15q25.1 | 2.95 |
| 212690_at | DDHD2 | 8p12 | 2.95 |
| 209036_s_at | MDH2 | 7p12.3-q11.2 | 2.95 |
| 212927_at | SMC5L1 | 9q21.11 | 2.94 |
| 204516_at | ATXN7 | 3p21.1-p12 | 2.94 |
| 208709_s_at | NRD1 | 1p32.2-p32.1 | 2.94 |
| 213356_x_at | HNRPA1 /// LOC284387 /// | 12q13.1 /// 19p13.2 /// | 2.94 |
| | LOC285984 /// LOC344741 /// | 7q21.11 /// 3q24 /// | |
| | LOC388275 /// LOC389674 /// | 16q12.1 /// 8q21.13 /// | |
| | LOC391670 /// LOC402112 /// | 4q21.21 /// 2q31.1 /// | |
| | LOC402562 /// LOC439963 /// | 10q11.22 /// 13q12.11 /// | |
| | LOC440125 /// LOC441507 | Xq22.1 | |
| 208799_at | PSMB5 | 14q11.2 | 2.94 |
| 212987_at | FBXO9 | 6p12.3-p11.2 | 2.94 |
| 201393_s_at | IGF2R | 6q26 | 2.93 |
| 221518_s_at | USP47 | 11p15.3 | 2.93 |
| 203301_s_at | DMTF1 | 7q21 | 2.93 |
| 41220_at | 9-Sep | 17q25 | 2.93 |
| 210976_s_at | PFKM | 12q13.3 | 2.93 |
| 201216_at | C12orf8 | 12q24.13 | 2.92 |
| 202277_at | SPTLC1 | 9q22.2 | 2.92 |
| 203026_at | ZBTB5 | 9p13.2 | 2.92 |
| 208021_s_at | RFC1 | 4p14-p13 | 2.92 |
| 223176_at | C6orf69 | 6p21.31 | 2.92 |
| 203531_at | CUL5 | 11q22-q23 | 2.91 |
| 1564637_s_at | FLJ38426 | 15q14 | 2.91 |
| 224644_at | — | 03 | 2.91 |
| 225892_at | IREB2 | 15q25.1 | 2.91 |
| 202264_s_at | TOMM40 | 19q13 | 2.91 |
| 205239_at | AREG | 4q13-q21 | 2.91 |
| 226006_at | — | 03 | 2.91 |
| 212426_s_at | YWHAQ | 2p25.1 | 2.91 |
| 203825_at | BRD3 | 9q34 | 2.91 |
| 221190_s_at | C18orf8 | 18q11.2 | 2.90 |
| 208864_s_at | TXN | 9q31 | 2.90 |
| 221570_s_at | METTL5 | 2q31.1 | 2.90 |
| 38269_at | PRKD2 | 19q13.3 | 2.90 |
| 202491_s_at | IKBKAP | 9q31 | 2.90 |
| 208706_s_at | EIF5 | 14q32.32 | 2.89 |
| 205633_s_at | ALAS1 | 3p21.1 | 2.89 |
| 226386_at | C7orf30 | 7p15.3 | 2.89 |
| 225561_at | SELT | 3q25.1 | 2.89 |
| 211971_s_at | LRPPRC | 2p21 | 2.89 |
| 231995_at | C9orf82 | 9p21.2 | 2.88 |
| 204068_at | STK3 | 8q22.2 | 2.88 |
| 201746_at | TP53 | 17p13.1 | 2.88 |
| 225912_at | TP53INP1 | 8q22 | 2.88 |
| 209898_x_at | ITSN2 | 2pter-p25.1 | 2.88 |
| 213860_x_at | CSNK1A1 | 5q32 | 2.87 |
| 234512_x_at | LOC442159 | 6p24.3 | 2.87 |
| 227636_at | THAP5 | 7q31.1 | 2.87 |
| 209337_at | PSIP1 | 9p22.3 | 2.87 |
| 226635_at | — | 9p13.2 | 2.87 |
| 201305_x_at | ANP32B | 9q22.32 | 2.87 |
| 222996_s_at | CXXC5 | 5q31.2 | 2.87 |
| 223238_s_at | — | 13 | 2.87 |
| 225219_at | SMAD5 | 5q31 | 2.87 |
| 204028_s_at | RABGAP1 | 9q33.2-q33.3 | 2.86 |
| 202975_s_at | RHOBTB3 | 5q15 | 2.86 |
| 202515_at | DLG1 | 3q29 | 2.86 |
| 225910_at | LOC284019 | 17q24.3 | 2.86 |
| 212674_s_at | DHX30 | 3p21.31 | 2.86 |
| 209240_at | OGT | Xq13 | 2.86 |
| 225197_at | PRO0149 | 16p13.2 | 2.86 |
| 228324_at | C9orf41 | 9q21.13 | 2.86 |
| 213465_s_at | PPP1R7 | 2q37.3 | 2.85 |
| 51200_at | FLJ20850 | 19p13.11 | 2.85 |
| 235791_x_at | CHD1 | 5q15-q21 | 2.85 |
| 208754_s_at | NAP1L1 | 12q21.2 | 2.85 |
| 221476_s_at | RPL15 | 3p24.2 | 2.85 |
| 226732_at | RBM33 | 7q36.3 | 2.85 |
| 213504_at | COPS6 | 7q22.1 | 2.85 |
| 211987_at | TOP2B | 3p24 | 2.85 |
| 200630_x_at | SET | 9q34 | 2.85 |
| 223553_s_at | DOK3 | 5q35.3 | 2.84 |
| 236265_at | SP4 | 7p15.3 | 2.84 |
| 227277_at | LYRIC | 8q22.1 | 2.84 |
| 202757_at | COBRA1 | 9q34 | 2.84 |
| 231870_s_at | CGI-07 | 3q26.1 | 2.84 |
| 224187_x_at | HSPA8 | 11q24.1 | 2.84 |
| 211929_at | HNRPA3 | 2q31.2 | 2.84 |
| 200004_at | EIF4G2 | 11p15 | 2.84 |
| 225552_x_at | AURKAIP1 | 1p36.33 | 2.83 |
| 203497_at | PPARBP | 17q12-q21.1 | 2.83 |
| 221481_x_at | HNRPD | 4q21.1-q21.2 | 2.83 |
| 227110_at | HNRPC | 14q11.2 | 2.83 |
| 202102_s_at | BRD4 | 19p13.1 | 2.83 |
| 217807_s_at | GLTSCR2 | 19q13.3 | 2.83 |
| 203255_at | FBXO11 | 2p16.3 | 2.83 |
| 238559_at | — | 02 | 2.83 |
| 202846_s_at | PIGC | 1q23-q25 | 2.83 |
| 217774_s_at | HSPC152 | 11q13.1 | 2.82 |
| 201584_s_at | DDX39 | 19p13.12 | 2.82 |
| 201738_at | GC20 | 3p22.1 | 2.82 |
| 200058_s_at | ASCC3L1 | 2q11.2 | 2.82 |
| 200650_s_at | LDHA | 11p15.4 | 2.81 |
| 225343_at | TMED8 | 14q24.3 | 2.81 |
| 201013_s_at | PAICS | 4pter-q21 | 2.81 |
| 225813_at | MNAB | 9q34 | 2.81 |
| 200621_at | CSRP1 | 1q32 | 2.80 |
| 223155_at | HDHD2 | 18q21.1 | 2.80 |
| 222990_at | UBQLN1 | 9q22\|9q21.2-q21.3 | 2.80 |
| 209836_x_at | BOLA2 | 16p11 | 2.80 |
| 208598_s_at | HUWE1 | Xp11.22 | 2.79 |
| 235675_at | DHFRL1 | 3q11.2 | 2.79 |
| 217987_at | NS3TP1 | 2p24.3-q21.3 | 2.79 |
| 223140_s_at | DHX36 | 03 | 2.79 |
| 214785_at | VPS13A | 9q21 | 2.79 |
| 224413_s_at | TM2D2 | 8p11.23 | 2.79 |
| 201664_at | SMC4L1 | 3q26.1 | 2.79 |
| 210149_s_at | ATP5H | 17q25 | 2.79 |
| 212195_at | IL6ST | 5q11 | 2.79 |
| 205442_at | MFAP3L | 4q32.3 | 2.79 |
| 228167_at | KLHL6 | 03 | 2.78 |
| 219081_at | ANKHD1 | 5q31.2 | 2.78 |
| 224575_at | C3orf10 | 3p25.3 | 2.78 |
| 213165_at | CAP350 | 1p36.13-q41 | 2.78 |
| 217946_s_at | SAE1 | 19q13.32 | 2.78 |
| 200896_x_at | HDGF | 1q21-q23 | 2.78 |
| 214170_x_at | FH | 1q42.1 | 2.78 |
| 212223_at | IDS | Xq28 | 2.78 |
| 201441_at | COX6B1 | 19q13.1 | 2.78 |
| 218085_at | CHMP5 | 9p13.3 | 2.78 |
| 206176_at | BMP6 | 6p24-p23 | 2.78 |
| 222579_at | UBE1DC1 | 3q22.1 | 2.78 |
| 231045_x_at | C11orf31 | 11q12.1 | 2.77 |
| 214328_s_at | HSPCA | 14q32.33 | 2.77 |
| 235401_s_at | FCRLM1 | 1q23.3 | 2.77 |
| 228541_x_at | — | 15q26.1 | 2.77 |
| 213377_x_at | RPS12 | 6q23.2 | 2.77 |
| 201232_s_at | PSMD13 | 11p15.5 | 2.77 |
| 204949_at | ICAM3 | 19p13.3-p13.2 | 2.77 |
| 204009_s_at | KRAS | 12p12.1 | 2.76 |
| 226414_s_at | ANAPC11 | 17q25.3 | 2.76 |
| 235061_at | PPM1K | 4q22.1 | 2.76 |
| 215179_x_at | PGF | 14q24-q31 | 2.76 |
| 227052_at | LOC201895 | 4p14 | 2.76 |
| 209815_at | PTCH | 9q22.3 | 2.76 |
| 210501_x_at | EIF3S12 | 19q13.2 | 2.76 |
| 222984_at | PAIP2 | 5q31.2 | 2.75 |
| 203985_at | ZNF212 | 7q36.1 | 2.75 |
| 211763_s_at | UBE2B | 5q23-q31 | 2.75 |
| 226158_at | DRE1 | 3q27.1 | 2.75 |
| 200016_x_at | HNRPA1 | 12q13.1 | 2.75 |
| 200904_at | HLA-E | 6p21.3 | 2.75 |
| 56919_at | WDR48 | 3p21.33 | 2.75 |
| 202761_s_at | SYNE2 | 14q23.2 | 2.75 |
| 200853_at | H2AFZ | 4q24 | 2.75 |
| 203110_at | PTK2B | 8p21.1 | 2.75 |
| 218646_at | FLJ20534 | 4q33 | 2.74 |
| 200966_x_at | ALDOA | 16q22-q24 | 2.74 |
| 214665_s_at | CHP | 15q13.3 | 2.74 |
| 230006_s_at | DKFZp313A2432 | 11p14.2 | 2.74 |
| 226148_at | BTBD15 | 11q24.3 | 2.74 |
| 209274_s_at | HBLD2 | 9q21.33 | 2.74 |
| 217801_at | ATP5E | 20q13.32 | 2.73 |
| 225052_at | MGC14327 | 9q34.3 | 2.73 |
| 225893_at | — | 01 | 2.73 |
| 201477_s_at | RRM1 | 11p15.5 | 2.73 |
| 229588_at | DNAJC10 | 2q32.1 | 2.73 |
| 203243_s_at | PDLIM5 | 4q22 | 2.73 |
| 217028_at | CXCR4 | 2q21 | 2.73 |
| 214683_s_at | CLK1 | 2q33 | 2.72 |
| 204500_s_at | AGTPBP1 | 9q21.33 | 2.72 |
| 207132_x_at | PFDN5 | 12q12 | 2.72 |
| 211939_x_at | BTF3 | 5q13.2 | 2.72 |
| 225469_at | LOC144363 | 12p12.1 | 2.72 |
| 219043_s_at | PDCL3 /// LOC285359 | 2q11.2 /// 3q12.3 | 2.71 |
| 202233_s_at | UQCRH | 1p34.1 | 2.71 |
| 225640_at | LOC401504 | 9p13.2 | 2.71 |
| 226316_at | — | 13 | 2.71 |
| 214709_s_at | KTN1 /// PDIA6 | 14q22.1 /// 2p25.1 | 2.71 |
| 211974_x_at | RBPSUH | 4p15.2 | 2.71 |
| 201993_x_at | HNRPDL | 4q13-q21 | 2.71 |
| 204805_s_at | H1FX | 3q21.3 | 2.71 |
| 1560587_s_at | PRDX5 | 11q13 | 2.71 |
| 225786_at | FAM36A | 1q44 | 2.71 |
| 233642_s_at | KIAA1414 | 2p22.2 | 2.71 |
| 224852_at | TTC17 | 11p12-p11.2 | 2.71 |
| 213735_s_at | COX5B | 2cen-q13 | 2.71 |
| 209509_s_at | DPAGT1 | 11q23.3 | 2.71 |
| 209435_s_at | ARHGEF2 | 1q21-q22 | 2.71 |
| 201204_s_at | RRBP1 | 20p12 | 2.70 |
| 212245_at | MCFD2 | 2p21 | 2.70 |
| 224876_at | FLJ37562 | 5q31.1 | 2.70 |
| 223547_at | C14orf100 | 14q23.1 | 2.70 |
| 209104_s_at | NOLA2 | 5q35.3 | 2.70 |
| 210825_s_at | PBP | 12q24.23 | 2.70 |
| 201227_s_at | NDUFB8 | 10q23.2-q23.33 | 2.70 |
| 214431_at | GMPS | 3q24 | 2.70 |
| 232843_s_at | DOCK8 | 9p24.3 | 2.70 |
| 219563_at | C14orf139 | 14q32.13 | 2.70 |
| 203593_at | CD2AP | 6p12 | 2.70 |
| 227964_at | FKSG44 | 11q13 | 2.69 |
| 239468_at | C10orf48 | 10p12.1 | 2.69 |
| 220942_x_at | E2IG5 | 3q21.1 | 2.69 |
| 206860_s_at | FLJ20323 | 7p22-p21 | 2.69 |
| 200826_at | SNRPD2 | 19q13.2 | 2.69 |
| 224814_at | DPP7 | 9q34.3 | 2.69 |
| 238604_at | — | 07 | 2.69 |
| 223051_at | SSU72 | 1p36.33 | 2.69 |
| 226816_s_at | KIAA1143 | 3p21.31 | 2.69 |
| 219028_at | HIPK2 | 7q32-q34 | 2.69 |
| 224977_at | — | 06 | 2.68 |
| 200746_s_at | GNB1 | 1p36.33 | 2.68 |
| 209181_s_at | RABGGTB | 1p31 | 2.68 |
| 208863_s_at | SFRS1 | 17q21.3-q22 | 2.68 |
| 217716_s_at | SFC61A1 | 3q21.3 | 2.68 |
| 210137_s_at | DCTD | 4q35.1 | 2.68 |
| 215416_s_at | STOML2 | 9p13.1 | 2.68 |
| 207358_x_at | MACF1 | 1p32-p31 | 2.68 |
| 231059_x_at | SCAND1 | 20q11.1-q11.23 | 2.68 |
| 234762_x_at | NLN | 5q12.3 | 2.67 |
| 220948_s_at | ATP1A1 | 1p21 | 2.67 |
| 212513_s_at | USP33 | 1p31.1 | 2.67 |
| 217756_x_at | SERF2 | 15q15.3 | 2.67 |
| 225539_at | ZNF295 | 21q22.3 | 2.67 |
| 202373_s_at | RAB3-GAP150 | 1q41 | 2.67 |
| 201472_at | VBP1 | Xq28 | 2.66 |
| 201922_at | TINP1 | 5q13.3 | 2.66 |
| 221654_s_at | USP3 | 15q22.3 | 2.66 |
| 222825_at | CGI-77 | 8q21.3 | 2.66 |
| 211954_s_at | RANBP5 | 13q32.2 | 2.66 |
| 237367_x_at | CFLAR | 2q33-q34 | 2.66 |
| 213743_at | CCNT2 | 2q21.3 | 2.66 |
| 202906_s_at | NBN | 8q21 | 2.66 |
| 208993_s_at | PPIG | 2q31.1 | 2.66 |
| 202177_at | GAS6 | 13q34 | 2.66 |
| 218580_x_at | AURKAIP1 | 1p36.33 | 2.65 |
| 225658_at | LOC339745 | 2q22.1 | 2.65 |
| 203391_at | FKBP2 | 11q13.1-q13.3 | 2.65 |
| 219922_s_at | LTBP3 | 11q12 | 2.65 |
| 214629_x_at | RTN4 | 2p16.3 | 2.65 |
| 222449_at | TMEPAI | 20q13.31-q13.33 | 2.65 |
| 204279_at | PSMB9 | 6p21.3 | 2.65 |
| 208788_at | ELOVL5 | 6p21.1-p12.1 | 2.65 |
| 225220_at | — | 04 | 2.65 |
| 209224_s_at | NDUFA2 | 5q31 | 2.65 |
| 225011_at | PRKAR2A | 3p21.3-p21.2 | 2.65 |
| 216348_at | RPS17 /// LOC402057 | 15q /// 22q12.3 | 2.65 |
| 217827_s_at | SPG21 | 15q21-q22 | 2.65 |
| 225302_at | TXNDC10 | 18q22 | 2.64 |
| 214214_s_at | C1QBP | 17p13.3 | 2.64 |
| 200869_at | RPL18A /// LOC390354 | 19p13 | 2.64 |
| 208764_s_at | ATP5G2 | 12q13.13 | 2.64 |
| 223096_at | NOP5/NOP58 | 2q33.1 | 2.64 |
| 201757_at | NDUFS5 | 1p34.2-p33 | 2.64 |
| 209669_s_at | PAI-RBP1 | 1p31 | 2.64 |
| 224915_x_at | TALDO1 /// HSUP1 | 11p15.5-p15.4 /// 20q13.13 | 2.64 |
| 212297_at | ATP13A3 | 3q29 | 2.64 |
| 203658_at | SLC25A20 | 3p21.31 | 2.64 |
| 220939_s_at | DPP8 | 15q22 | 2.64 |
| 225460_at | SEC22L3 | 3p22.1 | 2.64 |
| 217945_at | BTBD1 | 15q24 | 2.64 |
| 202693_s_at | STK17A | 7p12-p14 | 2.63 |
| 212251_at | MTDH | 8q22.1 | 2.63 |
| 225971_at | DDHD1 | 14q21 | 2.63 |
| 225110_at | FLJ10826 | 16q12.2 | 2.63 |
| 219293_s_at | PTD004 | 2q31.1 | 2.63 |
| 224688_at | FLJ10099 | 7q11.21 | 2.63 |
| 200905_x_at | HLA-E | 6p21.3 | 2.63 |
| 200909_s_at | RPLP2 | 11p15.5-p15.4 | 2.63 |
| 219366_at | AVEN | 15q13.1 | 2.63 |
| 207335_x_at | ATP51 | 4p16.3 | 2.63 |
| 219079_at | CYB5R4 | 6pter-q22.33 | 2.63 |
| 209476_at | TXNDC | 14q22.1 | 2.63 |
| 226361_at | TMEM42 | 3p21.31 | 2.63 |
| 213571_s_at | EIF4E2 | 2q37.1 | 2.62 |
| 200949_x_at | RPS20 | 8q12 | 2.62 |
| 210466_s_at | PAI-RBP1 | 1p31 | 2.62 |
| 212386_at | TCF4 | 18q21.1 | 2.62 |
| 204744_s_at | IARS | 9q21 | 2.62 |
| 222728_s_at | MGC5306 | 11q21 | 2.62 |
| 204076_at | ENTPD4 | 8p21.3 | 2.62 |
| 212038_s_at | VDAC1 | 5q31 | 2.62 |
| 202692_s_at | UBTF | 17q21.3 | 2.61 |
| 222472_at | AFTIPHILIN | 2p14 | 2.61 |
| 227369_at | PAI-RBP1 | 1p31 | 2.61 |
| 210793_s_at | NUP98 | 11p15.5 | 2.61 |
| 208798_x_at | GM88 | 15q11.2 | 2.61 |
| 201653_at | CNIH | 14q22.2 | 2.61 |
| 219598_s_at | RWDD1 | 6q13-q22.33 | 2.61 |
| 221474_at | MRLC2 | 18p11.31 | 2.61 |
| 200674_s_at | RPL32 | 3p25-p24 | 2.61 |
| 200846_s_at | PPP1CA | 11q13 | 2.61 |
| 217722_s_at | NGRN | 15q26.1 | 2.61 |
| 229429_x_at | — | 1q21.1 | 2.61 |
| 213034_at | KIAA0999 | 11q23.3 | 2.61 |
| 210183_x_at | — | 14 | 2.60 |
| 225515_s_at | LOC220906 | 10p12.1 | 2.60 |
| 202117_at | ARHGAP1 | 11p12-q12 | 2.60 |
| 224677_x_at | C11orf31 | 11q12.1 | 2.60 |
| 211275_s_at | GYG | 3q24-q25.1 | 2.60 |
| 211475_s_at | BAG1 | 9p12 | 2.60 |
| 200819_s_at | RPS15 | 19p13.3 | 2.60 |
| 218126_at | FAM82C | 15q15.1 | 2.60 |
| 217805_at | ILF3 | 19p13.2 | 2.60 |
| 217836_s_at | YY1AP1 | 1q22 | 2.60 |
| 224481_s_at | HECTD1 | 14q12 | 2.59 |
| 200805_at | LMAN2 | 5q35.3 | 2.59 |
| 203667_at | TBCA | 5q14.1 | 2.59 |
| 202413_s_at | USP1 | 1p31.3 | 2.59 |
| 200888_s_at | RPL23 | 17q | 2.59 |
| 201385_at | DHX15 | 4p15.3 | 2.59 |
| 210024_s_at | UBE2E3 | 2q32.1 | 2.59 |
| 215127_s_at | RBMS1 | 2q24.2 | 2.59 |
| 225001_at | RAB3D | 19p13.2 | 2.59 |
| 224784_at | MLLT6 | 17q21 | 2.58 |
| 216028_at | DKFZP564C152 | 11 | 2.58 |
| 203566_s_at | AGL | 1p21 | 2.58 |
| 225634_at | ZC3HAV1 | 7q34 | 2.58 |
| 202613_at | CTPS | 1p34.1 | 2.58 |
| 226748_at | LYSMD2 | 15q21.2 | 2.58 |
| 219192_at | UBAP2 | 9p13.3 | 2.58 |
| 225182_at | TMEM50B | 21q22.11 | 2.58 |
| 221046_s_at | HSPC135 | 3q13.2 | 2.58 |
| 208883_at | EDD1 | 8q22 | 2.58 |
| 233849_s_at | ARHGAP5 | 14q12 | 2.57 |
| 213398_s_at | C14orf124 | 14q11.2 | 2.57 |
| 202230_s_at | CHERP | 19p13.1 | 2.57 |
| 207641_at | TNFRSF13B | 17p11.2 | 2.57 |
| 203024_s_at | C5orf15 | 5q31.1 | 2.57 |
| 225395_s_at | C9orf10OS | 9q22.31 | 2.57 |
| 209248_at | GHITM | 10q23.1 | 2.57 |
| 219041_s_at | REPIN1 | 7q36.1 | 2.57 |
| 201175_at | TMX2 | 11cen-q22.3 | 2.57 |
| 223133_at | TMEM14B | 6p25.1-p23 | 2.57 |
| 218917_s_at | ARID1A | 1p35.3 | 2.57 |
| 217877_s_at | GPBP1L1 | 1p34.1 | 2.56 |
| 218495_at | UXT | Xp11.23-p11.22 | 2.56 |
| 208687_x_at | HSPA8 | 11q24.1 | 2.56 |
| 227196_at | RHPN2 | 19q13.11 | 2.56 |
| 200073_s_at | HNRPD | 4q21.1-q21.2 | 2.56 |
| 205047_s_at | ASNS | 7q21.3 | 2.56 |
| 203501_at | PGCP | 8q22.2 | 2.56 |
| 229498_at | — | X | 2.55 |
| 222405_at | — | 15 | 2.55 |
| 220741_s_at | PPA2 | 4q25 | 2.55 |
| 226481_at | VprBP | 3p21.2 | 2.55 |
| 225845_at | BTBD15 | 11q24.3 | 2.55 |
| 203217_s_at | ST3GAL5 | 2p11.2 | 2.55 |
| 202343_x_at | COX5B | 2cen-q13 | 2.55 |
| 235398_at | LOC390980 | 19q13.43 | 2.55 |
| 201703_s_at | PPP1R10 | 6p21.3 | 2.55 |
| 219123_at | ZNF232 | 17p13-p12 | 2.55 |
| 225405_at | DKFZp762N1910 | 11q12.3 | 2.54 |
| 209153_s_at | TCF3 | 19p13.3 | 2.54 |
| 213890_x_at | RPS16 | 19q13.1 | 2.54 |
| 226921_at | UBR1 | 15q13 | 2.54 |
| 211458_s_at | GABARAPL1 /// GABARAPL3 | 12p13.2 /// 15q26.1 | 2.54 |
| 230379_x_at | PRO1853 | 2p22.2 | 2.54 |
| 243496_at | — | 10 | 2.54 |
| 225017_at | CCDC14 | 3q21.1 | 2.54 |
| 222785_x_at | C11orf1 | 11q13-q22 | 2.54 |
| 223857_x_at | LOC51234 | 15q14 | 2.54 |
| 200749_at | RAN /// LOC391717 | 12q24.3 /// 4q34.1 | 2.54 |
| 226508_at | PHC3 | 3q26.2 | 2.53 |
| 210968_s_at | RTN4 | 2p16.3 | 2.53 |
| 201285_at | MKRN1 | 7q34 | 2.53 |
| 207657_x_at | TNPO1 | 5q13.2 | 2.53 |
| 202656_s_at | SERTAD2 | 2p14 | 2.53 |
| 226780_s_at | HSPC268 | 7q34 | 2.53 |
| 224780_at | RBM17 | 10p15.1 | 2.53 |
| 205590_at | RASGRP1 | 15q15 | 2.53 |
| 212502_at | C10orf22 | 10q21.3 | 2.53 |
| 201106_at | GPX4 | 19p13.3 | 2.53 |
| 221743_at | CUGBP1 | 11p11 | 2.53 |
| 227611_at | TARSL2 | 15q26.3 | 2.53 |
| 228562_at | ZBTB10 | 8q13-q21.1 | 2.53 |
| 225725_at | — | 03 | 2.52 |
| 210996_s_at | YWHAE | 17p13.3 | 2.52 |
| 211378_x_at | PPIA | 7p13-p11.2 | 2.52 |
| 208714_at | NDUFV1 | 11q13 | 2.52 |
| 211025_x_at | COX5B | 2cen-q13 | 2.52 |
| 208688_x_at | EIF3S9 | 7p22.3 | 2.52 |
| 212614_at | ARID5B | 10q21.2 | 2.52 |
| 201433_s_at | PTDSS1 | 8q22 | 2.52 |
| 227979_at | — | 11 | 2.52 |
| 217944_at | POMGNT1 | 1p34.1 | 2.52 |
| 223269_at | POLR3GL | 1q21.1 | 2.52 |
| 225086_at | FLJ38426 | 15q14 | 2.52 |
| 226450_at | INSR | 19p13.3-p13.2 | 2.52 |
| 227932_at | — | 03 | 2.51 |
| 226131_s_at | RPS16 | 19q13.1 | 2.51 |
| 208783_s_at | MCP | 1q32 | 2.51 |
| 207922_s_at | MAEA | 4p16.3 | 2.51 |
| 221974_at | SNRPN | 15q11.2 | 2.51 |
| 202066_at | PPFIA1 | 11q13.3 | 2.51 |
| 213476_x_at | TUBB3 | 16q24.3 | 2.51 |
| 1555961_a_at | HINT1 | 5q31.2 | 2.50 |
| 213687_s_at | RPL35A | 3q29-qter | 2.50 |
| 203845_at | PCAF | 3p24 | 2.50 |
| 211787_s_at | EIF4A1 | 17p13 | 2.50 |
| 225133_at | KLF3 | 4p14 | 2.50 |
| 227548_at | ORMDL1 | 02 | 2.50 |
| 211711_s_at | PTEN | 10q23.3 | 2.50 |
| 204992_s_at | PFN2 | 3q25.1-q25.2 | 2.50 |
| 227651_at | BTBD14B | 19p13.13 | 2.50 |
| 226227_x_at | TALDO1 /// HSUP1 | 11p15.5-p15.4 /// 20q13.13 | 2.50 |
| 210646_x_at | RPL13A | 19q13.3 | 2.50 |
| 204774_at | EVI2A | 17q11.2 | 2.50 |
| 229434_at | HNRPD | 4q21.1-q21.2 | 2.50 |
| 228049_x_at | — | 16 | 2.50 |
| 200048_s_at | JTB | 1q21 | 2.50 |
| 53720_at | FLJ11286 | 19p13.2 | 2.50 |
| 200029_at | RPL19 | 17q11.2-q12 | 2.50 |
| 214626_s_at | GANAB | 11q12.3 | 2.50 |
| 219133_at | KS | 3p24.2 | 2.49 |
| 200847_s_at | TMEM66 | 8p12 | 2.49 |
| 202536_at | CHMP2B | 3p12.1 | 2.49 |
| 218482_at | ENY2 | 8q23.1 | 2.49 |
| 218188_s_at | TIMM13 | 19p13.3 | 2.49 |
| 201797_s_at | VARS | 6p21.3 | 2.49 |
| 208190_s_at | LISCH7 | 19q13.12 | 2.49 |
| 202724_s_at | FOXO1A | 13q14.1 | 2.49 |
| 200037_s_at | CBX3 | 7p15.2 | 2.49 |
| 226835_s_at | TALDO1 /// HSUP1 | 11p15.5-p15.4 /// 20q13.13 | 2.49 |
| 226300_at | MED19 | 11q12.1 | 2.49 |
| 228454_at | MLR2 | 10q24 | 2.49 |
| 224782_at | ZMAT2 | 5q31.3 | 2.49 |
| 224948_at | MRPS24 | 7p14 | 2.49 |
| 224840_at | FKBP5 | 6p21.3-21.2 | 2.48 |
| 225583_at | UXS1 | 2q12.2 | 2.48 |
| 47608_at | TJAP1 | 6p21.1 | 2.48 |
| 200027_at | NARS | 18q21.2-q21.3 | 2.48 |
| 222421_at | UBE2H | 7q32 | 2.48 |
| 201486_at | RCN2 | 15q23 | 2.48 |
| 209533_s_at | PLAA | 9p21 | 2.47 |
| 213918_s_at | NIPBL | 5p13.2 | 2.47 |
| 218007_s_at | RPS27L | 15q22.2 | 2.47 |
| 209377_s_at | HMGN3 | 6q14.1 | 2.47 |
| 212498_at | MARCH-VI | 5p15.2 | 2.47 |
| 205267_at | POU2AF1 | 11q23.1 | 2.47 |
| 225916_at | ZNF131 | 5p12-p11 | 2.47 |
| 200912_s_at | EIF4A2 | 3q28 | 2.47 |
| 235450_at | FBXL4 | 6q16.1-q16.3 | 2.47 |
| 201183_s_at | CHD4 | 12p13 | 2.47 |
| 203380_x_at | SFRS5 | 14q24 | 2.47 |
| 217947_at | CKLFSF6 | 3p23 | 2.47 |
| 202060_at | SH2BP1 | 11p15.3 | 2.47 |
| 217092_x_at | RPL7 /// LOC90193 /// | 8q21.11 /// 12p12.3 /// | 2.47 |
| | LOC388401 /// LOC389305 /// | 17q21.33 /// 5q14.1 /// | |
| | LOC392550 /// LOC439954 | Xq26.3 /// 10p11.21 | |
| 200964_at | UBE1 | Xp11.23 | 2.47 |
| 235457_at | MAML2 | 11q21 | 2.47 |
| 200095_x_at | RPS10 | 6p21.31 | 2.46 |
| 202227_s_at | BRD8 | 5q31 | 2.46 |
| 225606_at | BCL2L11 | 2q13 | 2.46 |
| 216241_s_at | TCEA1 | 8q11.2 | 2.46 |
| 200010_at | RPL11 | 1p36.1-p35 | 2.46 |
| 201845_s_at | RYBP | 3p13 | 2.46 |
| 226134_s_at | MSI2 | 17q23.2 | 2.46 |
| 202521_at | CTCF | 16q21-q22.3 | 2.46 |
| 219620_x_at | FLJ20245 | 9q34.3 | 2.46 |
| 223136_at | AIG1 | 6q24.2 | 2.46 |
| 213065_at | MGC23401 | 12q21.1 | 2.45 |
| 208752_x_at | NAP1L1 | 12q21.2 | 2.45 |
| 201997_s_at | SPEN | 1p36.33-p36.11 | 2.45 |
| 203033_x_at | FH | 1q42.1 | 2.45 |
| 209511_at | POLR2F | 22q13.1 | 2.45 |
| 200033_at | DDX5 | 17q21 | 2.45 |
| 212847_at | NEXN | 1p31.1 | 2.45 |
| 217816_s_at | PCNP | 3q12.3 | 2.45 |
| 222839_s_at | PAPOLG | 2p16.1 | 2.45 |
| 222494_at | CHES1 | 14q24.3-q32.11 | 2.45 |
| 201412_at | LRP10 | 14q11.2 | 2.45 |
| 201592_at | EIF3S3 | 8q24.11 | 2.45 |
| 214042_s_at | RPL22 | 1p36.3-p36.2 | 2.45 |
| 217869_at | HSD17B12 | 11p11.2 | 2.45 |
| 203668_at | MAN2C1 | 15q11-q13 | 2.45 |
| 202029_x_at | RPL38 | 17q23-q25 | 2.45 |
| 201384_s_at | NBR1 | 17q21.1 | 2.44 |
| 204236_at | FLI1 | 11q24.1-q24.3 | 2.44 |
| 224651_at | C10orf9 | 10p11.21 | 2.44 |
| 212302_at | RTF1 | 15q15.1 | 2.44 |
| 223808_s_at | PTPMT1 | 11p11.2 | 2.44 |
| 222683_at | RNF20 | 9q22 | 2.44 |
| 222745_s_at | C15orf29 | 15q14 | 2.44 |
| 202909_at | EPM2AIP1 | 3p22.1 | 2.44 |
| 212867_at | NCOA2 | 8q13.3 | 2.44 |
| 220046_s_at | CCNL1 | 3q25.31 | 2.44 |
| 209492_x_at | ATP5I | 4p16.3 | 2.44 |
| 226884_at | LRRN1 | 3p26.2 | 2.44 |
| 225621_at | ALG2 | 9q22.33 | 2.43 |
| 200667_at | UBE2D3 | 4q24 | 2.43 |
| 218290_at | PLEKHJ1 | 19p13.3 | 2.43 |
| 225314_at | OCIAD2 | 4p12 | 2.43 |
| 200763_s_at | RPLP1 | 15q22 | 2.43 |
| 224729_s_at | ATPAF1 | 1p33-p32.3 | 2.43 |
| 225281_at | C3orf17 | 3q13.2 | 2.43 |
| 230650_at | — | 08 | 2.43 |
| 203406_at | MFAP1 | 15q15-q21 | 2.43 |
| 200091_s_at | RPS25 | 11q23.3 | 2.42 |
| 226165_at | LOC401466 | 8q21.2 | 2.42 |
| 214096_s_at | SHMT2 | 12q12-q14 | 2.42 |
| 200815_s_at | PAFAH1B1 | 17p13.3 | 2.42 |
| 218680_x_at | HYPK | 15q15.3 | 2.42 |
| 201501_s_at | GRSF1 | 4q13 | 2.42 |
| 232075_at | REC14 | 15q25.1 | 2.42 |
| 212709_at | NUP160 | 11p11.2 | 2.42 |
| 225945_at | ZNF655 | 7q22.1 | 2.42 |
| 200814_at | PSME1 | 14q11.2 | 2.42 |
| 218082_s_at | UBP1 | 3p23 | 2.42 |
| 209065_at | UQCRB | 8q22 | 2.42 |
| 213483_at | PPWD1 | 5q12.3 | 2.42 |
| 228446_at | KIAA2026 | 9p24.1 | 2.42 |
| 213313_at | RABGAP1 | 9q33.2-q33.3 | 2.41 |
| 208837_at | TMED3 | 15q24-q25 | 2.41 |
| 215191_at | FBXL11 | 11q13.2 | 2.41 |
| 200081_s_at | RPS6 | 9p21 | 2.41 |
| 224558_s_at | MALAT1 | 11q13.1 | 2.41 |
| 210962_s_at | AKAP9 | 7q21-q22 | 2.41 |
| 218242_s_at | SUV420H1 | 11q13.2 | 2.41 |
| 234295_at | DBR1 | 3q22.3 | 2.41 |
| 226334_s_at | AHSA2 | 2p15 | 2.41 |
| 1555764_s_at | TIMM10 | 11q12.1-q12.3 | 2.41 |
| 214022_s_at | IFITM1 | 11p15.5 | 2.41 |
| 212790_x_at | RPL13A | 19q13.3 | 2.41 |
| 201572_x_at | DCTD | 4q35.1 | 2.41 |
| 228960_at | NARG2 | 15q22.2 | 2.41 |
| 229666_s_at | CSTF3 | 11p13 | 2.41 |
| 218807_at | VAV3 | 1p13.3 | 2.41 |
| 200752_s_at | CAPN1 | 11q13 | 2.40 |
| 218008_at | FLJ10099 | 7q11.21 | 2.40 |
| 227755_at | — | 17 | 2.40 |
| 201622_at | SND1 | 7q31.3 | 2.40 |
| 201986_at | THRAP1 | 17q22-q23 | 2.40 |
| 218982_s_at | MRPS17 | 7p11 | 2.40 |
| 208673_s_at | SFRS3 | 6p21 | 2.40 |
| 201448_at | TIA1 | 2p13 | 2.40 |
| 225835_at | SLC12A2 | 5q23.3 | 2.40 |
| 217846_at | QARS | 3p21.3-p21.1 | 2.40 |
| 213027_at | SSA2 | 1q31 | 2.40 |
| 202221_s_at | EP300 | 22q13.2 | 2.40 |
| 225964_at | ZXDC | 3q21.2 | 2.39 |
| 213511_s_at | MTMR1 | Xq28 | 2.39 |
| 205070_at | ING3 | 7q31 | 2.39 |
| 218117_at | RBX1 | 22q13.2 | 2.39 |
| 217866_at | FLJ12529 | 11q12.2 | 2.39 |
| 218116_at | C9orf78 | 9q34.11 | 2.38 |
| 218025_s_at | PECI | 6p24.3 | 2.38 |
| 201948_at | GNL2 | 1p34.3 | 2.38 |
| 201628_s_at | RRAGA | 9p22.1 | 2.38 |
| 218020_s_at | TEX27 | 6pter-p22.3 | 2.38 |
| 201366_at | ANXA7 | 10q21.1-q21.2 | 2.38 |
| 202032_s_at | MAN2A2 | 15q26.1 | 2.38 |
| 217837_s_at | VPS24 | 2p24.3-p24.1 | 2.37 |
| 218258_at | POLR1D | 13q12.2 | 2.37 |
| 200817_x_at | RPS10 | 6p21.31 | 2.37 |
| 202704_at | TOB1 | 17q21 | 2.37 |
| 222447_at | DREV1 | 16p13-p12 | 2.37 |
| 207522_s_at | ATP2A3 | 17p13.3 | 2.37 |
| 207467_x_at | CAST | 5q15-q21 | 2.37 |
| 200812_at | CCT7 | 2p13.2 | 2.37 |
| 212476_at | CENTB2 | 3q29 | 2.37 |
| 218919_at | ZFAND1 | 8q21.13 | 2.37 |
| 53968_at | KIAA1698 | 11q12.3 | 2.36 |
| 202077_at | NDUFAB1 | 16p12.1 | 2.36 |
| 201561_s_at | CLSTN1 | 1p36.22 | 2.36 |
| 221842_s_at | ZNF131 | 5p12-p11 | 2.36 |
| 204396_s_at | GRK5 | 10q24-qter | 2.36 |
| 220925_at | MAK10 | 9q21.33 | 2.36 |
| 220643_s_at | FAIM | 3q22.3 | 2.36 |
| 203330_s_at | STX5A | 11q12.3 | 2.35 |
| 211257_x_at | ZNF638 | 2p13.2-p13.1 | 2.35 |
| 201687_s_at | API5 | 11p12-q12 | 2.35 |
| 202708_s_at | HIST2H2BE | 1q21-q23 | 2.35 |
| 204215_at | C7orf23 | 7q21.1-q21.2 | 2.35 |
| 218396_at | VPS13C | 15q22.2 | 2.35 |
| 225243_s_at | SLMAP | 3p21.2-p14.3 | 2.35 |
| 212904_at | LRRC47 | 1p36.32 | 2.35 |
| 217898_at | C15orf24 | 15q14 | 2.35 |
| 218712_at | C1orf109 | 1p34.3 | 2.35 |
| 227533_at | — | 01 | 2.34 |
| 201737_s_at | 6-Mar | 5p15.2 | 2.34 |
| 214179_s_at | NFE2L1 | 17q21.3 | 2.34 |
| 212933_x_at | RPL13 | 16q24.3\|17p11.2 | 2.34 |
| 202171_at | ZNF161 | 17q23.2 | 2.34 |
| 209515_s_at | RAB27A | 15q15-q21.1 | 2.34 |
| 208737_at | ATP6V1G1 | 9q32 | 2.34 |
| 227162_at | ZBTB26 | 9q33.2 | 2.34 |
| 216308_x_at | GRHPR | 9q12 | 2.34 |
| 38892_at | KIAA0240 | 6p21.1 | 2.33 |
| 213037_x_at | STAU | 20q13.1 | 2.33 |
| 226954_at | UBE2R2 | 9p13.3 | 2.33 |
| 224858_at | ZDHHC5 | 11q12.1 | 2.33 |
| 202778_s_at | ZNF198 | 13q11-q12 | 2.33 |
| 218611_at | IER5 | 1q25.3 | 2.33 |
| 235158_at | FLJ14803 | 7q32.2 | 2.33 |
| 219286_s_at | RBM15 | 1p13 | 2.33 |
| 215884_s_at | UBQLN2 | Xp11.23-p11.1 | 2.33 |
| 220924_s_at | SLC38A2 | 12q | 2.33 |
| 212140_at | SCC-112 | 4p14 | 2.33 |
| 213811_x_at | TCF3 | 19p13.3 | 2.33 |
| 226821_at | RIF1 | 2q23.3 | 2.33 |
| 212191_x_at | RPL13 | 16q24.3\|17p11.2 | 2.32 |
| 234107_s_at | HARS2 | 20p11.23 | 2.32 |
| 221425_s_at | HBLD2 | 9q21.33 | 2.32 |
| 211542_x_at | RPS10 | 6p21.31 | 2.32 |
| 225512_at | ZBTB38 | 3q23 | 2.32 |
| 213203_at | SNAPC5 | 15q22.31 | 2.32 |
| 203663_s_at | COX5A | 15q25 | 2.32 |
| 203062_s_at | MDC1 | 6pter-p21.31 | 2.32 |
| 225107_at | HNRPA2B1 | 7p15 | 2.32 |
| 223184_s_at | AGPAT3 | 21q22.3 | 2.32 |
| 221510_s_at | GLS | 2q32-q34 | 2.31 |
| 218932_at | C1orf181 | 1p22.3 | 2.31 |
| 201139_s_at | SSB | 2q31.1 | 2.31 |
| 200716_x_at | RPL13A | 19q13.3 | 2.31 |
| 201113_at | TUFM | 16p11.2 | 2.31 |
| 217719_at | EIF3S6IP | 22q | 2.31 |
| 213408_s_at | PIK4CA /// LOC220686 | 22q11.21 /// 22q11.22 | 2.31 |
| 200025_s_at | RPL27 | 17q21.1-q21.2 | 2.31 |
| 209630_s_at | FBXW2 | 9q34 | 2.31 |
| 211765_x_at | PPIA | 7p13-p11.2 | 2.31 |
| 218961_s_at | PNKP | 19q13.3-q13.4 | 2.31 |
| 200653_s_at | CALM1 | 14q24-q31 | 2.30 |
| 202475_at | NIFIE14 | 19q13.1 | 2.30 |
| 223062_s_at | PSAT1 | 9q21.2 | 2.30 |
| 203082_at | BMS1L | 10q11.21 | 2.30 |
| 200092_s_at | RPL37 | 5p13 | 2.30 |
| 223009_at | FLJ20625 | 11q13.4 | 2.30 |
| 207435_s_at | SRRM2 | 16p13.3 | 2.30 |
| 225530_at | MOBKL2A | 19p13.3 | 2.30 |
| 202754_at | R3HDM | 2q21.3 | 2.30 |
| 218104_at | TEX10 | 9q31.1 | 2.30 |
| 201934_at | PRO2730 | 3p21.2 | 2.30 |
| 226845_s_at | MYEOV2 | 2q37.3 | 2.30 |
| 201023_at | TAF7 | 5q31 | 2.30 |
| 208753_s_at | NAP1L1 | 12q21.2 | 2.30 |
| 225176_at | — | 05 | 2.30 |
| 225573_at | FLJ12592 | 3q22.1 | 2.30 |
| 211285_s_at | UBE3A | 15q11-q13 | 2.30 |
| 241348_at | ZNF654 | 3p11.1 | 2.30 |
| 224648_at | GPBP1 | 5q11.2 | 2.29 |
| 223211_at | HPCL2 | 3p25.1 | 2.29 |
| 222490_at | POLR3E | 16p12.1 | 2.29 |
| 200074_s_at | RPL14 /// RPL14L | 3p22-p21.2 /// 12q14.2 | 2.29 |
| 211503_s_at | RAB14 | 9q32-q34.11 | 2.29 |
| 212215_at | PREPL | 2p22.1 | 2.29 |
| 202603_at | ADAM10 | 15q2 | 2.29 |
| 224705_s_at | TNRC6A | 16p11.2 | 2.28 |
| 204373_s_at | CAP350 | 1p36.13-q41 | 2.28 |
| 1554067_at | FLJ32549 | 12q14.2 | 2.28 |
| 202325_s_at | ATP5J | 21q21.1 | 2.28 |
| 224735_at | CYBASC3 | 11q12.2 | 2.28 |
| 208766_s_at | HNRPR | 1p36.12 | 2.28 |
| 203259_s_at | C6orf74 | 6q13-q24.3 | 2.28 |
| 202605_at | GUSB | 7q21.11 | 2.28 |
| 212537_x_at | RPL17 | 18q21 | 2.27 |
| 201194_at | SEPW1 | 19q13.3 | 2.27 |
| 222443_s_at | RBM8A | 1q12 | 2.27 |
| 200768_s_at | MAT2A | 2p11.2 | 2.27 |
| 225073_at | PPHLN1 | 12q12 | 2.27 |
| 212824_at | FUBP3 | 9q34.2 | 2.27 |
| 201546_at | TRIP12 | 2q36.3 | 2.27 |
| 201928_at | PKP4 | 2q23-q31 | 2.27 |
| 228652_at | FLJ38288 | 19q13.43 | 2.27 |
| 48580_at | CXXC1 | 18q12 | 2.27 |
| 211509_s_at | RTN4 | 2p16.3 | 2.27 |
| 214657_s_at | TncRNA | 11q13.1 | 2.27 |
| 203165_s_at | SLC33A1 | 3q25.31 | 2.27 |
| 201931_at | ETFA | 15q23-q25 | 2.27 |
| 235615_at | PGGT1B | 5q22.3 | 2.27 |
| 226859_at | bA16L21.2.1 | 9q31.3 | 2.27 |
| 218011_at | UBL5 | 19p13.3 | 2.27 |
| 202297_s_at | RER1 | 1pter-q24 | 2.27 |
| 218409_s_at | DNAJC1 | 10p12.31 | 2.27 |
| 200936_at | RPL8 | 8q24.3 | 2.27 |
| 208683_at | CAPN2 | 1q41-q42 | 2.27 |
| 213698_at | ZNF258 | 1p34.2 | 2.27 |
| 210275_s_at | ZA20D2 | 9q13-q21 | 2.27 |
| 219147_s_at | C9orf95 | 9q21.13 | 2.26 |
| 224769_at | — | 17 | 2.26 |
| 225422_at | CDC26 | 9q32 | 2.26 |
| 222119_s_at | FBXO11 | 2p16.3 | 2.26 |
| 213704_at | RABGGTB | 1p31 | 2.26 |
| 201236_s_at | BTG2 | 1q32 | 2.26 |
| 229419_at | FBXW7 | 4q31.3 | 2.26 |
| 204208_at | RNGTT | 6q16 | 2.26 |
| 229519_at | FXR1 | 3q28 | 2.26 |
| 226091_s_at | MRFAP1 | 4p16.1 | 2.26 |
| 55872_at | GM632 | 20q13.33 | 2.26 |
| 217729_s_at | AES | 19p13.3 | 2.26 |
| 202231_at | hfl-B5 | 11p13 | 2.25 |
| 219206_x_at | CGI-119 | 12q14.1-q15 | 2.25 |
| 201731_s_at | TPR | 1q25 | 2.25 |
| 201256_at | COX7A2L | 2p21 | 2.25 |
| 216221_s_at | PUM2 | 2p22-p21 | 2.25 |
| 203040_s_at | HMBS | 11q23.3 | 2.25 |
| 213019_at | RANBP6 | 9p24.1 | 2.25 |
| 213080_x_at | RPL5 | 1p22.1 | 2.25 |
| 212918_at | RECQL | 12p12 | 2.25 |
| 208942_s_at | TLOC1 | 3q26.2 | 2.25 |
| 1553581_s_at | FLJ36754 | 5q12.3 | 2.25 |
| 200893_at | SFRS10 | 3q26.2-q27 | 2.25 |
| 225115_at | HIPK2 | 7q32-q34 | 2.25 |
| 200038_s_at | RPL17 | 18q21 | 2.25 |
| 230178_s_at | STATIP1 | 18q12.2 | 2.25 |
| 232683_s_at | PARP6 | 15q23 | 2.25 |
| 201601_x_at | IFITM1 | 11p15.5 | 2.25 |
| 212204_at | DKFZP564G2022 | 15q15.1 | 2.24 |
| 231530_s_at | C11orf1 | 11q13-q22 | 2.24 |
| 208517_x_at | BTF3 | 5q13.2 | 2.24 |
| 211940_x_at | H3F3A /// LOC440926 | 1q41 /// 2q31.1 | 2.24 |
| 201323_at | EBNA1BP2 | 1p35-p33 | 2.24 |
| 232681_at | PSIP1 | 9p22.3 | 2.24 |
| 238431_at | — | 02 | 2.24 |
| 202172_at | ZNF161 | 17q23.2 | 2.24 |
| 226851_at | LYPLAL1 | 1q41 | 2.24 |
| 200977_s_at | TAX1BP1 | 7p15 | 2.24 |
| 233632_s_at | XRN1 | 3q23 | 2.24 |
| 201479_at | DKC1 | Xq28 | 2.24 |
| 1560396_at | KLHL6 | 03 | 2.23 |
| 229075_at | — | 04 | 2.23 |
| 226387_at | RSBN1L | 7q11.23 | 2.23 |
| 201304_at | NDUFA5 | 7q32 | 2.23 |
| 206792_x_at | PDE4C | 19p13.11 | 2.23 |
| 218189_s_at | NANS | 9p24.1-p23 | 2.23 |
| 213941_x_at | RPS7 | 2p25 | 2.23 |
| 217745_s_at | MAK3 | 3q13.2 | 2.23 |
| 226628_at | THOC2 | Xq25-q26.3 | 2.23 |
| 212697_at | LOC162427 | 17q21.2 | 2.23 |
| 224655_at | AK3 | 9p24.1-p24.3 | 2.23 |
| 208095_s_at | SRP72 | 4q11 | 2.22 |
| 221751_at | PANK3 | 5q34 | 2.22 |
| 231817_at | USP53 | 4q26 | 2.22 |
| 212511_at | PICALM | 11q14 | 2.22 |
| 225493_at | LOC144438 | 12q13.12 | 2.22 |
| 225270_at | NEO1 | 15q22.3-q23 | 2.22 |
| 209103_s_at | UFD1L | 22q11.21 | 2.22 |
| 226181_at | TUBE1 | 6q21 | 2.22 |
| 205292_s_at | HNRPA2B1 | 7p15 | 2.22 |
| 214039_s_at | LAPTM4B | 8q22.1 | 2.22 |
| 1559822_s_at | — | 08 | 2.22 |
| 216338_s_at | YIPF3 | 6p21.1 | 2.22 |
| 201347_x_at | GRHPR | 9q12 | 2.22 |
| 214041_x_at | RPL37A | 2q35 | 2.22 |
| 202591_s_at | SSBP1 | 7q34 | 2.22 |
| 225358_at | DNAJC19 | 3q26.33 | 2.21 |
| 209455_at | FBXW11 | 5q35.1 | 2.21 |
| 203416_at | CD53 | 1p13 | 2.21 |
| 214329_x_at | TNFSF10 | 3q26 | 2.21 |
| 211662_s_at | VDAC2 | 10q22 | 2.21 |
| 206688_s_at | CPSF4 | 7q22.1 | 2.21 |
| 225635_s_at | — | 9p13.2 | 2.21 |
| 224151_s_at | AK3 | 9p24.1-p24.3 | 2.21 |
| 212296_at | PSMD14 | 2q24.2 | 2.21 |
| 218152_at | HMG20A | 15q24 | 2.21 |
| 213574_s_at | KPNB1 | 17q21.32 | 2.21 |
| 223622_s_at | HYI | 1p34.2 | 2.21 |
| 223350_x_at | LIN7C | 11p14 | 2.21 |
| 213701_at | DKFZp434N2030 | 12q21.33 | 2.21 |
| 225403_at | C9orf23 | 9p13.3 | 2.20 |
| 214047_s_at | MBD4 | 3q21-q22 | 2.20 |
| 226290_at | BDP1 | 5q12-q13 | 2.20 |
| 225724_at | FLJ31306 | 14 | 2.20 |
| 222182_s_at | CNOT2 | 12q15 | 2.20 |
| 206405_x_at | USP6 | 17q11 | 2.20 |
| 228970_at | ZBTB8OS | 1p35.1 | 2.20 |
| 214177_s_at | PBXIP1 | 1q22 | 2.19 |
| 212578_x_at | RPS17 | 15q | 2.19 |
| 207801_s_at | RNF10 | 12q24.31 | 2.19 |
| 210046_s_at | IDH2 | 15q26.1 | 2.19 |
| 218563_at | NDUFA3 | 19q13.42 | 2.19 |
| 219119_at | LSM8 | 7q31.1-q31.3 | 2.19 |
| 229120_s_at | CDC42SE1 | 1q21.2 | 2.19 |
| 213225_at | PPM1B | 2p21 | 2.19 |
| 210951_x_at | RAB27A | 15q15-q21.1 | 2.19 |
| 201864_at | GDI1 | Xq28 | 2.19 |
| 225823_at | QIL1 | 19p13.3 | 2.19 |
| 214363_s_at | MATR3 | 5q31.2 | 2.19 |
| 200788_s_at | PEA15 | 1q21.1 | 2.19 |
| 213828_x_at | H3F3A /// LOC440926 | 1q41 /// 2q31.1 | 2.19 |
| 201987_at | THRAP1 | 17q22-q23 | 2.19 |
| 231714_s_at | AP4B1 | 1p13.2 | 2.18 |
| 212036_s_at | PNN | 14q21.1 | 2.18 |
| 208716_s_at | TMCO1 | 1q22-q25 | 2.18 |
| 209695_at | PTP4A3 | 8q24.3 | 2.18 |
| 223576_at | C6orf203 | 6q21 | 2.18 |
| 200036_s_at | RPL10A | 6p21.3-p21.2 | 2.18 |
| 228318_s_at | FLJ34443 | 4p16.3 | 2.18 |
| 227677_at | JAK3 | 19p13.1 | 2.18 |
| 203707_at | ZNF263 | 16p13.3 | 2.18 |
| 204246_s_at | DCTN3 | 9p13 | 2.18 |
| 230742_at | — | 03 | 2.18 |
| 202431_s_at | MYC | 8q24.12-q24.13 | 2.18 |
| 57082_at | LDLRAP1 | 1p36-p35 | 2.18 |
| 212378_at | GART | 21q22.1\|21q22.11 | 2.18 |
| 205022_s_at | CHES1 | 14q24.3-q32.11 | 2.18 |
| 203285_s_at | HS2ST1 | 1p31.1-p22.1 | 2.17 |
| 228768_at | KIAA1961 | 5q23.3 | 2.17 |
| 226277_at | COL4A3BP | 5q13.3 | 2.17 |
| 200066_at | IK | 2p15-p14\|5q31.3 | 2.17 |
| 201293_x_at | PPIA | 7p13-p11.2 | 2.17 |
| 209066_x_at | UQCRB | 8q22 | 2.17 |
| 212455_at | YT521 | 4q13.2 | 2.17 |
| 200920_s_at | BTG1 | 12q22 | 2.17 |
| 227765_at | — | 08 | 2.17 |
| 223068_at | EML4 | 2p22-p21 | 2.17 |
| 201406_at | RPL36A | Xq22.1 | 2.17 |
| 225083_at | C6orf51 | 6q21 | 2.17 |
| 212699_at | SCAMP5 | 15q23 | 2.17 |
| 204053_x_at | PTEN | 10q23.3 | 2.17 |
| 214080_x_at | PRKCSH | 19p13.2 | 2.17 |
| 242606_at | — | | 2.17 |
| 229711_s_at | MGC5370 | 12q14.3 | 2.16 |
| 219869_s_at | SLC39A8 | 4q22-q24 | 2.16 |
| 226538_at | MAN2A1 | 5q21-q22 | 2.16 |
| 201528_at | RPA1 | 17p13.3 | 2.16 |
| 201290_at | SEC11L1 | 15q25.3 | 2.16 |
| 239629_at | CFLAR | 2q33-q34 | 2.16 |
| 200021_at | CFL1 | 11q13 | 2.16 |
| 221897_at | TRIM52 | 5q35.3 | 2.16 |
| 209448_at | HTATIP2 | 11p15.1 | 2.16 |
| 226511_at | — | 09 | 2.16 |
| 224867_at | C1orf151 | 1p36.13 | 2.16 |
| 210908_s_at | PFDN5 | 12q12 | 2.16 |
| 235427_at | — | 02 | 2.16 |
| 212802_s_at | GAPVD1 | 9q33.3 | 2.16 |
| 201641_at | BST2 | 19p13.2 | 2.16 |
| 212536_at | ATP11B | 3q27 | 2.16 |
| 225967_s_at | LOC284184 | 17q25.3 | 2.16 |
| 212082_s_at | MYL6 | 12q13.2 | 2.16 |
| 228751_at | CLK4 | 5q35 | 2.16 |
| 212010_s_at | H41 | 3q22.1 | 2.16 |
| 35974_at | LRMP | 12p12.1 | 2.15 |
| 212270_x_at | RPL17 | 18q21 | 2.15 |
| 222423_at | NDFIP1 | 5q31.3 | 2.15 |
| 217802_s_at | NUCKS1 | 1q32.1 | 2.15 |
| 201254_x_at | RPS6 | 9p21 | 2.15 |
| 225509_at | LOC56757 | 5q31-q32 | 2.15 |
| 210705_s_at | TRIM5 | 11p15 | 2.15 |
| 208718_at | DDX17 | 22q13.1 | 2.15 |
| 229410_at | PAEP | 9q34 | 2.15 |
| 200657_at | SLC25A5 | Xq24-q26 | 2.15 |
| 225332_at | KRTAP4-7 | 17q12-q21 | 2.15 |
| 222986_s_at | SCOTIN | 3p21.31 | 2.15 |
| 220746_s_at | RAP80 | 5q35.2 | 2.15 |
| 221522_at | ANKRD27 | 19q13.11 | 2.14 |
| 202688_at | TNFSF10 | 3q26 | 2.14 |
| 224890_s_at | LOC389541 | 7q22.1 | 2.14 |
| 212534_at | ZNF24 | 18q12 | 2.14 |
| 222229_x_at | RPL26 /// LOC391126 /// | 17p13 /// 1q24.1 /// | 2.14 |
| | LOC392501 /// LOC400055 /// | Xq21.31 /// 12q21.31 /// | |
| | LOC441073 /// LOC441533 | 5q11.2 /// Yp11.2 | |
| 201558_at | RAE1 | 20q13.32 | 2.14 |
| 214152_at | PIGB | 15q21-q22 | 2.14 |
| 218852_at | C14orf10 | 14q13.2 | 2.14 |
| 218048_at | COMMD3 | 10pter-q22.1 | 2.14 |
| 201409_s_at | PPP1CB | 2p23 | 2.14 |
| 212483_at | NIPBL | 5p13.2 | 2.14 |
| 200015_s_at | 2-Sep | 2q37 | 2.14 |
| 203513_at | FLJ21439 | 15q14 | 2.14 |
| 222533_at | CRBN | 3p26.2 | 2.14 |
| 209563_x_at | CALM1 | 14q24-q31 | 2.13 |
| 208909_at | UQCRFS1 | 19q12-q13.1 | 2.13 |
| 226923_at | SCFD2 | 4q12 | 2.13 |
| 225260_s_at | MRPL32 | 7p14 | 2.13 |
| 224692_at | PPP1R15B | 1q32.1 | 2.13 |
| 226831_at | LOC91137 | 5q22.1 | 2.13 |
| 212060_at | SR140 | 3q23 | 2.13 |
| 213603_s_at | RAC2 | 22q13.1 | 2.13 |
| 221493_at | TSPYL1 | 6q22-q23 | 2.13 |
| 217939_s_at | AFTIPHILIN | 2p14 | 2.12 |
| 200704_at | LITAF | 16p13.13 | 2.12 |
| 225763_at | RCSD1 | 1q22-q24 | 2.12 |
| 213754_s_at | PAIP1 /// LOC388345 | 5p12 /// 17p11.2 | 2.12 |
| 223005_s_at | C9orf5 | 9q31 | 2.12 |
| 212661_x_at | PPIA | 7p13-p11.2 | 2.11 |
| 201244_s_at | RAF1 | 3p25 | 2.11 |
| 230669_at | RASA2 | 3q22-q23 | 2.11 |
| 207040_s_at | ST13 | 22q13.2 | 2.11 |
| 221865_at | C9orf91 | 9q32 | 2.11 |
| 223682_s_at | MGC11102 | 11q13.1 | 2.11 |
| 224675_at | MESDC2 | 15q13 | 2.11 |
| 214662_at | WDR43 | 2p23.2 | 2.11 |
| 226426_at | ADNP | 20q13.13 | 2.11 |
| 208768_x_at | RPL22 | 1p36.3-p36.2 | 2.10 |
| 213361_at | TDRD7 | 9q22.33 | 2.10 |
| 226140_s_at | OTUD1 | 10p12.31 | 2.10 |
| 225927_at | MAP3K1 | 5q11.2 | 2.10 |
| 202659_at | PSMB10 | 16q22.1 | 2.10 |
| 208979_at | NCOA6 | 20q11 | 2.10 |
| 202519_at | MONDOA | 12q21.31 | 2.10 |
| 224561_s_at | MORF4L1 | 15q24 | 2.10 |
| 201762_s_at | PSME2 | 14q11.2 | 2.10 |
| 208655_at | CCNI | 4q21.1 | 2.10 |
| 227525_at | GLCCI1 | 7p21.3 | 2.10 |
| 227132_at | LOC51123 | 8q22.3 | 2.10 |
| 208610_s_at | SRRM2 | 16p13.3 | 2.10 |
| 217398_x_at | GAPDH | 12p13 | 2.10 |
| 211978_x_at | PPIA | 7p13-p11.2 | 2.09 |
| 225112_at | ABI2 | 2q33 | 2.09 |
| 209084_s_at | RAB28 | 4p15.33 | 2.09 |
| 227346_at | ZNFN1A1 | 7p13-p11.1 | 2.09 |
| 218740_s_at | CDK5RAP3 | 17q21.32 | 2.09 |
| 200976_s_at | TAX1BP1 | 7p15 | 2.09 |
| 216652_s_at | DR1 | 1p22.1 | 2.09 |
| 208809_s_at | C6orf62 | 6p22.2 | 2.09 |
| 209648_x_at | SOCS5 | 2p21 | 2.09 |
| 203200_s_at | MTRR | 5p15.3-p15.2 | 2.09 |
| 201381_x_at | CACYBP | 1q24-q25 | 2.08 |
| 203028_s_at | CYBA | 16q24 | 2.08 |
| 213101_s_at | ACTR3 | 2q14.1 | 2.08 |
| 201060_x_at | STOM | 9q34.1 | 2.08 |
| 200963_x_at | RPL31 | 2q11.2 | 2.08 |
| 226652_at | USP3 | 15q22.3 | 2.08 |
| 213786_at | — | 07 | 2.08 |
| 227499_at | — | 08 | 2.08 |
| 224755_at | SMBP | 10q24.1 | 2.08 |
| 212914_at | CBX7 | 22q13.1 | 2.08 |
| 214288_s_at | PSMB1 | 6q27 | 2.08 |
| 212242_at | TUBA1 | 2q35 | 2.08 |
| 229513_at | STRBP | 9q33.3 | 2.08 |
| 202395_at | NSF | 17q21 | 2.08 |
| 234873_x_at | RPL7A /// LOC133748 /// | 9q34 /// 5q14.1 /// 18q12.2-q12.3 | 2.08 |
| | LOC388474 | | |
| 222982_x_at | SLC38A2 | 12q | 2.08 |
| 201930_at | MCM6 | 2q21 | 2.08 |
| 201782_s_at | AIP | 11q13.3 | 2.08 |
| 217961_at | FLJ20551 | 3p22.2 | 2.08 |
| 200994_at | IPO7 | 11p15.4 | 2.08 |
| 220306_at | FAM46C | 1p12 | 2.08 |
| 1569349_at | C11orf30 | 11q13.5 | 2.07 |
| 201318_s_at | MRCL3 /// MRLC2 | 18p11.31 | 2.07 |
| 210588_x_at | HNRPH3 | 10q22 | 2.07 |
| 203943_at | KIF3B | 20q11.21 | 2.07 |
| 221652_s_at | C12orf11 | 12p11.23 | 2.07 |
| 232511_at | RANBP2L1 | 2q13 | 2.07 |
| 221726_at | RPL22 | 1p36.3-p36.2 | 2.07 |
| 215671_at | PDE4B | 1p31 | 2.07 |
| 218387_s_at | PGLS | 19p13.2 | 2.07 |
| 212891_s_at | GADD45GIP1 | 19p13.13 | 2.07 |
| 203023_at | HSPC111 | 5q35.2 | 2.07 |
| 212846_at | KIAA0179 | 21q22.3 | 2.07 |
| 229872_s_at | LOC440667 /// LOC440669 /// | 1q21.1 | 2.07 |
| | LOC440688 | | |
| 222444_at | ARMCX3 | Xq21.33-q22.2 | 2.07 |
| 200792_at | XRCC6 | 22q13.2-q13.31 | 2.07 |
| 200750_s_at | RAN | 12q24.3 | 2.07 |
| 201620_at | MBTPS1 | 16\|16q24 | 2.07 |
| 205684_s_at | C9orf55 | 9p22.1 | 2.06 |
| 213694_at | RSBN1 | 1p13.2 | 2.06 |
| 226382_at | LOC283070 | 10p14 | 2.06 |
| 210580_x_at | SULT1A3 /// SULT1A4 | 16p11.2 | 2.06 |
| 227224_at | RALGPS2 | 1q25.2 | 2.06 |
| 200809_x_at | RPL12 | 9q34 | 2.06 |
| 201567_s_at | GOLGA4 | 3p22-p21.3 | 2.06 |
| 212040_at | TGOLN2 | 2p11.2 | 2.06 |
| 202300_at | HBXIP | 1p13.3 | 2.06 |
| 200726_at | PPP1CC | 12q24.1-q24.2 | 2.06 |
| 213016_at | BBX | 3q13.1 | 2.06 |
| 225225_at | — | 15 | 2.05 |
| 228106_at | FLJ20280 | 4p15.32 | 2.05 |
| 213294_at | FLJ38348 | 2p22.2 | 2.05 |
| 202642_s_at | TRRAP | 7q21.2-q22.1 | 2.05 |
| 211529_x_at | HLA-G | 6p21.3 | 2.05 |
| 225866_at | BXDC1 | 6q21 | 2.05 |
| 228173_at | GNAS | 20q13.2-q13.3 | 2.05 |
| 200692_s_at | HSPA9B | 5q31.1 | 2.05 |
| 201361_at | MGC5508 | 11q12.2 | 2.05 |
| 200825_s_at | HYOU1 | 11q23.1-q23.3 | 2.05 |
| 208648_at | VCP | 9p13.3 | 2.05 |
| 224587_at | PC4 | 5p13.3 | 2.05 |
| 200062_s_at | RPL30 | 8q22 | 2.05 |
| 203143_s_at | KIAA0040 | 1q24-25 | 2.05 |
| 1559942_at | — | 07 | 2.04 |
| 224502_s_at | KIAA1191 | 5q35.2 | 2.04 |
| 225472_at | BAT4 | 6p21.3 | 2.04 |
| 218543_s_at | PARP12 | 7q34 | 2.04 |
| 201051_at | ANP32A | 15q22.3-q23 | 2.04 |
| 225581_s_at | MRPL50 | 9q31.1 | 2.04 |
| 205042_at | GNE | 9p13.2 | 2.04 |
| 207585_s_at | RPL36AL | 14q21 | 2.04 |
| 221230_s_at | ARID4B | 1q42.1-q43 | 2.04 |
| 212179_at | C6orf111 | 6q16.3 | 2.04 |
| 217848_s_at | PP | 10q11.1-q24 | 2.04 |
| 1556285_s_at | PPA2 | 4q25 | 2.04 |
| 200910_at | CCT3 | 1q23 | 2.04 |
| 212815_at | ASCC3 | 6q16 | 2.04 |
| 213567_at | — | 03 | 2.03 |
| 208773_s_at | ANKHD1 /// MASK-BP3 | 5q31.2 /// 5q31.3 | 2.03 |
| 209199_s_at | MEF2C | 5q14 | 2.03 |
| 217492_s_at | PTENP1 | 9p21 | 2.03 |
| 227421_at | C21orf57 | 21q22.3 | 2.03 |
| 202466_at | POLS | 5p15 | 2.03 |
| 200992_at | IPO7 | 11p15.4 | 2.03 |
| 225235_at | TSPAN17 | 5q35.3 | 2.03 |
| 218041_x_at | SLC38A2 | 12q | 2.03 |
| 228370_at | SNRPN | 15q11.2 | 2.03 |
| 225932_s_at | HNRPA2B1 | 7p15 | 2.03 |
| 224591_at | HP1BP3 | 1p36.12 | 2.03 |
| 202621_at | IRF3 | 19q13.3-q13.4 | 2.03 |
| 223436_s_at | MGC11134 | 11q13.1 | 2.02 |
| 218422_s_at | C13orf10 | 13q31.1 | 2.02 |
| 221452_s_at | TMEM14B | 6p25.1-p23 | 2.02 |
| 233746_x_at | SERF2 /// HYPK | 15q15.3 | 2.02 |
| 202336_s_at | PAM | 5q14-q21 | 2.02 |
| 226589_at | FLJ38482 | 4q32.3 | 2.02 |
| 212721_at | SFRS12 | 5q12.3 | 2.02 |
| 226413_at | LOC400027 | 12q12 | 2.02 |
| 212117_at | RHOQ | 2p21 | 2.02 |
| 225158_at | GFM1 | 3q25.1-q26.2 | 2.02 |
| 203983_at | TSNAX | 1q42.1 | 2.02 |
| 209067_s_at | HNRPDL | 4q13-q21 | 2.02 |
| 218084_x_at | FXYD5 | 19q12-q13.1 | 2.02 |
| 217752_s_at | CNDP2 | 18q22.3 | 2.02 |
| 202302_s_at | FLJ11021 | 12q24.31 | 2.01 |
| 235775_at | DKFZp762A217 | 12q21.31 | 2.01 |
| 231850_x_at | KIAA1712 | 4q34 | 2.01 |
| 209358_at | TAF11 | 6p21.31 | 2.01 |
| 209610_s_at | SLC1A4 | 2p15-p13 | 2.01 |
| 218034_at | TTC11 | 7q22.1 | 2.01 |
| 218674_at | FLJ13611 | 5q12.3 | 2.01 |
| 225116_at | HIPK2 | 7q32-q34 | 2.01 |
| 208891_at | DUSP6 | 12q22-q23 | 2.01 |
| 205596_s_at | SMURF2 | 17q22-q23 | 2.01 |
| 201011_at | RPN1 | 3q21.3 | 2.01 |
| 225397_at | MGC20481 | 15q15.1 | 2.01 |
| 222708_s_at | STX17 | 9q31.1 | 2.01 |
| 217950_at | NOSIP | 19q13.33 | 2.00 |
| 226773_at | — | 04 | 2.00 |
| 218501_at | ARHGEF3 | 3p21-p13 | 2.00 |
| 200030_s_at | SLC25A3 | 12q23 | 2.00 |
| 213440_at | RAB1A | 2p14 | 2.00 |
| 224879_at | C9orf123 | 9p24.1 | 2.00 |
| 223288_at | USP38 | 04 | 2.00 |
| 230792_at | FLJ31204 | Xp11.1 | 2.00 |
| 212953_x_at | CALR | 19p13.3-p13.2 | 2.00 |
| 202001_s_at | NDUFA6 | 22q13.2-q13.31 | 2.00 |
| 229146_at | C7orf31 | 7p15.3 | 2.00 |
| 228972_at | — | 17 | 2.00 |
| 225995_x_at | MGC52000 | 2q14.1 | 2.00 |
| 221775_x_at | RPL22 | 1p36.3-p36.2 | 2.00 |
| 217880_at | CDC27 | 17q12-17q23.2 | 1.99 |
| 218356_at | FTSJ2 | 7p22 | 1.99 |
| 214661_s_at | C4orf9 | 4p16.3 | 1.99 |
| 223190_s_at | MLL5 | 7q22.1 | 1.99 |
| 224566_at | TncRNA | 11q13.1 | 1.99 |
| 225120_at | PURB | 7p13 | 1.99 |
| 208127_s_at | SOCS5 | 2p21 | 1.99 |
| 203697_at | FRZB | 2qter | 1.99 |
| 228084_at | — | 04 | 1.99 |
| 208619_at | DDB1 | 11q12-q13 | 1.99 |
| 218703_at | SEC22L2 | 3q21.1 | 1.99 |
| 223106_at | TMEM14C | 6p24.1 | 1.99 |
| 203646_at | FDX1 | 11q22 | 1.98 |
| 206332_s_at | IFI16 | 1q22 | 1.98 |
| 203216_s_at | MYO6 | 6q13 | 1.98 |
| 239735_at | — | 05 | 1.98 |
| 214459_x_at | HLA-C | 6p21.3 | 1.98 |
| 233759_s_at | KIAA1387 | 2p16.1 | 1.98 |
| 235587_at | LOC202781 | 7q36.3 | 1.98 |
| 231839_at | 2′-PDE | 3p14.3 | 1.98 |
| 213214_x_at | ACTG1 | 17q25 | 1.98 |
| 203837_at | MAP3K5 | 6q22.33 | 1.98 |
| 208929_x_at | RPL13 | 16q24.3\|17p11.2 | 1.98 |
| 200777_s_at | BZW1 | 2q33 | 1.98 |
| 208763_s_at | TSC22D3 | Xq22.3 | 1.98 |
| 215157_x_at | PABPC1 | 8q22.2-q23 | 1.97 |
| 208051_s_at | PAIP1 | 5p12 | 1.97 |
| 214736_s_at | ADD1 | 4p16.3 | 1.97 |
| 218395_at | ACTR6 | 12q23.1 | 1.97 |
| 202170_s_at | AASDHPPT | 11q22 | 1.97 |
| 225768_at | NR1D2 | 3p24.2 | 1.97 |
| 204258_at | CHD1 | 5q15-q21 | 1.97 |
| 207318_s_at | CDC2L5 | 7p13 | 1.97 |
| 217834_s_at | SYNCRIP | 6q14-q15 | 1.97 |
| 225136_at | PLEKHA2 | 8p11.23 | 1.97 |
| 226979_at | MAP3K2 | 2q14.3 | 1.97 |
| 238465_at | MGC33648 | 5q11.2 | 1.97 |
| 201359_at | COPB | 11p15.2 | 1.97 |
| 220367_s_at | SAP130 | 2q14.3 | 1.97 |
| 209265_s_at | METTL3 | 14q11.1 | 1.97 |
| 213730_x_at | TCF3 | 19p13.3 | 1.97 |
| 208308_s_at | GPI | 19q13.1 | 1.97 |
| 226115_at | AHCTF1 | 1q44 | 1.97 |
| 209023_s_at | STAG2 | Xq25 | 1.97 |
| 225706_at | GLCCI1 | 7p21.3 | 1.96 |
| 209180_at | RABGGTB | 1p31 | 1.96 |
| 203804_s_at | CROP | 17q21.33 | 1.96 |
| 224621_at | — | 22q11.21 | 1.96 |
| 40225_at | GAK | 4p16 | 1.96 |
| 209200_at | MEF2C | 5q14 | 1.96 |
| 223474_at | C14orf4 | 14q24.3 | 1.96 |
| 208946_s_at | BECN1 | 17q21 | 1.96 |
| 201055_s_at | HNRPA0 | 5q31 | 1.96 |
| 224718_at | SLC25A29 | 14q32.2 | 1.96 |
| 218259_at | MKL2 | 16p13.12 | 1.96 |
| 201960_s_at | MYCBP2 | 13q22 | 1.96 |
| 201061_s_at | STOM | 9q34.1 | 1.96 |
| 212601_at | ZZEF1 | 17p13.2 | 1.96 |
| 212099_at | RHOB | 2p24 | 1.96 |
| 236125_at | DKFZp586I1420 | 7p15.1 | 1.96 |
| 202371_at | TCEAL4 | Xq22.2 | 1.96 |
| 200086_s_at | COX4I1 | 16q22-qter | 1.96 |
| 227455_at | C6orf136 | 6p21.33 | 1.95 |
| 206342_x_at | IDS | Xq28 | 1.95 |
| 202957_at | HCLS1 | 3q13 | 1.95 |
| 223423_at | GPR160 | 3q26.2-q27 | 1.95 |
| 200705_s_at | EEF1B2 | 2q33-q34 | 1.95 |
| 224516_s_at | CXXC5 | 5q31.2 | 1.95 |
| 208948_s_at | STAU | 20q13.1 | 1.95 |
| 210211_s_at | HSPCA | 14q32.33 | 1.95 |
| 224889_at | FOXO3A | 6q21 | 1.95 |
| 210649_s_at | ARID1A | 1p35.3 | 1.95 |
| 222550_at | ARMC1 | 8q13.1 | 1.95 |
| 224129_s_at | LOC84661 | 2p22.3 | 1.95 |
| 201152_s_at | MBNL1 | 3q25 | 1.95 |
| 222998_at | MAF1 | 8q24.3 | 1.95 |
| 205072_s_at | XRCC4 | 5q13-q14 | 1.95 |
| 233124_s_at | ECHDC1 | 6q22.33 | 1.95 |
| 213390_at | C19orf7 | 19q13.32 | 1.94 |
| 212648_at | DHX29 | 5q11.2 | 1.94 |
| 201863_at | FAM32A | 19pter-p13.3 | 1.94 |
| 218226_s_at | NDUFB4 | 3q13.33 | 1.94 |
| 224331_s_at | MRPL36 | 5p15.3 | 1.94 |
| 201273_s_at | SRP9 | 1q42.12 | 1.94 |
| 222199_s_at | BIN3 | 8p21.3 | 1.94 |
| 203359_s_at | MYCBP | 1p33-p32.2 | 1.94 |
| 224617_at | — | 09 | 1.94 |
| 201857_at | ZFR | 5p13.3 | 1.94 |
| 202745_at | USP8 | 15q21.2 | 1.94 |
| 218166_s_at | HBXAP | 11q13.5 | 1.94 |
| 202160_at | CREBBP | 16p13.3 | 1.93 |
| 203569_s_at | OFD1 | Xp22.2-p22.3 | 1.93 |
| 211271_x_at | PTBP1 | 19p13.3 | 1.93 |
| 201345_s_at | UBE2D2 | 5q31.2 | 1.93 |
| 213366_x_at | ATP5C1 | 10p15.1 | 1.93 |
| 217887_s_at | EPS15 | 1p32 | 1.93 |
| 214730_s_at | GLG1 | 16q22-q23 | 1.93 |
| 206513_at | AIM2 | 1q22 | 1.93 |
| 226251_at | — | 02 | 1.93 |
| 231035_s_at | OTUD1 | 10p12.31 | 1.93 |
| 203284_s_at | HS2ST1 | 1p31.1-p22.1 | 1.93 |
| 208722_s_at | ANAPC5 | 12q24.31 | 1.93 |
| 39582_at | CYLD | 16q12-q13 | 1.93 |
| 1567214_a_at | PNN | 14q21.1 | 1.93 |
| 202031_s_at | WIPI-2 | 7p22.1 | 1.93 |
| 217730_at | PP1201 | 2p24.3-p24.1 | 1.93 |
| 201197_at | AMD1 | 6q21-q22 | 1.93 |
| 222621_at | DNAJC1 | 10p12.31 | 1.93 |
| 202653_s_at | 7-Mar | 2q24.2 | 1.93 |
| 217900_at | IARS2 | 1q41 | 1.93 |
| 239377_at | MGC11102 | 11q13.1 | 1.93 |
| 201463_s_at | TALDO1 | 11p15.5-p15.4 | 1.93 |
| 221532_s_at | WDR61 | 15q25.1 | 1.92 |
| 228095_at | PHF14 | 7p21.3 | 1.92 |
| 209580_s_at | MBD4 | 3q21-q22 | 1.92 |
| 215023_s_at | PEX1 | 7q21-q22 | 1.92 |
| 211986_at | AHNAK | 11q12.2 | 1.92 |
| 225686_at | FAM33A | 17q23.2 | 1.92 |
| 207127_s_at | HNRPH3 | 10q22 | 1.92 |
| 201603_at | PPP1R12A | 12q15-q21 | 1.92 |
| 202318_s_at | SENP6 | 6q13-q14.3 | 1.92 |
| 219363_s_at | MTERFD1 | 8q22.1 | 1.91 |
| 224831_at | CPEB4 | 5q21 | 1.91 |
| 200088_x_at | RPL12 | 9q34 | 1.91 |
| 212053_at | KIAA0251 | 16p13.11 | 1.91 |
| 223396_at | TMEM60 | 7q11.23 | 1.91 |
| 226694_at | PALM2-AKAP2 | 9q31-q33 | 1.91 |
| 221488_s_at | C6orf82 | 6pter-p21.31 | 1.91 |
| 206240_s_at | ZNF136 | 19p13.2-p13.12 | 1.91 |
| 202042_at | HARS | 5q31.3 | 1.91 |
| 220525_s_at | AUP1 | 2p13 | 1.91 |
| 218403_at | P53CSV | 12q24.31 | 1.91 |
| 1554089_s_at | SBDS /// SBDSP | 7q11.21 /// 7q11.23 | 1.91 |
| 208826_x_at | HINT1 | 5q31.2 | 1.90 |
| 205480_s_at | UGP2 | 2p14-p13 | 1.90 |
| 201748_s_at | SAFB | 19p13.3-p13.2 | 1.90 |
| 215780_s_at | SET /// LOC389168 | 9q34 /// 3q25.31 | 1.90 |
| 212635_at | TNPO1 | 5q13.2 | 1.90 |
| 213879_at | SUMO2 | 17q25.1 | 1.90 |
| 203613_s_at | NDUFB6 | 9p21.1 | 1.90 |
| 213503_x_at | ANXA2 | 15q21-q22 | 1.90 |
| 213086_s_at | CSNK1A1 | 5q32 | 1.90 |
| 224967_at | UGCG | 9q31 | 1.90 |
| 217958_at | TRAPPC4 | 11q23.3 | 1.90 |
| 202424_at | MAP2K2 | 19p13.3 | 1.90 |
| 208904_s_at | RPS28 | 19p13.2 | 1.90 |
| 230078_at | KIAA1961 | 5q23.3 | 1.90 |
| 213453_x_at | GAPDH | 12p13 | 1.90 |
| 201692_at | OPRS1 | 9p13.3 | 1.90 |
| 200049_at | MYST2 | 17q21.32 | −2.12 |
| 210561_s_at | WSB1 | 17q11.1 | −2.12 |
| 1552612_at | CDC42SE2 | 5q23.3 | −2.12 |
| 63009_at | SHQ1 | 3p13 | −2.13 |
| 225673_at | MYADM | 19q13.42 | −2.13 |
| 212370_x_at | FAM21B /// LOC387680 | 10q11.22 /// 10q11.23 | −2.13 |
| 38710_at | OTUB1 | 11q13.1 | −2.13 |
| 1566003_x_at | — | 16 | −2.13 |
| 241490_s_at | — | 01 | −2.13 |
| 208730_x_at | RAB2 | 8q12.1 | −2.14 |
| 232749_at | RAB12 | 18p11.22 | −2.14 |
| 207665_at | ADAM21 | 14q24.1 | −2.14 |
| 228565_at | KIAA1804 | 1q42 | −2.14 |
| 205140_at | FPGT | 1p31.1 | −2.14 |
| 241202_at | GALNT10 | 5q33.2 | −2.15 |
| 225897_at | MARCKS | 6q22.2 | −2.15 |
| 203363_s_at | KIAA0652 | 11p11.2 | −2.15 |
| 218091_at | HRB | 2q36.3 | −2.15 |
| 1557810_at | CCT5 | 5p15.2 | −2.15 |
| 234143_at | — | 05 | −2.16 |
| 224630_at | C2orf30 | 2p16.3 | −2.16 |
| 226198_at | TOM1L2 | 17p11.2 | −2.16 |
| 209136_s_at | USP10 | 16q24.1 | −2.16 |
| 223602_at | USP30 | 12q24.11 | −2.16 |
| 212625_at | STX10 | 19p13.13 | −2.16 |
| 201494_at | PRCP | 11q14 | −2.17 |
| 217540_at | — | 03 | −2.17 |
| 207408_at | SLC22A14 | 3p21.3 | −2.17 |
| 202919_at | PREI3 | 2q33.1 | −2.18 |
| 218021_at | DHRS4 | 14q11.2 | −2.18 |
| 211693_at | MGC27165 | 14q32.33 | −2.18 |
| 1552632_a_at | KIAA1001 | 17q24.2 | −2.19 |
| 211754_s_at | SLC25A17 | 22q13.2 | −2.19 |
| 222699_s_at | PLEKHF2 | 8q22.1 | −2.19 |
| 209782_s_at | DBP | 19q13.3 | −2.19 |
| 242895_x_at | RNF39 | 6p21.3 | −2.19 |
| 201830_s_at | NET1 | 10p15 | −2.20 |
| 244016_at | — | — | −2.20 |
| 230648_at | LOC283663 | 15q21.3 | −2.21 |
| 232066_x_at | MGC21675 | 4p16.3 | −2.21 |
| 211543_s_at | GRK6 | 5q35 | −2.21 |
| 219180_s_at | PEX26 | 22q11.21 | −2.21 |
| 47560_at | LPHN1 | 19p13.2 | −2.21 |
| 1553153_at | ATP6V0D2 | 08 | −2.21 |
| 206846_s_at | HDAC6 | Xp11.23 | −2.22 |
| 242787_at | INCENP | 11q12-q13 | −2.22 |
| 211416_x_at | GGTLA4 | 20p11.1 | −2.22 |
| 201647_s_at | SCARB2 | 4q21.1 | −2.22 |
| 218218_at | DIP13B | 12q24.1 | −2.22 |
| 224560_at | TIMP2 | 17q25 | −2.22 |
| 1561683_at | — | 01 | −2.22 |
| 228003_at | RAB30 | 11q12-q14 | −2.23 |
| 1566002_at | — | 16 | −2.23 |
| 239960_x_at | — | | −2.24 |
| 230592_at | C1orf48 | 1q41 | −2.24 |
| 208704_x_at | APLP2 | 11q23-q25\|11q24 | −2.25 |
| 206478_at | KIAA0125 | 14q32.33 | −2.25 |
| 218582_at | 5-Mar | 10q23.32-q23.33 | −2.25 |
| 211610_at | KLF6 | 10p15 | −2.25 |
| 229693_at | LOC388335 | 17p13.1 | −2.25 |
| 234974_at | GALM | 2p22.1 | −2.26 |
| 213957_s_at | CAP350 | 1p36.13-q41 | −2.26 |
| 225263_at | HS6ST1 | 2q21 | −2.26 |
| 223650_s_at | NRBF2 | 10q21.3 | −2.26 |
| 1570248_at | GNB1 | 1p36.33 | −2.26 |
| 231449_at | — | 02 | −2.27 |
| 227143_s_at | BID | 22q11.1 | −2.27 |
| 202902_s_at | CTSS | 1q21 | −2.27 |
| 209379_s_at | KIAA1128 | 10q23.1 | −2.27 |
| 218866_s_at | POLR3K | 16p13.3 | −2.27 |
| 240015_at | — | 10p15.1 | −2.27 |
| 211935_at | ARL6IP | 16p12-p11.2 | −2.28 |
| 228240_at | — | 02 | −2.28 |
| 202092_s_at | ARL2BP | 16q13 | −2.28 |
| 236539_at | PTPN22 | 1p13.3-p13.1 | −2.28 |
| 228906_at | CXXC6 | 10q21 | −2.28 |
| 209882_at | RIT1 | 1q22 | −2.28 |
| 223356_s_at | MTIF3 | 13q12.2 | −2.29 |
| 243148_at | TJP2 | 9q13-q21 | −2.29 |
| 225756_at | CSNK1E | 22q13.1 | −2.29 |
| 232264_at | EDD | 8q22 | −2.29 |
| 218888_s_at | NETO2 | 16q11 | −2.29 |
| 235648_at | ZNF567 | 19q13.12 | −2.29 |
| 203967_at | CDC6 | 17q21.3 | −2.29 |
| 37232_at | KIAA0586 | 14q23.1 | −2.30 |
| 225042_s_at | C12orf22 | 12q13.11-q13.12 | −2.30 |
| 224405_at | FCRL5 | 1q21 | −2.30 |
| 211945_s_at | ITGB1 | 10p11.2 | −2.30 |
| 208832_at | ATXN10 | 22q13.31 | −2.30 |
| 226580_at | BRMS1L | 14q13.2 | −2.30 |
| 205550_s_at | BRE | 2p23.2 | −2.31 |
| 37170_at | BMP2K | 4q21.21 | −2.31 |
| 205698_s_at | MAP2K6 | 17q24.3 | −2.31 |
| 50314_i_at | C20orf27 | 20p13 | −2.32 |
| 229465_s_at | PTPRS | 19p13.3 | −2.32 |
| 218173_s_at | WHSC1L1 | 8p11.2 | −2.32 |
| 211068_x_at | FAM21C /// LOC439973 | 10q11.1 /// 10q11.23 | −2.32 |
| 222657_s_at | FLJ11011 | 8q21.11 | −2.33 |
| 219675_s_at | UXS1 | 2q12.2 | −2.33 |
| 232471_at | MYO1E | 15q21-q22 | −2.33 |
| 1557276_at | — | 06 | −2.33 |
| 211630_s_at | GSS | 20q11.2 | −2.33 |
| 212293_at | HIPK1 | 1p13.2 | −2.33 |
| 1559052_s_at | PAK2 | 3q29 | −2.33 |
| 210284_s_at | MAP3K7IP2 | 6q25.1-q25.3 | −2.34 |
| 231106_at | LOC255326 | 10q11.22 | −2.34 |
| 52741_at | C14orf172 | 14q32.32 | −2.34 |
| 205745_x_at | ADAM17 | 2p25 | −2.35 |
| 221006_s_at | SNX27 | 1q21.3 | −2.35 |
| 211074_at | FOLR1 | 11q13.3-q14.1 | −2.36 |
| 200928_s_at | RAB14 | 9q32-q34.11 | −2.36 |
| 238675_x_at | MGC23908 | 1p32.3 | −2.37 |
| 204903_x_at | APG4B | 2q37.3 | −2.38 |
| 244764_at | HIVEP3 | 1p34 | −2.38 |
| 1554167_a_at | GOLGA7 | 8p11.21 | −2.38 |
| 227035_x_at | LOC441212 | 7p14.3 | −2.39 |
| 213340_s_at | KIAA0495 | 1p36.32 | −2.40 |
| 235479_at | CPEB2 | 4p15.33 | −2.40 |
| 238437_at | LOC390980 | 19q13.43 | −2.40 |
| 226354_at | LACTB | 15q22.1 | −2.40 |
| 1562476_at | RAD51 | 15q15.1 | −2.40 |
| 224555_x_at | IL1F7 | 2q12-q14.1 | −2.40 |
| 211734_s_at | FCER1A | 1q23 | −2.40 |
| 208540_x_at | S100A11 | 1q21 | −2.40 |
| 208733_at | RAB2 | 8q12.1 | −2.40 |
| 227125_at | IFNAR2 | 21q22.1 | −2.41 |
| 239084_at | SNAP29 | 22q11.21 | −2.41 |
| 201050_at | PLD3 | 19q13.2 | −2.41 |
| 204565_at | THEM2 | 6p22.2 | −2.41 |
| 37793_r_at | RAD51L3 | 17q11 | −2.41 |
| 223228_at | LDOC1L | 22q13.31 | −2.41 |
| 1568678_s_at | FGFR1OP | 6q27 | −2.42 |
| 1554344_s_at | AQP12B /// AQP12A | 2q37.3 | −2.42 |
| 206468_s_at | KIAA0859 | 1q24-q25.3 | −2.42 |
| 1557818_x_at | — | 13 | −2.42 |
| 215521_at | PHC3 | 3q26.2 | −2.42 |
| 210935_s_at | WDR1 | 4p16.1 | −2.42 |
| 226887_at | HSPA14 | 10p13 | −2.43 |
| 202535_at | FADD | 11q13.3 | −2.43 |
| 1568696_at | ARMETL1 | 10p14 | −2.43 |
| 235258_at | DCP2 | 5q22.2 | −2.44 |
| 219095_at | PLA2G4B | 15q11.2-q21.3 | −2.44 |
| 218725_at | SLC25A22 | 11p15.5 | −2.45 |
| 204624_at | ATP7B | 13q14.3 | −2.45 |
| 238035_at | SP3 | 2q31 | −2.45 |
| 244022_at | FNDC3B | 3q26.31 | −2.45 |
| 205372_at | PLAG1 | 8q12 | −2.46 |
| 222441_x_at | C20orf45 | 20q13.32 | −2.46 |
| 215528_at | — | 02 | −2.46 |
| 238795_at | C10orf18 | 10p15.1 | −2.46 |
| 241996_at | — | 10 | −2.46 |
| 1553678_a_at | ITGB1 | 10p11.2 | −2.47 |
| 215032_at | RREB1 | 6p25 | −2.47 |
| 1562256_at | NALP1 | 17p13 | −2.48 |
| 224886_at | LOC339123 | 16p13.3 | −2.48 |
| 214582_at | PDE3B | 11p15.1 | −2.48 |
| 209964_s_at | ATXN7 | 3p21.1-p12 | −2.48 |
| 222207_x_at | — | 07 | −2.48 |
| 215177_s_at | ITGA6 | 2q31.1 | −2.48 |
| 230082_at | LRRFIP2 | 3p22.3 | −2.48 |
| 232440_at | ZDHHC13 | 11p15.1 | −2.48 |
| 218871_x_at | GALNACT-2 | 10q11.21 | −2.48 |
| 203266_s_at | MAP2K4 | 17p11.2 | −2.48 |
| 202805_s_at | ABCC1 | 16p13.1 | −2.49 |
| 222955_s_at | FAM45B /// FAM45A | Xq25 /// 10q25 | −2.49 |
| 223354_x_at | C2orf33 | 2q36.3 | −2.50 |
| 215758_x_at | ZNF505 | 19p12 | −2.50 |
| 227338_at | LOC440983 | 3q25.1 | −2.50 |
| 212835_at | KIAA0157 | 10q26.13 | −2.51 |
| 202510_s_at | TNFAIP2 | 14q32 | −2.51 |
| 217499_x_at | OR7E37P | 13q14.11 | −2.51 |
| 201775_s_at | KIAA0494 | 1pter-p22.1 | −2.52 |
| 206194_at | HOXC4 /// FLJ12825 | 12q13.3 /// 12q13.13 | −2.52 |
| 1557193_at | PTPN2 | 18p11.3-p11.2 | −2.52 |
| 243913_at | MYOM2 | 8p23.3 | −2.53 |
| 212311_at | KIAA0746 | 4p15.2 | −2.53 |
| 36907_at | MVK | 12q24 | −2.53 |
| 220701_at | — | 14 | −2.53 |
| 242876_at | — | 01 | −2.54 |
| 238075_at | — | 11 | −2.54 |
| 230376_at | GTF2A2 | 15q22.2 | −2.54 |
| 219648_at | DSU | 2q35 | −2.54 |
| 213002_at | MARCKS | 6q22.2 | −2.54 |
| 212314_at | KIAA0746 | 4p15.2 | −2.55 |
| 202749_at | WRB | 21q22.3 | −2.55 |
| 229933_at | C1orf74 | 1q32.2 | −2.55 |
| 213106_at | ATP8A1 | 4p14-p12 | −2.55 |
| 222732_at | TRIM39 | 6p21.3 | −2.56 |
| 222235_s_at | GALNACT-2 | 10q11.21 | −2.56 |
| 1553535_a_at | RANGAP1 | 22q13 | −2.57 |
| 1553239_at | FLJ30707 | 13q14.3 | −2.57 |
| 218297_at | C10orf97 | 10p13 | −2.57 |
| 218043_s_at | AZI2 | 3p24.1 | −2.57 |
| 224377_s_at | RAB18 | 10p12.1 | −2.57 |
| 203883_s_at | RAB11FIP2 | 10q26.11 | −2.58 |
| 1561571_at | LOC389183 | 3q27.3 | −2.58 |
| 220865_s_at | TPRT | 10p12.1 | −2.58 |
| 1563772_a_at | LAMA3 | 18q11.2 | −2.58 |
| 224404_s_at | FCRL5 | 1q21 | −2.59 |
| 203158_s_at | GLS | 2q32-q34 | −2.59 |
| 226272_at | — | 01 | −2.59 |
| 241429_at | — | 10 | −2.59 |
| 206218_at | MAGEB2 | Xp21.3 | −2.61 |
| 1557986_s_at | ATP6V0C /// SHMT1 | 16p13.3 /// 17p11.2 | −2.61 |
| 241844_x_at | FLJ23235 | 4p14 | −2.61 |
| 202317_s_at | UBE4B | 1p36.3 | −2.61 |
| 232922_s_at | C20orf59 | 20q13.33 | −2.62 |
| 223945_x_at | LOC441212 | 7p14.3 | −2.62 |
| 234464_s_at | EME1 | 17q21.33 | −2.62 |
| 232422_at | LOC87769 | 13q32.3 | −2.62 |
| 234634_at | EXT1 | 8q24.11-q24.13 | −2.63 |
| 238029_s_at | SLC16A14 | 2q36.3 | −2.63 |
| 228139_at | RIPK3 | 14q11.2 | −2.63 |
| 221419_s_at | — | 16 | −2.63 |
| 230651_at | THOC2 | Xq25-q26.3 | −2.64 |
| 207265_s_at | KDELR3 | 22q13.1 | −2.64 |
| 220949_s_at | MGC5242 | 7q33 | −2.64 |
| 235749_at | UGCGL2 | 13q32.1 | −2.64 |
| 206632_s_at | APOBEC3B | 22q13.1-q13.2 | −2.65 |
| 32811_at | MYO1C | 17p13 | −2.65 |
| 1554757_a_at | INPP5A | 10q26.3 | −2.65 |
| 218967_s_at | PTER | 10p12 | −2.66 |
| 211089_s_at | NEK3 | 13q14.13 | −2.66 |
| 202075_s_at | PLTP | 20q12-q13.1 | −2.66 |
| 200709_at | FKBP1A | 20p13 | −2.66 |
| 1556345_s_at | MCCC2 | 5q12-q13 | −2.66 |
| 229466_at | LOC256273 | 11p15.3 | −2.67 |
| 224806_at | TRIM25 | 17q23.2 | −2.67 |
| 201739_at | SGK | 6q23 | −2.68 |
| 210001_s_at | SOCS1 | 16p13.13 | −2.69 |
| 215376_at | — | 08 | −2.70 |
| 202894_at | EPHB4 | 7q22 | −2.70 |
| 202120_x_at | AP2S1 | 19q13.2-q13.3 | −2.70 |
| 235055_x_at | MUC4 | 3q29 | −2.71 |
| 218322_s_at | ACSL5 | 10q25.1-q25.2 | −2.71 |
| 1560386_at | XPO1 | 2p16 | −2.72 |
| 38964_r_at | WAS | Xp11.4-p11.21 | −2.72 |
| 37425_g_at | CCHCR1 | 6p21.3 | −2.72 |
| 217975_at | WBP5 | Xq22.2 | −2.72 |
| 219731_at | FLJ34077 | 10q23-q24 | −2.72 |
| 1555820_a_at | FLJ20345 | 17q23.2 | −2.73 |
| 243830_at | — | 03 | −2.73 |
| 208732_at | RAB2 | 8q12.1 | −2.74 |
| 206066_s_at | RAD51C | 17q22-q23 | −2.74 |
| 1553048_a_at | PIP5K2B | 17q12 | −2.75 |
| 1557966_x_at | MTERFD2 | 2q37.3 | −2.75 |
| 227090_at | PHF21A | 11p11.2 | −2.75 |
| 1558166_at | MGC16275 | 17q25.2 | −2.75 |
| 217104_at | LOC400410 | 15q25.1 | −2.75 |
| 219870_at | ATF7IP2 | 16p13.13 | −2.75 |
| 125207_x_at | YDD19 /// C6orf68 /// LOC389850 | 13q12 /// 6q22.1 /// Xp11.3 | −2.76 |
| | /// LOC440128 | /// 13q12.12 | |
| 215764_x_at | AP2A2 | 11p15.5 | −2.76 |
| 234609_at | PRKCE | 2p21 | −2.76 |
| 214869_x_at | GAPVD1 | 9q33.3 | −2.77 |
| 1570360_s_at | DDX3Y | Yq11 | −2.77 |
| 206263_at | FMO4 | 1q23-q25 | −2.77 |
| 1555916_at | RPUSD3 | 3p25.3 | −2.77 |
| 241669_x_at | PRKD2 | 19q13.3 | −2.78 |
| 38069_at | CLCN7 | 16p13 | −2.79 |
| 203851_at | IGFBP6 | 12q13 | −2.80 |
| 235366_at | ZNF10 | 12q24.33 | −2.80 |
| 202881_x_at | — | 06 | −2.80 |
| 225585_at | RAP2A | 13q34 | −2.81 |
| 1552863_a_at | CACNG6 | 19q13.4 | −2.81 |
| 230769_at | FLJ37099 | 1p13.2-p13.1 | −2.81 |
| 204906_at | RPS6KA2 | 6q27 | −2.82 |
| 201360_at | CST3 | 20p11.21 | −2.82 |
| 221498_at | SNX27 | 1q21.3 | −2.83 |
| 1555860_x_at | — | 03 | −2.84 |
| 238004_at | PGBD2 | 1q44 | −2.84 |
| 235882_at | — | 17 | −2.84 |
| 226664_at | TBC1D20 | 20p13 | −2.85 |
| 1568713_a_at | TBC1D1 | 4p14 | −2.85 |
| 230448_at | MGC15523 | 17q25.3 | −2.85 |
| 218662_s_at | HCAP-G | 4p15.33 | −2.86 |
| 243522_at | SPPL3 | 12q24.31 | −2.86 |
| 230042_at | — | 21 | −2.86 |
| 206686_at | PDK1 | 2q31.1 | −2.87 |
| 226571_s_at | PTPRS | 19p13.3 | −2.87 |
| 1568887_at | — | 01 | −2.88 |
| 239349_at | C1QTNF7 | 4p16-p15 | −2.88 |
| 225656_at | EFHC1 | 6p12.3 | −2.89 |
| 225172_at | CRAMP1L | 16p13.3 | −2.89 |
| 203278_s_at | PHF21A | 11p11.2 | −2.89 |
| 214706_at | ZNF200 | 16p13.3 | −2.90 |
| 213587_s_at | ATP6V0E2L | 7q36.1 | −2.90 |
| 209474_s_at | ENTPD1 | 10q24 | −2.92 |
| 225754_at | AP1G1 | 16q23 | −2.93 |
| 1560290_at | — | 16 | −2.94 |
| 240062_at | FAM3C | 7q22.1-q31.1 | −2.94 |
| 1553112_s_at | CDK8 | 13q12 | −2.94 |
| 1563646_a_at | MGC26979 | 8q22.1 | −2.94 |
| 233361_at | ANKRD44 | 2q33.1 | −2.95 |
| 215946_x_at | LOC91353 | 22q11.23 | −2.95 |
| 219570_at | C20orf23 | 20p11.23 | −2.95 |
| 221590_s_at | ALDH6A1 | 14q24.3 | −2.96 |
| 202641_at | ARL3 | 10q23.3 | −2.96 |
| 210731_s_at | LGALS8 | 1q42-q43 | −2.96 |
| 217597_x_at | RAB40B | 17q25.3 | −2.97 |
| 204079_at | TPST2 | 22q12.1 | −2.97 |
| 209766_at | PRDX3 | 10q25-q26 | −2.97 |
| 243986_at | LOC144766 | 13q21.31 | −2.98 |
| 1557586_s_at | ATP6V1H | 8p22-q22.3 | −2.98 |
| 121_at | PAX8 | 2q12-q14 | −2.99 |
| 205197_s_at | ATP7A | Xq13.2-q13.3 | −2.99 |
| 216253_s_at | PARVB | 22q13.2-q13.33 | −2.99 |
| 232366_at | KIAA0232 | 4p16.1 | −2.99 |
| 235299_at | — | 12 | −2.99 |
| 202292_x_at | LYPLA2 /// LYPLA2P1 /// | 1p36.12-p35.1 /// 6p21.32 | −3.00 |
| | LOC388499 | /// 19p13.2 | |
| 238846_at | TNFRSF11A | 18q22.1 | −3.00 |
| 231002_s_at | NUP88 | 17p13.2 | −3.01 |
| 203418_at | CCNA2 | 4q25-q31 | −3.01 |
| 1554518_at | FLJ13273 | 4q24 | −3.02 |
| 229351_at | C6orf49 | 6p21.31 | −3.02 |
| 233168_s_at | SELO | 22q13.33 | −3.03 |
| 229821_at | NBR2 | 17q21 | −3.04 |
| 213264_at | PCBP2 | 12q13.12-q13.13 | −3.04 |
| 229637_at | hSyn | 12q23.3 | −3.04 |
| 227885_at | PRO1768 | 14q32.11 | −3.05 |
| 1553088_a_at | BCL2L11 | 2q13 | −3.06 |
| 244357_at | LOC64744 | 1p35.3-p34.1 | −3.06 |
| 233055_at | — | 02 | −3.06 |
| 1568408_x_at | — | 14 | −3.07 |
| 207543_s_at | P4HA1 | 10q21.3-q23.1 | −3.07 |
| 1554582_a_at | MGC50559 | 12p11.21 | −3.07 |
| 239267_at | — | 09 | −3.07 |
| 1560826_at | — | 08 | −3.07 |
| 221951_at | LOC283232 | 11p15.5 | −3.09 |
| 208591_s_at | PDE3B | 11p15.1 | −3.09 |
| 31861_at | IGHMBP2 | 11q13.3 | −3.09 |
| 211433_x_at | KIAA1539 | 9p13.3 | −3.10 |
| 214462_at | SOCS6 | 18q22.2 | −3.10 |
| 238025_at | MLKL | 16q22.3 | −3.11 |
| 1554769_at | FLJ32130 | 16p11.2 | −3.11 |
| 214119_s_at | FKBP1A | 20p13 | −3.12 |
| 225226_at | FAM40A | 1p13.3 | −3.12 |
| 43934_at | C11ORF4 | 11cen-q22.3 | −3.12 |
| 209416_s_at | FZR1 | 19p13.3 | −3.12 |
| 217706_at | LOC220074 | 11q13.4 | −3.12 |
| 229835_s_at | C20orf45 | 20q13.32 | −3.13 |
| 239725_at | PGAP1 | 2q33.1 | −3.14 |
| 202403_s_at | COL1A2 | 7q22.1 | −3.14 |
| 210186_s_at | FKBP1A | 20p13 | −3.14 |
| 237187_at | — | 12 | −3.14 |
| 240979_at | — | 17 | −3.15 |
| 1560981_a_at | PPARA | 22q12-q13.1\|22q13.31 | −3.17 |
| 217994_x_at | CPSF3L | 1p36.33 | −3.17 |
| 223798_at | SLC41A2 | 12q23.3 | −3.18 |
| 219330_at | VANGL1 | 1p11-p13.1 | −3.18 |
| 1570249_x_at | GNB1 | 1p36.33 | −3.20 |
| 1557158_s_at | MLL3 | 7q34-q36 | −3.21 |
| 234575_at | ZNF71 | 19q13.4 | −3.22 |
| 1562259_at | TEX9 | 15q21.3 | −3.22 |
| 219032_x_at | OPN3 | 1q43 | −3.23 |
| 58994_at | CC2D1A | 19p13.12 | −3.23 |
| 209467_s_at | MKNK1 | 1p33 | −3.24 |
| 239314_at | LOC387921 | 13q13.3 | −3.24 |
| 218554_s_at | ASH1L | 1q22 | −3.25 |
| 219801_at | ZNF34 | 8q24.3 | −3.25 |
| 1557890_at | — | 06 | −3.25 |
| 228990_at | C1orf79 | 1p35.3 | −3.26 |
| 57540_at | RBKS | 2p23.3 | −3.26 |
| 33323_r_at | SFN | 1p36.11 | −3.28 |
| 201029_s_at | CD99 | Xp22.32; Yp11.3 | −3.29 |
| 212872_s_at | TRFP | 6p21.1 | −3.30 |
| 221569_at | AHI1 | 6q23.3 | −3.31 |
| 1554471_a_at | ANKRD13C | 1p32.3-p31.3 | −3.32 |
| 218273_s_at | PPM2C | 8q22.1 | −3.33 |
| 230108_at | ERCC6 | 10q11.23 | −3.33 |
| 221542_s_at | SPFH2 | 8p11.2 | −3.34 |
| 206576_s_at | CEACAM1 | 19q13.2 | −3.38 |
| 219472_at | MGC11266 | 2p23.3 | −3.38 |
| 211152_s_at | PRSS25 | 2p12 | −3.38 |
| 222252_x_at | UBQLN4 /// UBQLN4P | 1q21 /// 3q24 | −3.39 |
| 226457_at | — | 01 | −3.39 |
| 220564_at | C10orf59 | 10q23.31 | −3.40 |
| 201028_s_at | CD99 | Xp22.32; Yp11.3 | −3.40 |
| 217128_s_at | CAMK1G | 1q32-q41 | −3.42 |
| 1569629_x_at | LOC389906 | Xp22.33 | −3.43 |
| 240423_at | — | 7p15.2 | −3.46 |
| 1553905_at | CXorf22 | Xp21.1 | −3.46 |
| 218068_s_at | ZNF672 | 1q44 | −3.47 |
| 228034_x_at | FLJ20308 | 17p11.2 | −3.48 |
| 227986_at | ZNF343 | 20p13 | −3.48 |
| 210779_x_at | SIP1 | 14q13 | −3.48 |
| 235089_at | FBXL20 | 17q12 | −3.48 |
| 242159_at | — | 12 | −3.48 |
| 230333_at | SAT | Xp22.1 | −3.50 |
| 37965_at | PARVB | 22q13.2-q13.33 | −3.55 |
| 242041_at | CSPP | 8q13.2 | −3.57 |
| 1555288_s_at | FBF1 | 17q25.1 | −3.57 |
| 243440_at | — | 02 | −3.58 |
| 241380_at | FLJ41603 | 5q32 | −3.59 |
| 241906_at | ZNF15L1 | 7q | −3.61 |
| 200659_s_at | PHB | 17q21 | −3.63 |
| 221999_at | VRK3 | 19q13 | −3.65 |
| 207425_s_at | 9-Sep | 17q25 | −3.66 |
| 209280_at | MRC2 | 17q23.3 | −3.67 |
| 1553002_at | DEFB105A | 08 | −3.70 |
| 227683_x_at | NUDT4 | 01 | −3.71 |
| 221681_s_at | DSPP | 4q21.3 | −3.75 |
| 215481_s_at | PEX5 | 12p13.3 | −3.75 |
| 242956_at | IDH1 | 2q33.3 | −3.76 |
| 216491_x_at | IGHM | 14q32.33 | −3.78 |
| 224097_s_at | F11R | 1q21.2-q21.3 | −3.81 |
| 206150_at | TNFRSF7 | 12p13 | −3.82 |
| 217111_at | AMACR | 5p13.2-q11.1 | −3.83 |
| 225105_at | LOC387882 | 12q23.3 | −3.84 |
| 211918_x_at | PAPPA2 | 1q23-q25 | −3.85 |
| 221080_s_at | FAM31C | 19p13.3 | −3.86 |
| 223107_s_at | PS1D | 1p35.2 | −3.86 |
| 227337_at | ANKRD37 | 4q35.1 | −3.91 |
| 201801_s_at | SLC29A1 | 6p21.1-p21.2 | −3.92 |
| 1559691_at | NDUFS1 | 2q33-q34 | −3.94 |
| 209710_at | GATA2 | 3q21.3 | −3.95 |
| 1561391_at | STAU2 | 8q13-q21.1 | −3.95 |
| 234231_at | LOC197350 | 16p13.3 | −3.96 |
| 1557944_s_at | CTNND1 | 11q11 | −3.97 |
| 203307_at | GNL1 | 6p21.3 | −3.97 |
| 229191_at | TBCD | 17q25.3 | −4.00 |
| 209626_s_at | OSBPL3 | 7p15 | −4.02 |
| 220066_at | CARD15 | 16q21 | −4.02 |
| 217462_at | C11orf9 | 11q12-q13.1 | −4.07 |
| 203003_at | MEF2D | 1q12-q23 | −4.07 |
| 229250_at | TPCN2 | 11q13.3 | −4.08 |
| 201849_at | BNIP3 | 10q26.3 | −4.10 |
| 222951_s_at | ANKRD5 | 20pter-q11.23 | −4.11 |
| 207300_s_at | F7 | 13q34 | −4.11 |
| 227046_at | SLC39A11 | 17q24.3-q25.1 | −4.18 |
| 220036_s_at | LMBR1L | 12q13.12 | −4.21 |
| 202563_at | C14orf1 | 14q24.3 | −4.30 |
| 203093_s_at | TIMM44 | 19p13.3-p13.2 | −4.35 |
| 215410_at | PMS2L1 /// PMS2L2 /// PMS2L5 | 7q22.1 /// 7q11-q22 /// | −4.36 |
| | /// PMS2L11 /// LOC442593 | 7q11.23 | |
| 229906_at | ARMC7 | 17q25.1 | −4.41 |
| 213249_at | FBXL7 | 5p15.1 | −4.50 |
| 233891_at | — | | −4.52 |
| 219125_s_at | LOC55974 | 1q22 | −4.64 |
| 1553793_a_at | KIAA1109 | 4q27 | −4.65 |
| 1570454_at | EIF4EBP2 | 10q21-q22 | −4.70 |
| 215949_x_at | IGHM | 14q32.33 | −4.71 |
| 202837_at | TRAFD1 | 12q | −4.75 |
| 211159_s_at | PPP2R5D | 6p21.1 | −4.83 |
| 230491_at | — | 12 | −4.94 |
| 216846_at | IGLJ3 | 22q11.1-q11.2 | −5.35 |
| 234381_at | IGLC2 | 22q11.2 | −5.94 |

Note:
+ Score means higher expression in monoclonal gammopathy of undetermined significance than in normal plasma cell.

TABLE 3
Genes significantly expressed between monoclonal gammopathy of
undetermined significance and multiple myeloma.

| | | | SAM |
|---|---|---|---|
| Probe Set | Symbol | Map Location | Score |
| 1565951_s_at | CHML | 1q42-qter | 4.86 |
| 235117_at | LOC494143 | 2p16 | 4.50 |
| 208910_s_at | C1QBP | 17p13.3 | 4.45 |
| 214773_x_at | TIPRL | 1q23.2 | 4.32 |
| 204071_s_at | TOPORS | 9p21 | 4.28 |
| 203198_at | CDK9 | 9q34.1 | 4.26 |
| 209424_s_at | AMACR | 5p13.2-q11.1 | 4.22 |
| 1557765_at | LOC340109 | 5p14.1 | 4.14 |
| 201486_at | RCN2 | 15q23 | 4.13 |
| 203886_s_at | FBLN2 | 3p25.1 | 4.11 |
| 226760_at | LOC203411 | Xp22.13 | 4.10 |
| 221727_at | PC4 | 5p13.3 /// 8p23.1 | 4.06 |
| 202475_at | NIFIE14 | 19q13.1 | 4.00 |
| 219029_at | FLJ21657 | 5p12 | 3.99 |
| 1555225_at | C1orf43 | 1q21.2 | 3.99 |
| 1555226_s_at | C1orf43 | 1q21.2 | 3.97 |
| 214484_s_at | OPRS1 | 9p13.3 | 3.96 |
| 1560316_s_at | GLCCI1 | 7p21.3 | 3.94 |
| 201873_s_at | ABCE1 | 4q31 | 3.86 |
| 201461_s_at | MAPKAPK2 | 1q32 | 3.85 |
| 228620_at | PRKRA | 2q31.2 | 3.80 |
| 212846_at | KIAA0179 | 21q22.3 | 3.80 |
| 225260_s_at | MRPL32 | 7p14 | 3.77 |
| 215050_x_at | MAPKAPK2 | 1q32 | 3.74 |
| 207396_s_at | ALG3 | 3q27.1 | 3.73 |
| 217398_x_at | GAPDH | 12p13 | 3.73 |
| 223223_at | ARV1 | 1q42.2 | 3.73 |
| 234672_s_at | TMEM48 | 1p32.3 | 3.70 |
| 210480_s_at | MYO6 | 6q13 | 3.70 |
| 223046_at | EGLN1 | 1q42.1 | 3.70 |
| 235103_at | MAN2A1 | 5q21-q22 | 3.69 |
| 223804_s_at | THUMPD3 | 3p25.3 | 3.69 |
| 219481_at | TTC13 | 1q42.2 | 3.68 |
| 225805_at | HNRPU | 1q44 | 3.66 |
| 230795_at | HIST1H4D | 6p21.3 | 3.66 |
| 227109_at | CYP2R1 | 11p15.2 | 3.66 |
| 226784_at | TWISTNB | 7p21.1 | 3.66 |
| 224713_at | MKI67IP | 2q14.3 | 3.63 |
| 229804_x_at | CBWD1 | 9p24.3 /// 2q14.1 /// 9q13 | 3.62 |
| 232392_at | SFRS3 | 6p21 | 3.61 |
| 224654_at | DDX21 | 10q21 /// 8p23.3 | 3.61 |
| 208490_x_at | HIST1H2BF | 6p21.3 | 3.60 |
| 222673_x_at | TMEM57 | 1p36.11 /// Xq26.3 | 3.60 |
| 235384_at | NUDT19 | 19q13.11 | 3.60 |
| 224436_s_at | NIPSNAP3A | 9q31.1 | 3.59 |
| 213188_s_at | MINA | 3q11.2 | 3.59 |
| 228324_at | C9orf41 | 9q21.13 | 3.59 |
| 212789_at | hCAP-D3 | 11q25 | 3.57 |
| 229785_at | KRIT1 | 7q21-q22 | 3.55 |
| 217777_s_at | HSPC121 | 15q22.2 | 3.54 |
| 202069_s_at | IDH3A | 15q25.1-q25.2 | 3.54 |
| 224714_at | MKI67IP | 2q14.3 | 3.53 |
| 226752_at | UNQ1912 | 5q21.1 | 3.53 |
| 1569454_a_at | LOC283352 | 12q24.33 | 3.52 |
| 203235_at | THOP1 | 19q13.3 | 3.49 |
| 233952_s_at | ZNF295 | 21q22.3 | 3.48 |
| 225699_at | LOC285958 | 7p13 | 3.47 |
| 225734_at | FBXO22 | 15q23 | 3.44 |
| 1558254_s_at | SRPK2 | 7q22-q31.1 | 3.44 |
| 212417_at | SCAMP1 | 5q13.3-q14.1 | 3.44 |
| 244631_at | LOC389834 | chr2 | 3.44 |
| 218837_s_at | UBE2D4 | 7p13 | 3.43 |
| 225223_at | SMAD5 | 5q31 | 3.43 |
| 212907_at | SLC30A1 | 1q32-q41 | 3.42 |
| 1558755_x_at | ZNF440L | 19p13.2 | 3.42 |
| 225317_at | ACBD6 | 1q25.2-q25.3 | 3.42 |
| 212536_at | ATP11B | 3q27 | 3.41 |
| 223649_s_at | CGI-69 | 17q12 | 3.39 |
| 229846_s_at | MAPKAP1 | 9q33.3 | 3.39 |
| 222204_s_at | RRN3 | 16p12 | 3.38 |
| 235039_x_at | LIN9 | 1q42.12 | 3.38 |
| 227211_at | PHF19 | 9q33.2 | 3.38 |
| 218052_s_at | ATP13A1 | 19p13.11 | 3.36 |
| 230766_at | — | chr21 | 3.36 |
| 204928_s_at | SLC10A3 | Xq28 | 3.36 |
| 200730_s_at | PTP4A1 | 6q12 | 3.36 |
| 203622_s_at | LOC56902 | 2p14 | 3.35 |
| 222280_at | GAPDS | 19q13.1 | 3.35 |
| 202422_s_at | ACSL4 | Xq22.3-q23 | 3.35 |
| 201177_s_at | UBA2 | 19q12 | 3.35 |
| 203216_s_at | MYO6 | 6q13 | 3.35 |
| 218009_s_at | PRC1 | 15q26.1 | 3.34 |
| 1564651_at | LOC221710 | 6p24.1 | 3.34 |
| 201326_at | CCT6A | 7p11.2 | 3.33 |
| 212574_x_at | C19orf6 | 19p13.3 | 3.33 |
| 204900_x_at | SAP30 | 4q34.1 | 3.32 |
| 238761_at | MED28 | 4p16 | 3.32 |
| 218270_at | MRPL24 | 1q21-q22 | 3.31 |
| 222794_x_at | PAPD1 | 10p11.23 | 3.31 |
| 203480_s_at | HSHIN1 | 4q31.21 | 3.31 |
| 221156_x_at | CCPG1 | 15q21.1 | 3.30 |
| 200910_at | CCT3 | 1q23 | 3.30 |
| 1555790_a_at | ZFPL | 19q13.41 /// 4q32.3 | 3.29 |
| 228366_at | PPA2 | 4q25 | 3.29 |
| 202904_s_at | LSM5 | 7p14.3 | 3.29 |
| 230560_at | STXBP6 | 14q12 | 3.27 |
| 244103_at | C1orf55 | 1q42.12 | 3.26 |
| 231530_s_at | C11orf1 | 11q13-q22 | 3.26 |
| 208965_s_at | IFI16 | 1q22 | 3.25 |
| 201824_at | RNF14 | 5q23.3-q31.1 | 3.25 |
| 201458_s_at | BUB3 | 10q26 | 3.25 |
| 222147_s_at | ACTR5 | 20q11.23 | 3.25 |
| 1555730_a_at | CFL1 | 11q13 | 3.25 |
| 226558_at | ANKRD20B | 2q11.1 | 3.24 |
| 201485_s_at | RCN2 | 15q23 | 3.24 |
| 211747_s_at | LSM5 | 7p14.3 | 3.24 |
| 227246_at | — | chr4 | 3.23 |
| 204602_at | DKK1 | 10q11.2 | 3.23 |
| 235109_at | ZBED3 | 5q13.3 | 3.22 |
| 221207_s_at | NBEA | 13q13 | 3.22 |
| 223073_at | HIATL1 | 9q22.32 | 3.22 |
| 203360_s_at | MYCBP | 1p33-p32.2 | 3.21 |
| 207508_at | ATP5G3 | 2q31.1 | 3.21 |
| 225625_at | MGC90512 | 12q24.11 | 3.21 |
| 228822_s_at | USP16 | 21q22.11 | 3.21 |
| 227124_at | — | chr6 | 3.18 |
| 200692_s_at | HSPA9B | 5q31.1 | 3.18 |
| 203203_s_at | HRB2 | 12q21.1 | 3.18 |
| 201456_s_at | BUB3 | 10q26 | 3.18 |
| 201595_s_at | LEREPO4 | 2q32.1 | 3.17 |
| 212038_s_at | VDAC1 | 5q31 | 3.17 |
| 209147_s_at | PPAP2A | 5q11 | 3.17 |
| 208308_s_at | GPI | 19q13.1 | 3.17 |
| 218027_at | MRPL15 | 8q11.2-q13 | 3.17 |
| 201013_s_at | PAICS | 4pter-q21 | 3.17 |
| 224619_at | CASC4 | 15q15.3 | 3.16 |
| 218073_s_at | TMEM48 | 1p32.3 | 3.16 |
| 202541_at | SCYE1 | 4q24 | 3.16 |
| 225580_at | MRPL50 | 9q31.1 | 3.15 |
| 211070_x_at | DB1 | 2q12-q21 | 3.15 |
| 213355_at | ST3GAL6 | 3q12.1 | 3.15 |
| 235032_at | DNAJA5 | 5p13.2 | 3.14 |
| 207564_x_at | OGT | Xq13 | 3.14 |
| 202708_s_at | HIST2H2BE | 1q21-q23 | 3.14 |
| 215071_s_at | HIST1H2AC | 6p21.3 | 3.13 |
| 203560_at | GGH | 8q12.3 | 3.12 |
| 214290_s_at | HIST2H2AA | 1q21.2 | 3.11 |
| 226193_x_at | CBWD1 | 9p24.3 | 3.11 |
| 225361_x_at | LOC159090 | Xq26.3 | 3.11 |
| 227288_at | — | 5q12.3 | 3.10 |
| 200737_at | PGK1 | Xq13 | 3.10 |
| 219366_at | AVEN | 15q13.1 | 3.10 |
| 221669_s_at | ACAD8 | 11q25 | 3.10 |
| 209398_at | HIST1H1C | 6p21.3 | 3.09 |
| 239609_s_at | LOC254531 | 15q14 | 3.09 |
| 200968_s_at | PPIB | 15q21-q22 | 3.08 |
| 230298_at | LOC153364 | 5q14.3 | 3.08 |
| 221677_s_at | DONSON | 21q22.1 | 3.08 |
| 221652_s_at | C12orf11 | 12p11.23 | 3.06 |
| 214931_s_at | SRPK2 | 7q22-q31.1 | 3.06 |
| 209100_at | IFRD2 | 3p21.3 | 3.06 |
| 226493_at | KCTD18 | 2q33.1 | 3.06 |
| 201890_at | RRM2 | 2p25-p24 | 3.06 |
| 210802_s_at | HSA9761 | 5q11-q14 | 3.05 |
| 203362_s_at | MAD2L1 | 4q27 | 3.05 |
| 227669_at | DKFZPS64B167 | 1q24 | 3.05 |
| 1553698_a_at | C1orf96 | 1q42.13 | 3.04 |
| 202169_s_at | AASDHPPT | 11q22 | 3.04 |
| 213427_at | RPP40 | 6p25.1 | 3.04 |
| 225028_at | LOC550643 | Xq11.1 | 3.03 |
| 214214_s_at | C1QBP | 17p13.3 | 3.03 |
| 1554455_at | LINS1 | 15q26.3 | 3.03 |
| 218527_at | APTX | 9p13.3 | 3.03 |
| 221020_s_at | MFTC | 8q22.3 | 3.03 |
| 212133_at | NIPA2 | 15q11.2 | 3.02 |
| 204176_at | KLHL20 | 1q24.1-q24.3 | 3.02 |
| 235274_at | — | chr15 | 3.02 |
| 203044_at | CHSY1 | 15q26.3 | 3.02 |
| 208523_x_at | HIST1H2BI | 6p21.3 | 3.02 |
| 203182_s_at | SRPK2 | 7q22-q31.1 | 3.01 |
| 212416_at | SCAMP1 | 5q13.3-q14.1 | 3.01 |
| 225633_at | DPY19L3 | 19q13.11 | 3.01 |
| 228190_at | — | chr1 | 3.01 |
| 204905_s_at | EEF1E1 | 6p24.3-p25.1 | 3.01 |
| 229299_at | FLJ30596 | 5p13.2 | 3.01 |
| 208669_s_at | CRI1 | 15q21.1-q21.2 | 3.01 |
| 64900_at | CHST5 | 16q22.3 /// 3p21.2 | 3.00 |
| 1560982_at | — | chr16 | 3.00 |
| 201577_at | NME1 | 17q21.3 | 2.99 |
| 206562_s_at | CSNK1A1 | 5q32 | 2.98 |
| 231130_at | FKBP7 | 2q31.2 | 2.98 |
| 211934_x_at | GANAB | 11q12.3 | 2.97 |
| 219675_s_at | UXS1 | 2q12.2 | 2.97 |
| 218668_s_at | RAP2C | Xq25 | 2.97 |
| 228561_at | CDC37L1 | chr9 | 2.97 |
| 242214_at | RPS27A | 2p16 /// 1q31.2 /// 6q21 | 2.97 |
| 235532_at | — | chr1 | 2.96 |
| 215030_at | GRSF1 | 4q13 | 2.96 |
| 203427_at | ASF1A | 6q22.31 | 2.95 |
| 218280_x_at | HIST2H2AA | 1q21.2 | 2.95 |
| 218962_s_at | FLJ13576 | 7q31.32 | 2.95 |
| 224824_at | FAM36A | 1q44 | 2.95 |
| 235168_at | — | chr1 | 2.94 |
| 225737_s_at | FBXO22 | 15q23 | 2.94 |
| 227418_at | KIAA1826 | 11q22 | 2.94 |
| 217356_s_at | PGK1 | Xq13 | 2.92 |
| 1558692_at | MGC31963 | 1q22 | 2.92 |
| 201479_at | DKC1 | Xq28 | 2.92 |
| 220980_s_at | ADPGK | 15q24.1 | 2.91 |
| 208864_s_at | TXN | 9q31 | 2.91 |
| 219200_at | MGC5297 | 5p15.3-p15.2 | 2.90 |
| 218988_at | SLC35E3 | 12q15 | 2.89 |
| 223686_at | TPK1 | 7q34-q35 | 2.89 |
| 241734_at | SRFBP1 | 5q23.1 | 2.89 |
| 218590_at | PEO1 | 10q23.3-24.3 | 2.88 |
| 202024_at | ASNA1 | 19q13.3 | 2.88 |
| 212297_at | ATP13A3 | 3q29 | 2.88 |
| 222825_at | CGI-77 | 8q21.3 | 2.88 |
| 209267_s_at | SLC39A8 | 4q22-q24 | 2.88 |
| 213453_x_at | GAPDH | 12p13 | 2.88 |
| 220346_at | MTHFD2L | 4q13.3 | 2.87 |
| 224723_x_at | LOC401397 | 7q31.1 | 2.87 |
| 1558801_at | — | | 2.87 |
| 204444_at | KIF11 | 10q24.1 | 2.87 |
| 1556151_at | CDA08 | 16q12.1 | 2.86 |
| 218386_x_at | USP16 | 21q22.11 | 2.86 |
| 224883_at | PLDN | 15q21.1 | 2.85 |
| 220954_s_at | PILRB | 7q22.1 | 2.85 |
| 217790_s_at | SSR3 | 3q25.31 | 2.85 |
| 222154_s_at | DNAPTP6 | 2q33.1 | 2.85 |
| 201317_s_at | PSMA2 | 7p14.1 | 2.84 |
| 210370_s_at | LY9 | 1q21.3-q22 | 2.83 |
| 217898_at | C15orf24 | 15q14 | 2.83 |
| 219628_at | WIG1 | 3q26.3-q27 | 2.83 |
| 229235_at | — | chr16 | 2.82 |
| 210275_s_at | ZA20D2 | 9q13-q21 | 2.81 |
| 229491_at | LOC133308 | 4q24 | 2.81 |
| 209161_at | PRPF4 | 9q31-q33 | 2.81 |
| 218512_at | WDR12 | 2q33.2 | 2.80 |
| 202430_s_at | PLSCR1 | 3q23 | 2.80 |
| 221568_s_at | LIN7C | 11p14 | 2.78 |
| 220850_at | MORC1 | 3q13 | 2.78 |
| 209773_s_at | RRM2 | 2p25-p24 | 2.77 |
| 201817_at | UBE3C | 7q36.3 | 2.77 |
| 235205_at | LOC346887 | 8q23.1 | 2.77 |
| 238762_at | MTHFD2L | 4q13.3 | 2.77 |
| 219003_s_at | MANEA | 6q16.1 | 2.77 |
| 213485_s_at | ABCC10 | 6p21.1 | 2.76 |
| 219177_at | BXDC2 | 5p13.2 | 2.76 |
| 231297_at | DOT1L | 19p13.3 | 2.76 |
| 242201_at | — | chr7 | 2.76 |
| 223264_at | MESDC1 | 15q13 | 2.76 |
| 224523_s_at | MGC4308 | 3q12.1 | 2.76 |
| 217933_s_at | LAP3 | 4p15.32 | 2.75 |
| 203452_at | B3GAT3 | 11q12.3 | 2.75 |
| 201115_at | POLD2 | 7p13 | 2.75 |
| 220175_s_at | CBWD1 | 9p24.3 /// 2q14.1 /// 9q13 /// | 2.74 |
| | | 9q21.13 | |
| 235907_at | TMEM33 | 4p13 | 2.74 |
| 213626_at | CBR4 | 4q32.3 | 2.74 |
| 224391_s_at | CSE-C | 11q24 | 2.74 |
| 219787_s_at | ECT2 | 3q26.1-q26.2 | 2.73 |
| 202070_s_at | IDH3A | 15q25.1-q25.2 | 2.73 |
| 235581_at | — | chr7 | 2.72 |
| 200994_at | IPO7 | 11p15.4 | 2.72 |
| 222428_s_at | LARS | 5q32 | 2.71 |
| 236193_at | HIST1H2BC | 6p21.3 | 2.70 |
| 222412_s_at | SSR3 | 3q25.31 | 2.70 |
| 235159_at | FLJ11000 | 7q33 | 2.70 |
| 202591_s_at | SSBP1 | 7q34 | 2.69 |
| 223470_at | PIGM | 1q23.2 | 2.68 |
| 218568_at | MULK | 7q34 | 2.68 |
| 204244_s_at | ASK | 7q21.3 | 2.67 |
| 208775_at | XPO1 | 2p16 | 2.67 |
| 205386_s_at | MDM2 | 12q14.3-q15 | 2.67 |
| 205361_s_at | PFDN4 | 20q13.2 | 2.65 |
| 225904_at | C1orf96 | 1q42.13 | 2.64 |
| 230005_at | DKFZp313A2432 | 11p14.2 | 2.64 |
| 209628_at | NXT2 | Xq23 | 2.64 |
| 225916_at | ZNF131 | 5p12-p11 | 2.63 |
| 202396_at | TCERG1 | 5q31 | 2.63 |
| 1554321_a_at | NFS1 | 20q11.22 | 2.63 |
| 224875_at | FLJ37562 | 5q31.1 | 2.63 |
| 208828_at | POLE3 | 9q33 | 2.63 |
| 212279_at | MAC30 | 17q11.2 | 2.63 |
| 224903_at | CIRH1A | 16q22.1 | 2.63 |
| 230177_at | — | chr5 | 2.62 |
| 229551_x_at | ZNF367 | 9q22 | 2.62 |
| 1556194_a_at | — | chr4 | 2.62 |
| 217856_at | RBM8A | 1q12 | 2.61 |
| 229082_at | KENAE | 5q13.2 | 2.60 |
| 223243_s_at | C1orf22 | 1q24-q25 | 2.59 |
| 209426_s_at | AMACR | 5p13.2-q11.1 | 2.59 |
| 223261_at | POLK | 5q13 | 2.58 |
| 228559_at | — | chr16 | 2.58 |
| 222163_s_at | SPATA5L1 | 15q21.1 | 2.58 |
| 201312_s_at | SH3BGRL | Xq13.3 | 2.58 |
| 201624_at | DARS | 2q21.3 | 2.58 |
| 208967_s_at | AK2 | 1p34 | 2.57 |
| 1555815_a_at | L3MBTL2 | 22q13.31-q13.33 | 2.56 |
| 214835_s_at | SUCLG2 | 3p14.1 | 2.56 |
| 223077_at | TMOD3 | 15q21.1-q21.2 | 2.55 |
| 1555948_s_at | C9orf10 | 9q22.31 | 2.55 |
| 201251_at | PKM2 | 15q22 | 2.54 |
| 223180_s_at | C18orf55 | 18q22.3 | 2.53 |
| 218397_at | FANCL | 2p16.1 | 2.53 |
| 215954_s_at | C19orf29 | 19p13.3 | 2.52 |
| 225385_s_at | HNRPLL | 2p22.1 | 2.52 |
| 214218_s_at | XIST | Xq13.2 | −2.50 |
| 219966_x_at | BANP | 16q24 | −2.52 |
| 213340_s_at | KIAA0495 | 1p36.32 | −2.52 |
| 225688_s_at | PHLDB2 | 3q13.2 | −2.52 |
| 202459_s_at | LPIN2 | 18p11.31 | −2.53 |
| 214679_x_at | GNA11 | 19p13.3 | −2.54 |
| 219049_at | ChGn | 8p21.3 | −2.55 |
| 239292_at | — | 3p24.1 | −2.55 |
| 204164_at | SIPA1 | 11q13 | −2.56 |
| 224693_at | C20orf108 | 20q13.31 | −2.56 |
| 1570243_at | — | | −2.56 |
| 209158_s_at | PSCD2 | 19q13.3 | −2.56 |
| 206150_at | TNFRSF7 | 12p13 | −2.56 |
| 224588_at | XIST | Xq13.2 | −2.57 |
| 227917_at | — | | −2.57 |
| 243738_at | NMNAT3 | 3q23 | −2.57 |
| 223769_x_at | HYI | 1p34.2 | −2.57 |
| 242104_at | — | 22q13.2 | −2.57 |
| 213183_s_at | CDKN1C | 11p15.5 | −2.59 |
| 241435_at | ETS1 | 11q23.3 | −2.59 |
| 228139_at | RIPK3 | 14q11.2 | −2.59 |
| 208472_at | ZNFN1A4 | 12q13 | −2.60 |
| 236494_x_at | — | chr1 | −2.61 |
| 241685_x_at | — | chr5 | −2.62 |
| 215785_s_at | CYFIP2 | 5q33.3 | −2.62 |
| 219593_at | SLC15A3 | 11q12.2 | −2.62 |
| 213940_s_at | FNBP1 | 9q34 | −2.62 |
| 219062_s_at | ZCCHC2 | 18q21.33 | −2.64 |
| 226497_s_at | FLT1 | 13q12 | −2.64 |
| 220758_s_at | ROBO4 | 11q24.2 | −2.64 |
| 239694_at | TRIM7 | 5q35.3 | −2.64 |
| 205277_at | PRDM2 | 1p36 | −2.65 |
| 220066_at | CARD15 | 16q21 | −2.66 |
| 210347_s_at | BCL11A | 2p16.1 | −2.67 |
| 208779_x_at | DDR1 | 6p21.3 | −2.68 |
| 232693_s_at | ZNF395 | 8p21.1 | −2.70 |
| 223681_s_at | INADL | 1p31.3 | −2.70 |
| 1558794_at | — | | −2.70 |
| 243795_s_at | — | chr2 | −2.71 |
| 232511_at | RANBP2L1 | 2q13 | −2.71 |
| 216894_x_at | CDKN1C | 11p15.5 | −2.72 |
| 212589_at | SCP2 | 1p32 | −2.72 |
| 214677_x_at | IGL | 22q11.1-q11.2 /// 22q11.2 | −2.72 |
| 1555888_at | EDD | 8q22 | −2.73 |
| 212230_at | PPAP2B | 1pter-p22.1 | −2.74 |
| 203823_at | RGS3 | 9q32 | −2.74 |
| 204912_at | IL10RA | 11q23 | −2.74 |
| 242451_x_at | INO80 | 15q15.1 | −2.74 |
| 209619_at | CD74 | 5q32 | −2.75 |
| 213944_x_at | GNA11 | 19p13.3 | −2.76 |
| 205898_at | CX3CR1 | 3p21\|3p21.3 | −2.76 |
| 221651_x_at | IGKC | 2p12 | −2.76 |
| 226459_at | PIK3AP1 | 10q24.1 | −2.76 |
| 203206_at | FAM53B | 10q26.13 | −2.76 |
| 206695_x_at | ZNF43 | 19p13.1-p12 | −2.77 |
| 241944_x_at | TNFRSF1A | 12p13.2 | −2.78 |
| 202897_at | PTPNS1 | 20p13 | −2.80 |
| 227331_at | LOC283337 | 12q13.13 | −2.81 |
| 239809_at | KLF7 | 2q32 | −2.81 |
| 231989_s_at | LOC23117 | 16p12.2 | −2.81 |
| 36742_at | TRIM15 | 6p21.3 | −2.81 |
| 220377_at | C14orf110 | 14q32.33 | −2.82 |
| 227396_at | — | chr11 | −2.83 |
| 1566780_at | — | X | −2.84 |
| 210749_x_at | DDR1 | 6p21.3 | −2.85 |
| 208456_s_at | RRAS2 | 11p15.2 | −2.85 |
| 205482_x_at | SNX15 | 11q12 | −2.86 |
| 202460_s_at | LPIN2 | 18p11.31 | −2.86 |
| 218032_at | SNN | 16p13 | −2.87 |
| 239283_at | TMED5 | 1pter-q31.3 | −2.89 |
| 235099_at | CKLFSF8 | 3p23 | −2.89 |
| 203313_s_at | TGIF | 18p11.3 | −2.89 |
| 1556839_s_at | SPTBN5 | 15q21 | −2.91 |
| 224795_x_at | IGKC | 2p12 | −2.91 |
| 201938_at | CDK2AP1 | 12q24.31 | −2.91 |
| 1007_s_at | DDR1 | 6p21.3 | −2.91 |
| 220989_s_at | AMN | 14q32.3 | −2.92 |
| 221671_x_at | IGKC | 2p12 | −2.92 |
| 228951_at | FLJ10815 | 16q21 | −2.92 |
| 205514_at | ZNF415 | 19q13.42 | −2.93 |
| 203708_at | PDE4B | 1p31 | −2.93 |
| 1565358_at | RARA | 17q21 | −2.94 |
| 204798_at | MYB | 6q22-q23 | −2.94 |
| 210162_s_at | NFATC1 | 18q23 | −2.95 |
| 215949_x_at | IGHM | 14q32.33 | −2.96 |
| 213350_at | RPS11 | 19q13.3 | −2.98 |
| 210715_s_at | SPINT2 | 19q13.1 | −2.98 |
| 213642_at | — | chr1 | −2.99 |
| 232072_at | ASAHL | 4q21.1 | −3.00 |
| 211230_s_at | PIK3CD | 1p36.2 | −3.00 |
| 212590_at | RRAS2 | 11p15.2 | −3.02 |
| 234753_x_at | — | chr18 | −3.02 |
| 49329_at | KLHL22 | 22q11.21 | −3.03 |
| 210356_x_at | MS4A1 | 11q12 | −3.04 |
| 208315_x_at | TRAF3 | 14q32.32 | −3.05 |
| 230253_at | SCUBE3 | 6p21.3 | −3.05 |
| 225051_at | EPB41 | 1p33-p32 | −3.06 |
| 1558075_at | LOC339047 | 16p12.3 | −3.06 |
| 217016_x_at | FLJ23172 | 3q26.31 | −3.06 |
| 204257_at | FADS3 | 11q12-q13.1 | −3.07 |
| 221969_at | PAX5 | 9p13 | −3.08 |
| 227778_at | KIAA1833 | 8q24.3 | −3.08 |
| 217418_x_at | MS4A1 | 11q12 | −3.09 |
| 223415_at | RPP25 | 15q24.1 | −3.09 |
| 214041_x_at | RPL37A | 2q35 | −3.09 |
| 34210_at | CD52 | 1p36 | −3.10 |
| 218546_at | C1orf115 | 1q41 | −3.11 |
| 219371_s_at | KLF2 | 19p13.13-p13.11 | −3.11 |
| 209808_x_at | ING1 | 13q34 | −3.12 |
| 224590_at | XIST | Xq13.2 | −3.13 |
| 221479_s_at | BNIP3L | 8p21 | −3.13 |
| 221558_s_at | LEF1 | 4q23-q25 | −3.16 |
| 211430_s_at | IGH | 14q32.33 | −3.17 |
| 239516_at | LYPLAL1 | 1q41 | −3.19 |
| 201811_x_at | SH3BP5 | 3p24.3 | −3.20 |
| 216563_at | ANKRD12 | 18p11.22 | −3.21 |
| 1554636_at | — | chr19 | −3.23 |
| 224562_at | WASF2 | 1p36.11-p34.3 | −3.23 |
| 235081_x_at | TRIM65 | 17q25.1 | −3.25 |
| 1555779_a_at | CD79A | 19q13.2 | −3.26 |
| 202724_s_at | FOXO1A | 13q14.1 | −3.27 |
| 215671_at | PDE4B | 1p31 | −3.30 |
| 202615_at | GNAQ | 9q21 | −3.31 |
| 242472_x_at | FNBP4 | 11p11.2 | −3.31 |
| 221011_s_at | LBH | 2p23.1 | −3.31 |
| 1569906_s_at | PHF20 | 20q11.22-q11.23 | −3.32 |
| 212226_s_at | PPAP2B | 1pter-p22.1 | −3.33 |
| 218502_s_at | TRPS1 | 8q24.12 | −3.34 |
| 1564310_a_at | PARP15 | 3q21.1 | −3.35 |
| 212288_at | FNBP1 | 9q34 | −3.37 |
| 222329_x_at | — | chr4 | −3.38 |
| 230807_at | MGC20983 | 19p13.2 | −3.39 |
| 204588_s_at | SLC7A7 | 14q11.2 | −3.42 |
| 223467_at | RASD1 | 17p11.2 | −3.44 |
| 211697_x_at | LOC56902 | 2p14 | −3.45 |
| 1560754_at | CKLFSF7 | 3p23 | −3.46 |
| 244654_at | MYO1G | 7p13-p11.2 | −3.46 |
| 220068_at | VPREB3 | 22q11.23\|22q11 | −3.49 |
| 228592_at | MS4A1 | 11q12 | −3.52 |
| 209795_at | CD69 | 12p13-p12 | −3.58 |
| 224493_x_at | C18orf45 | 18q11.2 | −3.63 |
| 217022_s_at | IGHA1 | 14q32.33 | −3.64 |
| 1553185_at | RASEF | 9q21.32 | −3.64 |
| 243895_x_at | — | chr18 | −3.66 |
| 209116_x_at | HBB | 11p15.5 | −3.68 |
| 221943_x_at | RPL38 | 17q23-q25 | −3.69 |
| 1553186_x_at | RASEF | 9q21.32 | −3.79 |
| 1553575_at | — | chr5 | −3.84 |
| 217232_x_at | HBB | 11p15.5 | −3.89 |
| 225955_at | METRNL | 17q25.3 | −3.94 |
| 234381_at | IGLC2 | 22q11.2 | −3.95 |
| 203037_s_at | MTSS1 | 8p22 | −3.96 |
| 211696_x_at | HBB | 11p15.5 | −4.02 |
| 216491_x_at | IGHM | 14q32.33 | −4.25 |
| 210450_at | LOC90925 | 14q32.33 | −4.31 |
| 211699_x_at | HBA1 | 16p13.3 | −4.86 |
| 214414_x_at | HBA2 | 16p13.3 | −5.01 |
| 217414_x_at | HBA2 | 16p13.3 | −5.02 |
| 204018_x_at | HBA1 | 16p13.3 | −5.06 |
| 209458_x_at | HBA1 | 16p13.3 | −5.08 |
| 211745_x_at | HBA1 | 16p13.3 | −5.15 |

Note:
+ Score means higher expression in MM than in MGUS.

In another embodiment of the present invention there is provided a method of predicting clinical outcome and survival of an individual by classification of disease into subsets based on genomic signature specific for the disease and its precursor state, identified by gene expression profiling as discussed supra, where the data obtained is subjected to significance analysis of microarray (SAM), unsupervised hierarchical cluster analysis and supervised colorgram analyses on Log2-transformed signal calls intensity values of the significance analysis of microarray-defined genes. Preferably, the disease state is multiple myeloma and the precursor state is monoclonal gammopathy of undetermined significance or smoldering multiple myeloma. Specifically, the cases of multiple myeloma clustering with cases of monoclonal gammopathy of undetermined significance are classified as monoclonal gammopathy of undetermined significance-like multiple myeloma and may have a favorable clinical outcome and survival. Additionally, the cases of monoclonal gammopathy of undetermined significance clustering with multiple myeloma cases are classified as multiple myeloma-like monoclonal gammopathy of undetermined significance and may have a high rate of conversion to multiple myeloma and thus poor clinical outcome and survival.

In yet, another embodiment of the present invention there is a method of relating specific genomic signatures of a disease to its molecular classification to predict the progression and evolution of the disease from its precursor state. Preferably, the disease is multiple myeloma and the precursor state is monoclonal gammopathy of undetermined significance or smoldering multiple myeloma. In general, the molecular classification of multiple myeloma constitutes either the CD-1 high-risk disease or the CD-2 low-risk disease. CD-1 high-risk disease is characterized by spiked expression of MMSET and MAF/MAFB and PROLIFERATION signature. CD-2 low-risk disease is characterized by HYPERDIPLOIDY, LOW BONE DISEASE and CCND1/CCND3 translocations. Specifically, the cases of multiple myeloma bearing monoclonal gammopathy of undetermined significance-like genomic signature constitute the molecular characteristics of the low-risk CD-2 disease and may have evolved from the precursor state.

In still yet another embodiment of the present invention there is a method of predicting clinical outcome and patient survival in patients suffering from multiple myeloma based on correlating genomic signatures of multiple myeloma with changes in gene copy number and progression of the disease. Generally, the changes in gene copy number may involve gain/amplification and/or loss/deletion of genetic material in any human chromosome. Specifically, the fluorescent in situ hybridization defined-amplification of chromosome 1q21 is absent in monoclonal gammopathy of undetermined significance, and is present in smoldering multiple myeloma patients associated with higher risk conversion to multiple myeloma, and its presence in multiple myeloma confers shorter survival.

In still yet another embodiment of the present invention there is a method of selecting treatment for an individual diagnosed with a disease, based on the specific genomic signature for said disease. Specifically, the individual with a genomic signature of multiple myeloma-like monoclonal gammopathy of undetermined significance (MM-L MGUS) may be selected for aggressive treatment and an individual with a genomic signature of monoclonal gammopathy of undetermined significance-like multiple myeloma (MGUS-like MM) may be selected for less aggressive forms of treatment.

As used herein, the term, “a” or “an” may mean one or more. As used herein in the claim(s), when used in conjunction with the word “comprising”, the words “a” or “an” may mean one or more than one. As used herein “another” or “other” may mean at least a second or more of the same or different claim element or components thereof.

The following examples are given for the purpose of illustrating various embodiments of the invention and are not meant to limit the present invention in any fashion. One skilled in the art will appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

### EXAMPLE 1

### Study Subjects

The International Myeloma Working Group criteria were used to classify the patients as having monoclonal gammopathy of undetermined significance, smoldering multiple myeloma and symptomatic multiple myeloma. For a diagnosis of monoclonal gammopathy of undetermined significance, levels of monoclonal protein could not exceed 30 g/L and of bone marrow infiltration with plasma cells 10%; there could not be any evidence of related organ or tissue impairment defined as hypercalcemia, renal impairment, anemia or bone lesions attributed to plasma cell proliferation. In the case of smoldering multiple myeloma, related organ or tissue impairment had to be absent but levels of bone marrow plasmacytosis exceeded 10% and of monoclonal protein 30 g/L.

The analysis described utilized samples from 22 healthy donors; 72 patients with monoclonal gammopathy of undetermined significance (MGUS) (n=56) or smoldering multiple myeloma (SMM) (n=16) or multiple myeloma with a monoclonal gammopathy of undetermined significance history (n=16) and 351 patients treated with Total Therapy 2 (TT2), a tandem transplant for symptomatic or progressive multiple myeloma (Barlogie B, et al., 2006). The test set comprised 214 patients with multiple myeloma enrolled in Total Therapy 3 (TT3) and 20 patients surviving greater than 10 years after treatment with Total Therapy 1 (TT1) (Barlogie B, et al., 2006). Table 4 lists laboratory parameters for the monoclonal gammopathy of undetermined significance/smoldering multiple myeloma (at diagnosis or progression to multiple myeloma) and for multiple myeloma (prior to initiation of therapy). In the case of monoclonal gammopathy of undetermined significance/smoldering multiple myeloma, data were also retrieved from records of the referring institution. Thirty-two subjects of the monoclonal gammopathy of undetermined significance/smoldering multiple myeloma group had been enrolled in a prospective observational Southwest Oncology Group study (SWOG 0210), which called for clinical staging with bone marrow biopsy, skeletal survey and magnetic resonance imaging at initial registration, and follow-up at 3-6 mo intervals.

TABLE 4
Patient characteristics of MGUS, SMM, MM from MGUS, TT1, TT2 and TT3 at diagnosis^{a}.

| 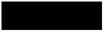 | 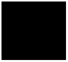 | 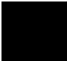 | 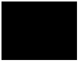 | 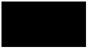 | 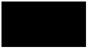 | 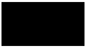 | 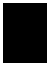 |
|---|---|---|---|---|---|---|---|
| Age ≧ 65 yr | 36 | 225 | 63 | 5 | 23 | 30 | .001 |
| 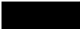 | 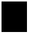 | 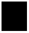 | 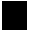 | 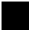 | 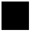 | 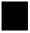 | 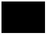 |
| White race | 84 | 92 | 25 | 80 | 29 | 89 | <.001 |
| 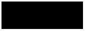 | 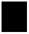 | 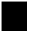 | 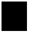 | 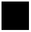 | 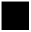 | 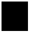 | 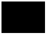 |
| B2M | 11 | 17 | 64 | 45 | 49 | 57 | <.001* |
| ≧3.0 mg/liter | | | | | | | |
| 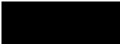 | 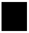 | 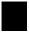 | 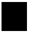 | 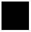 | 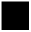 | 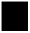 | 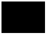 |
| Creatinine | 2 | 0 | 7 | 5 | 11 | 8 | NS |
| ≧2.0 mg/dl | | | | | | | |
| 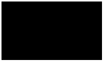 | 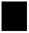 | 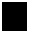 | 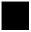 | 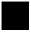 | 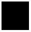 | 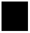 | 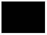 |
| Albumin | 2 | 8 | 6 | 30 | 14 | 14 | .049 |
| <3.5 g/dl | | | | | | | |
| 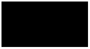 | 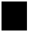 | 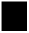 | 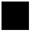 | 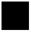 | 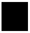 | 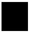 | 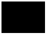 |
| Cytogenetic | 0 | 0 | 6 | 20 | 24 | 31 | <.001 |
| abnromalities | | | | | | | |
| 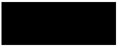 | 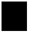 | 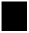 | 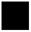 | 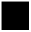 | 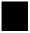 | 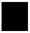 | 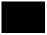 |
| MRI ≧ 1 | 0 | 25 | 25 | 62 | 72 | 73 | <.001 |

^{a}Fisher exact test, otherwise chi-square test.
# Values represent the percentage of cases with the specified variable

Plasma cells were purified from bone marrow aspirates of 72 patients, 56 with monoclonal gammopathy of undetermined significance and 16 with smoldering multiple myeloma (together termed “monoclonal gammopathy of undetermined significance”). Group A (19 monoclonal gammopathy of undetermined significance and 5 smoldering multiple myeloma) with documented stable disease parameters for at least 2.5 yr (median 4.3 yr, mean 5.5 yr; range, 2.5 yr to 14.5 yr) was used to identify monoclonal gammopathy of undetermined significance-genes; smoldering multiple myeloma cases included in this group had less than 20% plasma cells at latest follow-up. For Group B (25 monoclonal gammopathy of undetermined significance and 7 smoldering multiple myeloma), the most recent follow-up was less than 2.5 yr (median 1.5 yr, mean 2.0 yr; range 0 yr to 7.3 yr). Group C consisted of 16 patients with multiple myeloma converted from monoclonal gammopathy of undetermined significance (n=12) or smoldering multiple myeloma (n=4), the criteria of which pertained for at least 1 yr (median 4.5, mean 6.2; range, 1.1 yr to 19 yr).

### EXAMPLE 2

### Sample Processing and Molecular Analyses

Plasma cell isolation, total RNA extraction, complementary RNA synthesis and hybridizations to Affymetrix U133Plus2.0 microarrays were performed as described (Zhan F, et al., 2006). Significance Analysis of Microarray (Tusher V, et al., 2001) with a false discovery rate of 0.1% was performed to identify genes uniquely expressed in monoclonal gammopathy of undetermined significance by comparing half of the monoclonal gammopathy of undetermined significance cases (n=24) with normal plasma cells cases (n=22) and 351 multiple myeloma cases. Unsupervised hierarchical (Eisen M, et al., 1998) and supervised (Golub T R, et al., 1999) cluster analysis was employed on Log2-transformed signal calls intensity values of 52 significance analysis of microarray-defined genes.

Plasma cell isolation, total RNA extraction, complementary RNA synthesis and hybridizations to Affymetrix U133Plus2.0 microarrays were performed as described previously (Zhan F, et al., 2006). Differences between monoclonal gammopathy of undetermined significance (n=24; comprising group A) and normal plasma cells (n=22) were determined by first filtering out all genes with an absent detection call in greater than half of these samples or a Chi-square value of greater than >3.84. Significance analysis of microarray (Tusher V, et al., 2001), with a false discovery rate of 1% was then applied to 9,935 probe sets. A total of 2,864 genes probe sets were differentially expressed between the two groups. Genes making up a myeloid cell and/or normal plasma cell contamination signature were further subtracted. The contamination signature, including 5,351 probe sets, was defined by the comparison of 95 multiple myeloma contaminated by myeloid cells and/or normal plasma cells to 256 multiple myeloma without contamination (significance analysis of microarray false discovery rate<1%) (Zhan F, et al., 2006).

This lead to the identification of 2,181 genes probe sets, with 1,736 over-expressed and 444 under-expressed in monoclonal gammopathy of undetermined significance relative to normal plasma cells (refer to Table 2). By using the same strategy, a total of 458 genes with 161 over- and 297 under-expressed in monoclonal gammopathy of undetermined significance were found differentially expressed in a comparison between monoclonal gammopathy of undetermined significance (n=24; group A) and multiple myeloma (n=351) (Table 3). Using significance analysis of microarray-intersect analysis 52 genes were found to be significantly differentially expressed in both comparisons (refer to Table 5). Unsupervised hierarchical cluster analysis and supervised colorgram analyses were employed on Log2-transformed signal calls intensity values of the 52 significance analysis of microarray-defined genes.

TABLE 5
Fifty-two significance analysis of microarray-defined genes are differentially expressed in normal plasma
cells, monoclonal gammopathy of undetermined significance, and multiple myeloma^{a}.

| 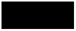 | 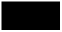 | 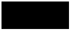 | 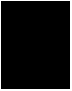 | 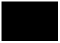 | 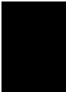 | 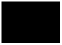 |
|---|---|---|---|---|---|---|
| 201486_at | RCN2 | unknown; calcium | 2.48 | 1.55 | 4.13 | 1.63 |
| | | binding, ER lumen | | | | |
| 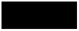 | 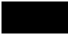 | 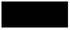 | 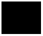 | 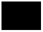 | 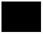 | 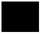 |
| 212846_at | KIAA0179 | unknown; nucleolar | 2.07 | 1.30 | 3.80 | 1.48 |
| | | protein | | | | |
| 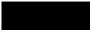 | 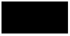 | 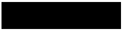 | 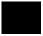 | 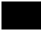 | 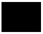 | 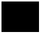 |
| 222673_x_at | TMEM57 | unknown; | 3.19 | 1.65 | 3.60 | 1.63 |
| | | transmembrane protein | | | | |
| 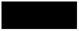 | 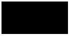 | 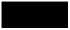 | 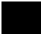 | 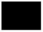 | 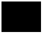 | 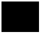 |
| 225223_at | SMAD5 | gene transcription | 3.12 | 1.70 | 3.43 | 1.41 |
| 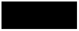 | 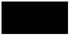 | 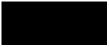 | 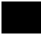 | 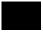 | 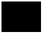 | 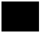 |
| 203216_s_at | MYO6 | recessive actin-based | 1.98 | 1.57 | 3.35 | 1.91 |
| | | motor | | | | |
| 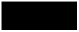 | 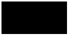 | 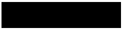 | 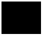 | 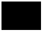 | 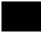 | 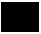 |
| 200910_at | CCT3 | molecular chaperone | 2.04 | 1.34 | 3.30 | 1.60 |
| 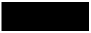 | 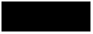 | 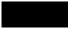 | 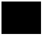 | 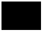 | 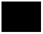 | 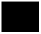 |
| 221207_{'}s_at | NBEA | protein kinase A | 3.42 | 1.83 | 3.22 | 2.49 |
| | | regulator | | | | |
| 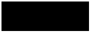 | 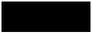 | 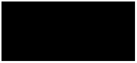 | 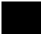 | 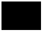 | 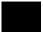 | 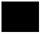 |
| 212038_s_at | VDAC1 | ion channel for | 1.62 | 1.56 | 3.17 | 1.42 |
| | | cytochrome c | | | | |
| 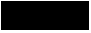 | 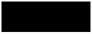 | 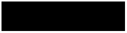 | 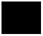 | 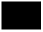 | 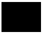 | 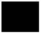 |
| 201013_s_at | PA1CS | DNA synthesis | 2.81 | 1.43 | 3.17 | 1.45 |
| 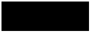 | 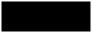 | 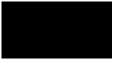 | 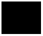 | 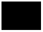 | 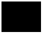 | 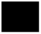 |
| 215071_s_at | HIST1H2AC | chromosome | 3.47 | 3.62 | 3.13 | 1.97 |
| | | organization and | | | | |
| | | biogenesis | | | | |
| 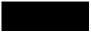 | 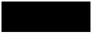 | 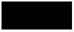 | 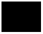 | 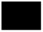 | 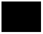 | 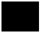 |
| 219366_at | AVEN | anti-apoptosis | 2.63 | 1.76 | 3.10 | 1.47 |
| 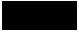 | 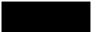 | 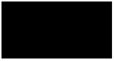 | 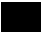 | 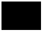 | 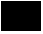 | 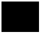 |
| 221652_s_at | C12orf11 | unknown; sarcoma | 2.07 | 1.37 | 3.06 | 1.57 |
| | | antigen | | | | |
| 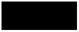 | 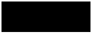 | 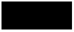 | 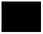 | 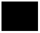 | 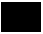 | 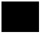 |
| 214214_s_at | C1QBP | immunity | 2.27 | 1.45 | 3.03 | 1.47 |
| 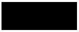 | 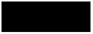 | 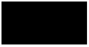 | 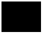 | 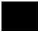 | 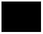 | 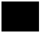 |
| 218280_x_at | HIST2H2AA | chromosome | 4.24 | 4.76 | 2.95 | 1.92 |
| | | organization and | | | | |
| | | biogenesis | | | | |
| 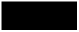 | 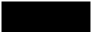 | 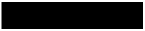 | 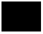 | 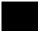 | 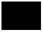 | 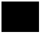 |
| 208864_s_at | TXN | redox reactions | 2.90 | 1.68 | 2.91 | 1.51 |
| 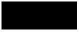 | 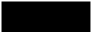 | 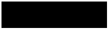 | 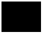 | 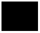 | 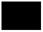 | 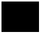 |
| 222825_at | OTUD6B | unknown | 2.66 | 1.35 | 2.88 | 1.40 |
| 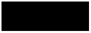 | 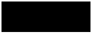 | 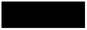 | 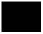 | 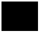 | 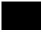 | 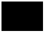 |
| 217898_at | C15orf24 | unknown | 2.35 | 1.70 | 2.83 | 1.33 |
| 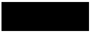 | 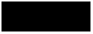 | 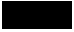 | 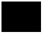 | 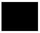 | 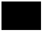 | 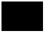 |
| 213485_s_at | ABCC10 | ATP-dependent efflux | 3.17 | 1.51 | 2.76 | 1.34 |
| | | pump; multidrug | | | | |
| | | resistance pump | | | | |
| 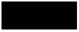 | 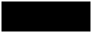 | 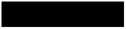 | 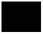 | 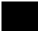 | 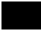 | 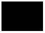 |
| 222428_s_at | LARS | protein synthesis | 3.64 | 1.68 | 2.71 | 1.32 |
| 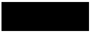 | 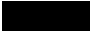 | 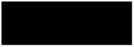 | 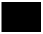 | 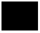 | 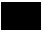 | 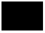 |
| 204244_s_aat | ASK | cell cycle | 3.25 | 1.77 | 2.67 | 1.37 |
| 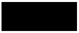 | 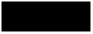 | 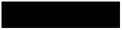 | 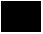 | 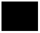 | 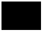 | 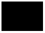 |
| 202396_at | TCERG1 | gene transcription | 3.85 | 1.62 | 2.63 | 1.32 |
| 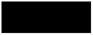 | 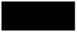 | 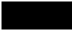 | 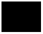 | 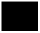 | 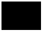 | 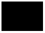 |
| 213340_s_at | KIAA0495 | unknown | −2.40 | 0.78 | 2.52 | 0.75 |
| 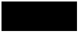 | 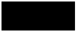 | 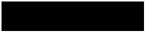 | 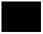 | 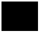 | 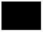 | 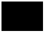 |
| 228139_at | RIPK3 | cell signaling | −2.63 | 0.74 | −2.59 | 0.77 |
| 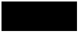 | 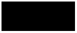 | 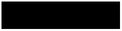 | 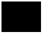 | 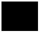 | 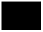 | 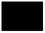 |
| 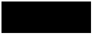 | 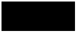 | 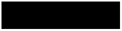 | 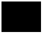 | 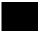 | 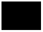 | 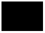 |
| 232511_at | RANDP2L1 | Nuclear improt | 2.07 | 1.54 | −2.71 | 0.64 |
| 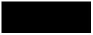 | 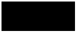 | 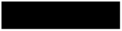 | 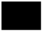 | 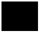 | 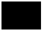 | 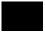 |
| 219371_s_at | KLF2 | gene transcription | 3.81 | 1.78 | −3.11 | 0.66 |
| 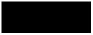 | 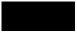 | 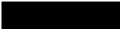 | 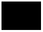 | 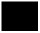 | 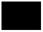 | 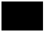 |
| 215671_at | PDE4B | drug metabolism | 2.07 | 1.53 | −3.30 | 0.59 |
| 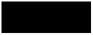 | 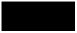 | 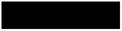 | 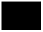 | 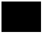 | 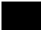 | 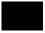 |
| 219675_s_at | UXS1 | glycosaminoglycan | −2.33 | 0.76 | 2.97 | 1.35 |
| | | biosynthesis | | | | |

^{a}genes are ordered based on the significance of microarray score in the MGUS v. MM comparison.
^{b}A positive significance analysis of microarray score in the MGUS v. NPC column indicates the gene expression is higher in MGUS relative to normal plasma cels.
^{c}A positive significance analysis of microarray score in the MM v. MGUS column indicates the gene is higher in MM relative to MGUS.

Approximately one-third of CD138-enriched cells from newly diagnosed cases in training and test sets had a myeloid cell gene expression signature attributable to contamination of the selected fraction with cells of this lineage. Such cases were not included in a previous molecular classification of multiple myeloma, as their bone marrow plasmacytosis was lower and survival superior. Bone marrow plasma cells proportions of subjects with monoclonal gammopathy of undetermined significance and normal donors are also low and therefore could also have myeloid cell contamination (Zhan F, et al., 2006). However, no significant difference was observed in the proportions with myeloid signature in monoclonal gammopathy of undetermined significance-like and non-monoclonal gammopathy of undetermined significance-like multiple myeloma of the training set (24% v. 28%; P=0.56), suggesting that the monoclonal gammopathy of undetermined significance-like designation was not an artifact of the cell purification procedure. For interphase fluorescent in situ hybridization analysis of abnormalities of chromosome 1q21 and 13q14, procedures described were employed (Hanamura 1, et al., 2006).

### EXAMPLE 3

### Statistical Analyses

The Kaplan-Meier Method was used to estimate overall survival, with group comparisons made using the log-rank test. Overall survival was defined from the date of registration until death from any cause; survivors were censored at the time of last contact. Univariate and multivariate analyses of prognostic factors were carried out using Cox regression. The cumulative incidence of Cox regression was estimated using the method outlined in Gooley et al., and compared using the log-rank test.

### EXAMPLE 4

### Clinical, Laboratory and Molecular Features in Subjects with Monoclonal Gammopathy of Undetermined Significance, Smoldering Multiple Myeloma and Multiple Myeloma

As expected, patients with multiple myeloma had features of greater tumor burden and aggressiveness than subjects with monoclonal gammopathy of undetermined significance or smoldering multiple myeloma (refer to Table 4). Thus, there were higher proportions of patients in the multiple myeloma group with elevations of beta-2-microglobulin (B2M), C-reactive protein (CRP), lactate dehydrogenase (LDH), creatinine and bone marrow plasmacytosis as well as lower levels of hemoglobin and albumin. Focal lesions were absent in all subjects with monoclonal gammopathy of undetermined significance but were present in 17% of smoldering multiple myeloma and 80% of patients with multiple myeloma, 59% of whom had at least 3 focal lesions. Cytogenetic abnormalities were absent in all monoclonal gammopathy of undetermined significance and smoldering multiple myeloma cases and present in one-third of patients with multiple myeloma. Patients with multiple myeloma evolved from monoclonal gammopathy of undetermined significance tended to be older and, as a group, had higher hemoglobin levels, fewer cytogenetic abnormalities, lower levels of marrow plasmacytosis and fewer magnetic resonance imaging lesions than patients with multiple myeloma, in whom a prior monoclonal gammopathy of undetermined significance/smoldering multiple myeloma history was not documented.

In a recent report on a validated molecular classification of multiple myeloma into seven disease subtypes, “spiked” expression of MMSET and AF/MAFB and PROLIFERATION signatures together constituted high-risk disease, whereas HYPERDIPLOIDY, LOW BONE DISEASE and CCND1/CCND3 translocations represented low-risk multiple myeloma. When applied to this training set, PROLIFERATION, MMSET and CCND-1 signatures were under-represented and LB and CCND-2 signatures over-represented in monoclonal gammopathy of undetermined significance/smoldering multiple myeloma; in contrast, HYPERDIPLOIDY and MAF/MAFB signatures were noted in similar frequencies in monoclonal gammopathy of undetermined significance and smoldering multiple myeloma relative to monoclonal gammopathy of undetermined significance-evolved multiple myeloma and multiple myeloma (refer to Table 1).

### EXAMPLE 5

### Identifying Genes Uniquely Dysregulated in Plasma Cells of Monoclonal Gammopathy of Undetermined Significance in the Context of Plasma Cells of Normal Subjects and Patients with Multiple Myeloma

Significance analysis of microarray intersection analyses identified 52 genes with differential expression levels across normal plasma cells, monoclonal gammopathy of undetermined significance and multiple myeloma; these were involved in cell cycle control, DNA synthesis, chromosome assembly, nuclear protein import, gene transcription, cell aging, cell signaling, metabolism, energy production, ion transport, reactive oxygen metabolism, drug resistance and programmed cell death/apoptosis (refer to Table 5). Of the 52 genes, 41 exhibited a progressive increase in expression levels along the transition from normal plasma cells to monoclonal gammopathy of undetermined significance to multiple myeloma, while 4 exhibited a progressive reduction in expression from normal plasma cells to monoclonal gammopathy of undetermined significance to multiple myeloma; 6 genes had higher and 1 gene lower expression levels in monoclonal gammopathy of undetermined significance relative to both normal plasma cells and multiple myeloma.

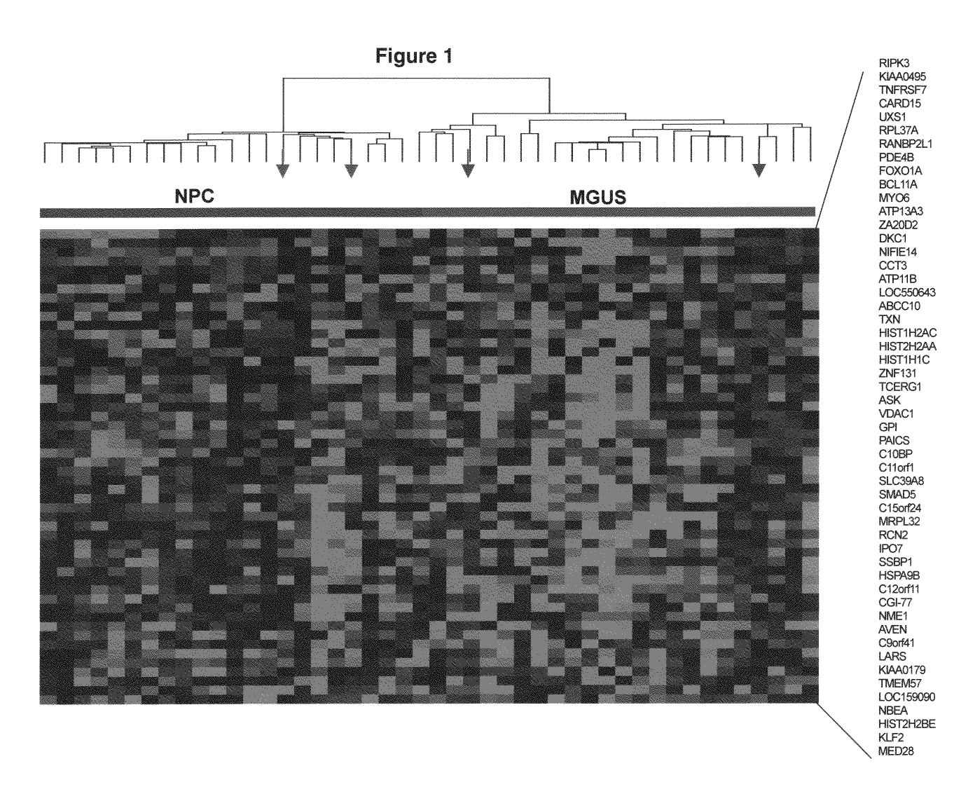

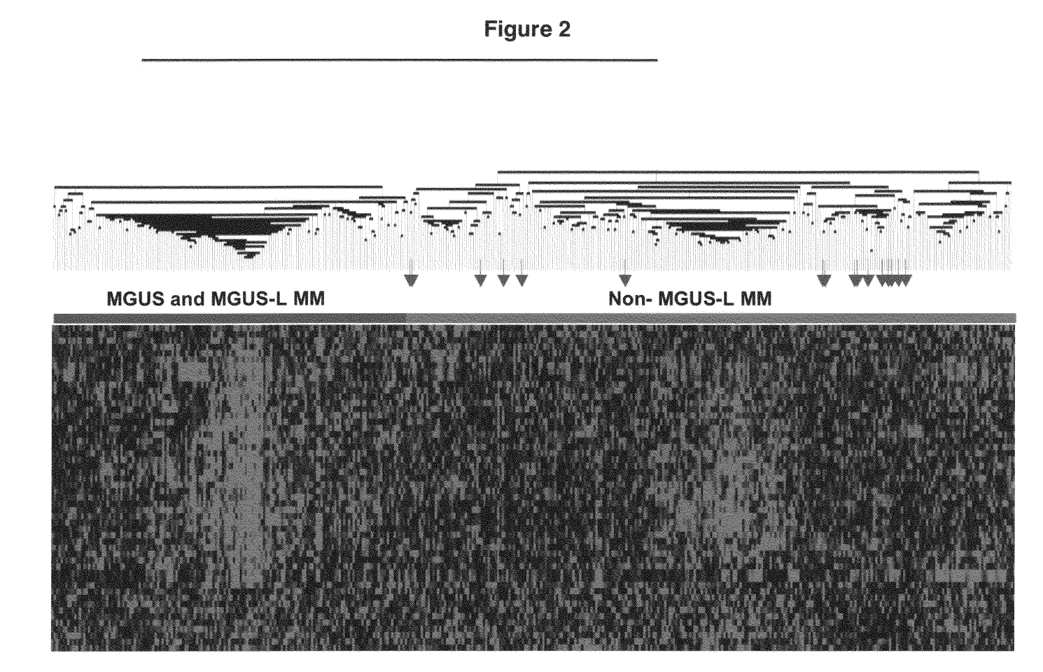

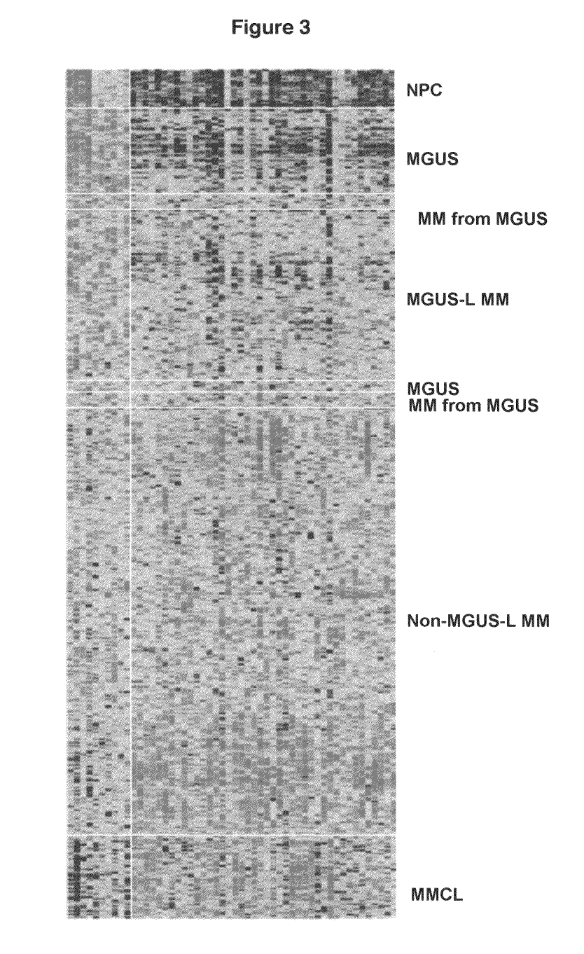

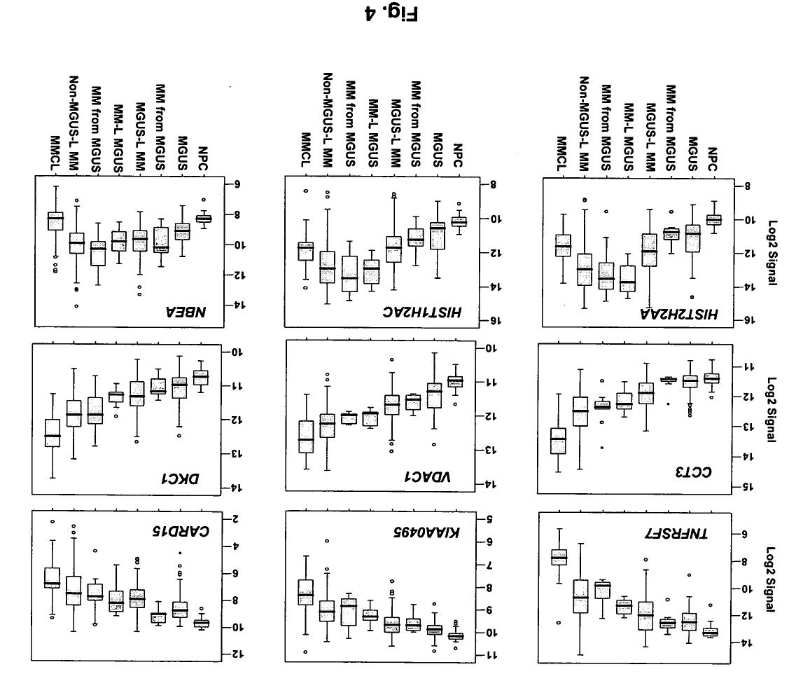

The differential expression of the 52 genes in the 22 normal plasma cells and 24 monoclonal gammopathy of undetermined significance cases was visualized through unsupervised hierarchical clustering (FIG. 1): 2 major branches were identified, one containing all but 2 of the monoclonal gammopathy of undetermined significance cases and the other comprising all but 2 of the normal plasma cells samples. When applied to the 72 cases of monoclonal gammopathy of undetermined significance or monoclonal gammopathy of undetermined significance-evolved multiple myeloma and the 351 multiple myeloma cases of the training group, the sample dendrogram produced 2 major branches, one containing 56 of 72 (78%) monoclonal gammopathy of undetermined significance cases together with 99 of 351 (28%) multiple myeloma cases including 7 of 16 (43%) of monoclonal gammopathy of undetermined significance-evolved multiple myeloma monoclonal gammopathy of undetermined significance; the second branch comprised 252 of the 351 (72%) of multiple myeloma and only 16 of 72 (22%) cases of monoclonal gammopathy of undetermined significance/smoldering multiple myeloma (FIG. 2). Multiple myeloma cases on the first branch were designated monoclonal gammopathy of undetermined significance-like multiple myeloma (MGUS-L MM), while those on the second branch were termed non-monoclonal gammopathy of undetermined significance-like (non-MGUS-L MM); the monoclonal gammopathy of undetermined significance cases on the second branch were designated multiple myeloma-like (MM-L MGUS). Supervised cluster analysis was used to provide a visualization of the differential expression of the 52 genes across the groups described along with normal plasma cells and human myeloma cell lines (MMCL) (FIG. 3). Normal plasma cells and multiple myeloma cell lines represent the extremes of benign and malignant plasma cells, and their plasma cells gene expression profiling signatures are consistent with this extreme divergence. Box plots of the expression of select genes are shown in FIG. 4. TNFSF7/CD27, KIAA0495 and CARD15 genes were progressively down-regulated, whereas CCT3, VDAC1 and DKC1 genes were progressively up-regulated in the transition from normal plasma cells to multiple myeloma cell lines. HIST1H2AC, HIST1H2AC and NBEA were representative of genes showing an increase from normal plasma cells to the monoclonal gammopathy of undetermined significance-like multiple myeloma with a reduction in expression seen in the non-monoclonal gammopathy of undetermined significance-like multiple myeloma and especially in multiple myeloma cell lines.

### EXAMPLE 6

### Relating Monoclonal Gammopathy of Undetermined Significance-Like and Non Monoclonal Gammopathy of Undetermined Significance-Like Signatures to Previously Identified Molecular Classes of Multiple Myeloma

Whether there were differences in the distribution of molecular subgroups in the monoclonal gammopathy of undetermined significance-like multiple myeloma and non-monoclonal gammopathy of undetermined significance-like multiple myeloma cases was determined next. Of the 351 cases of multiple myeloma used in the current analysis, 95 had been excluded because of myeloid expression signature from the molecular classification schema described previously (see Patients and Methods, Zhan F, et al., 2006) leaving 76 monoclonal gammopathy of undetermined significance-like and 180 non-monoclonal gammopathy of undetermined significance-like multiple myeloma for the 7-subtype molecular model (Table 6). A PROLIFERATION signature was absent in all monoclonal gammopathy of undetermined significance-like multiple myeloma and present in 29 (16%) of the non-monoclonal gammopathy of undetermined significance-like multiple myeloma (P<0.001) HYPERDIPLOIDY was less frequent in monoclonal gammopathy of undetermined significance-like multiple myeloma (5% v. 34%, P<0.001); CCND1-1 and CCND1-2 groups (characterized by spiked expression of CCND1 or CCND3) were more common in monoclonal gammopathy of undetermined significance-like multiple myeloma than in non-monoclonal gammopathy of undetermined significance-like multiple myeloma (15% v. 6%; P=0.038 for CCND1-1 and 47% v. 4%; p<0.001 for CCND1-2).

TABLE 6
Molecular subgroup distribution in monoclonal gammopathy of
undetermined significance-like multiple myeloma and non-monoclonal
gammopathy of undetermined significance-like multiple myeloma in
the training set.

| 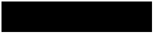 | 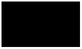 | 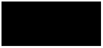 | 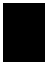 |
|---|---|---|---|
| PROLIFERATION | 0 | 16 | <.001 |
| 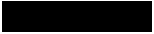 | 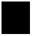 | 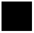 | 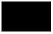 |
| MMSET | 12 | 19 | NS |
| 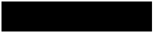 | 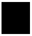 | 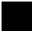 | 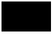 |
| CCND1-1 | 15 | 6 | 0.038 |
| 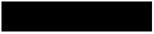 | 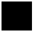 | 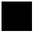 | 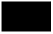 |
| MAF | 10 | 8 | NS |

### EXAMPLE 7

### A Monoclonal Gammopathy of Undetermined Significance-Like Signature is Associated with Favorable Clinical Characteristics and Superior Survival in Spite of Lower Incidence of Complete Remission

Relative to non-monoclonal gammopathy of undetermined significance-like multiple myeloma, monoclonal gammopathy of undetermined significance-like multiple myeloma was characterized by lower frequencies of elevated B2M (>3 mg/L) (33% v. 56%; P<0.001), CA (17% v. 42%; P<0.001), high-risk molecular subgroups (PROLIFERATION, MMSET or MAF) (22% v. 43%, P=0.001), elevated lactate dehydrogenase (LDH) (>upper limit of normal, ULN) (12% v. 26%; P=0.005) and bone marrow plasmacytosis (>30%) (56% vs 70%; P=0.0012) (Table 7).

TABLE 7
Patient characteristics in monoclonal gammopathy of undetermined significance-
like and non-monoclonal gammopathy of undetermined significance-
like multiple myeloma in the training set

| 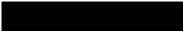 | 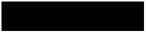 | 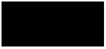 | 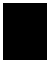 |
|---|---|---|---|
| B2M ≧ 3.0 mg/liter | 33 | 56 | <.001 |
| 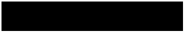 | 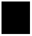 | 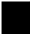 | 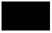 |
| Subgroups with poor progno- | 22 | 43 | 0.001 |
| sis (Proliferation/MMSET/ | | | |
| MAF) | | | |
| 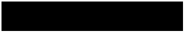 | 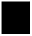 | 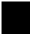 | 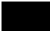 |
| Plasma cells (Aspirate) > 30% | 56 | 70 | 0.018 |

Variables with P > = .02: age, race, sex, isotype, creatinine, hemoglobin, MRI lesions, c-reactive protein and albumin

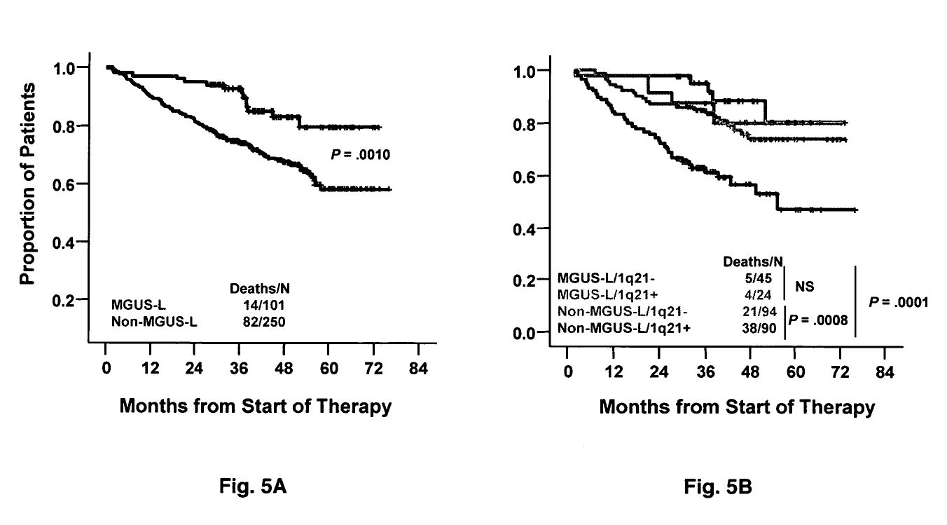

Despite a lower frequency of complete and near-complete remission in monoclonal gammopathy of undetermined significance-like multiple myeloma (P=0.006), such patients enjoyed a superior 5-yr survival than the remainder with non-monoclonal gammopathy of undetermined significance-like multiple myeloma (76% v. 59%, P=0.009) (FIG. 5A). Inter-phase fluorescence in situ hybridization-defined gains/amplification of 1q21 (amp1q21) in multiple myeloma tumor cells is associated with an inferior survival (Hanamura I, et al., 2006). When examined in 253 of the 351 cases, amp1q21 was less frequent in monoclonal gammopathy of undetermined significance-like multiple myeloma relative to non-monoclonal gammopathy of undetermined significance-like multiple myeloma (35% v. 49%, P=0.04). Importantly, the negative prognostic impact of amp1q21 was only seen in the non-monoclonal gammopathy of undetermined significance-like multiple myeloma group, whose 5-yr survival was 44% in the presence and 73% in the absence of amp1q21 (P=0.0008) and, thus, similar to monoclonal gammopathy of undetermined significance-like multiple myeloma (FIG. 5B). Chromosome 13 deletion, tested in 325 patients, was present with similar frequencies in monoclonal gammopathy of undetermined significance-like and non-monoclonal gammopathy of undetermined significance-like multiple myeloma (52% v. 49%, P=0.5) and was not linked to survival in either group.

On multivariate analysis, the non-monoclonal gammopathy of undetermined significance-like designation was an independent high-risk feature in addition to high-risk molecular subgroup designation, low albumin, high lactate dehydrogenase and presence of focal lesions on magnetic resonance imaging examination (Table 8).

TABLE 8
Multivariate proportional hazards analysis for overall survival in test set (N = 234^{†})

| 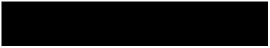 | 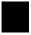 | 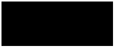 | | |
|---|---|---|---|---|
| | % | HR | 95% CI | P |
| 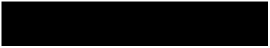 | 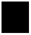 | 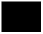 | 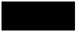 | 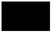 |
| LDH ≧ upper limit off normal | 21 | 2.27 | 1.35, 3.82 | 0.002 |
| 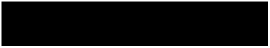 | 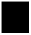 | 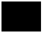 | 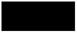 | 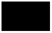 |
| Albumin < 3.5 g/dL | 16 | 1.92 | 1.09, 3.37 | 0.024 |
| 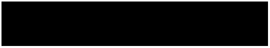 | 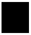 | 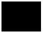 | 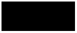 | 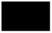 |

^{†}Total of 234 cases with complete data on all variables were available for the analysis. Only significant variables are shown.

### EXAMPLE 8

### Monoclonal Gammopathy of Undetermined Significance-Like Multiple Myeloma Signature is Linked to Low Risk Clinical and Molecular Characteristics in Separate Test Cohort of Newly Diagnosed Multiple Myeloma

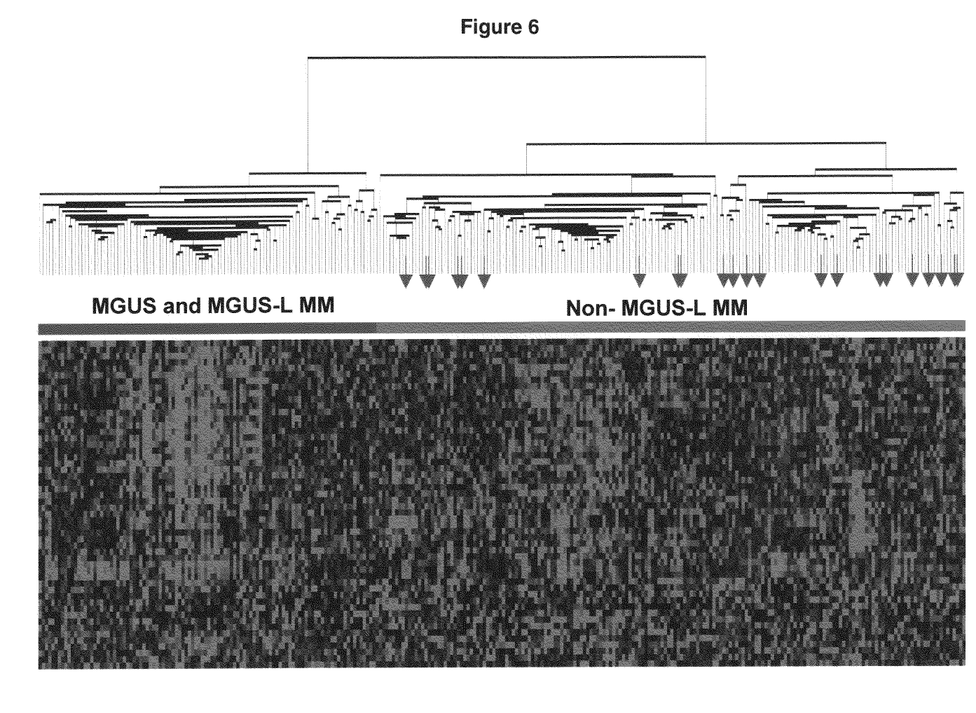

When applied to plasma cells of a separate cohort of 213 newly diagnosed multiple myeloma enrolled in Total Therapy 3 and evaluated in the context of the 72 cases of monoclonal gammopathy of undetermined significance and monoclonal gammopathy of undetermined significance-evolved multiple myeloma, two major branches in the sample dendrogram were noted in this test set: 58 of 72 (80%) monoclonal gammopathy of undetermined significance clustered together with 55 (26%) of 213 multiple myeloma cases (FIG. 6). As with the 28% of monoclonal gammopathy of undetermined significance-like multiple myeloma in the training group, the monoclonal gammopathy of undetermined significance-like multiple myeloma group of the test set comprised fewer cases with elevated beta-2-microglobulin (42% v 63%; P=0.006) and lactate dehydrogenase (7% v. 23%, P=0.012), cytogenetic abnormalities (16% v. 36%, P=0.006) and high-risk genetic subgroups (19% v. 41%, P=0.018) (Table 9). None of the monoclonal gammopathy of undetermined significance-like multiple myeloma cases in the test set had a PROLIFERATION signature, few belonged to the MMSET group, and CCND1-1 and CCND1-2 designations predominated (Table 10).

TABLE 9
Patient characteristics in monoclonal gammopathy of undetermined significance-
like and non-monoclonal gammopathy of undetermined significance-
like multiple myeloma in the test set.

| 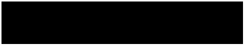 | 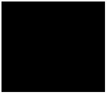 | 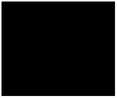 | 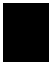 |
|---|---|---|---|
| B2M ≧ 3.0 mg/L | 42 | 63 | 0.006 |
| 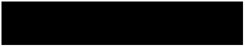 | 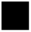 | 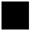 | 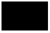 |
| LDH ≧ upper limit of normal | 7 | 23 | 0.012 |
| 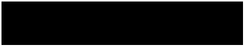 | 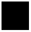 | 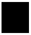 | 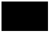 |

Variables with P > = .02: age, race, sex, isotype, creatinine, hemoglobin, magnetic resonance imaging lesions, c-reactive protein and albumin

TABLE 10
Distribution of molecular subgroups in monoclonal gammopathy off undetermined
significance-like multiple myeloma and non-monoclonal gammopathy of
undetermined significance-like multiple myeloma of test set.

| 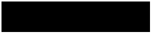 | 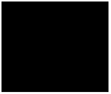 | 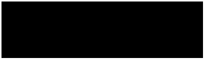 | 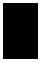 |
|---|---|---|---|
| PROLIFERATION | 0 | 14 | <.001 |
| 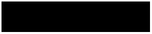 | 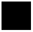 | 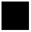 | 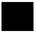 |
| MMSET | 3 | 18 | <.001 |
| 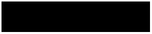 | 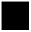 | 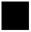 | 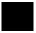 |
| CCND1-1 | 13 | 2 | .003 |
| 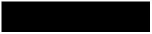 | 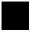 | 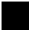 | 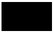 |
| MAF | 15 | 9 | NS |

### EXAMPLE 9

### Long Term Survivors have an Monoclonal Gammopathy of Undetermined Significance-L Signature

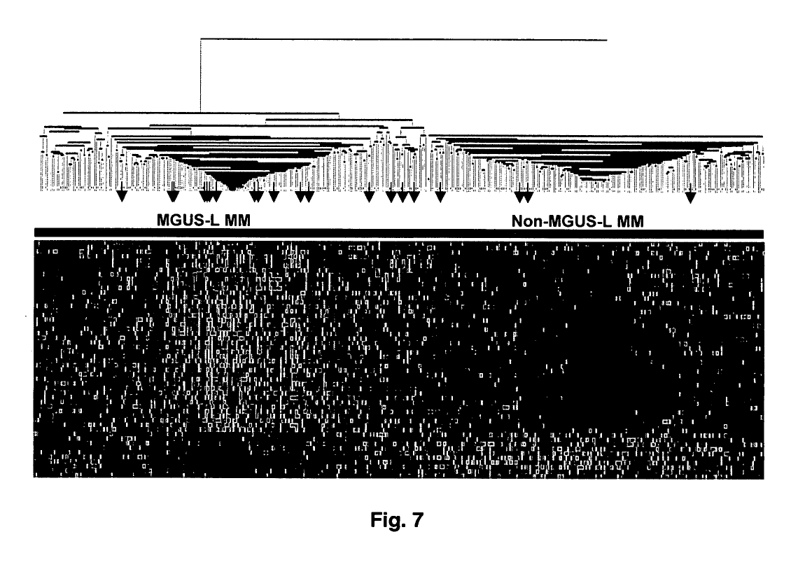

Finally, unsupervised hierarchical cluster analysis of CD138-selected plasma cells of 20 patients with multiple myeloma surviving more than 10 years after initiation of Total Therapy 1 was performed, (Barlogie B, et al., 2006) together with the 72 monoclonal gammopathy of undetermined significance and the 351 newly diagnosed multiple myeloma cases in the training set (FIG. 7). The sample dendrogram had 2 main branches, one containing all monoclonal gammopathy of undetermined significance and monoclonal gammopathy of undetermined significance-like multiple myeloma and 15 of 20 (75%) of the long-term survivors (P<0.001). Expression spikes for MAF and MAFB (with CCND2 over expression), CCND1 and CCND3 were observed in the TT1 plasma cells. The presence of spikes had no influence on whether the sample was defined as being monoclonal gammopathy of undetermined significance-like versus non-monoclonal gammopathy of undetermined significance-like.

### The Following References are Cited Herein:

Ablashi D V, et al., (2000) Blood; 96:2304-2306.
Barlogie B, et al., (2006) Blood; 107:2633-2638.
Barlogie B, et al., (2006) N Engl J Med; 354:1021-1030.
Blade J, and Rosinol L, (2006) Curr Treat Options Oncol; 7:237-245.
Carrasco D, et al., (2006) Cancer Cell; 9:313-325.
Chng W J, et al., (2005) Blood; 106:2156-2161.
Cox D R, (1972) J Royal Statistical Soc B; 34:187-202,
Davies F E, et al., (2003) Blood; 102:4504-4511.
Durie B G, (2001) Semin Hematol; 38:1-5.
Eisen M, (1998) Proc Natl Acad Sci USA; 95:14863-14888.
Fonseca R, et al., (2002) Blood; 100:1417-1424.
Golub T R, et al., (1999) Science; 286:531-537.
Gooley T A, et al., (1999) Stat Med; 18:695-706,
Guikema J E, et al., (2003) Br J Haematol; 121:36-43.
Hardin J, et al., (2004) Mol Biol; 3:Article10.
Kaufmann H, et al., (2004) Leukemia; 18:1879-1882.
Kyle R A, et al., (2002) N Engl J Med; 346:564-569.
Kyle R A, et al., (2006) N Engl J Med; 354:1362-369.
Lynch H T, et al., (2005) J Clin Oncol; 23:685-693.
Moreau P, et al., (2006) Br J Haematol; 132:168-170.
Neriishi K, et al., (2003) Br J Haematol; 121:405-1410.
Rajkumar S V, (2005) Hematology (Am Soc Hematol Educ Program):340-345.
Rosinol L, et al.; (2005) Br J Haematol; 130:729-32.
Shaughnessy J D, et al., (2003) Blood; 101:3849-3856.
Tilsdale J F, et al., (1998) Blood; 92:2681-2687.
Tusher V, et al., (2001) Proc Natl Acad Sci USA; 98:5116-5121.
Zhan F, et al., (2002) Blood; 99:1745-1757.
Zhan F, et al., (2006) Blood; 108(6):2020-2028.

What is claimed is:

1. A method of gene expression profiling to identify genomic signatures specific for a disease comprising:
isolating plasma cells from individuals within a population;
extracting nucleic acid from said plasma cells;
hybridizing said nucleic acid to a DNA microarray; and
performing comparative analysis on data obtained from said hybridization, wherein said analysis identifies specific genomic signatures for said disease.

2. The method of claim 1, wherein said genomic signature comprises:
genes differentially expressed in plasma cells from a precursor form of the disease in comparison to expression of said gene(s) in normal plasma cells, and/or plasma cells from the disease.

3. The method of claim 1, wherein said disease is multiple myeloma.

4. The method of claim 1, wherein said disease is in its precursor form of monoclonal gammopathy of undetermined significance or smoldering multiple myeloma.

5. The method of claim 2, wherein said genes are ABCC10, ASK, ATP11B, ATP13A3, AVEN, BCL11A, C11orf1, C12orf11, C15orf24, C1QBP, C9orf41, CARD15, CCT3, DKC1, FOXO1A, GPI, HIST1H1C, HIST1H2AC, HIST2H2AA, HIST2H2BE, HSPA9B, IPO7, KIAA0179, KIAA049, KLF2, LARS, LOC15909, LOC550643, MED28, MRPL32, MYO6, NBEA, NIFIE14, NME1, OTUD6B, PAIC, PDE4B, RANBP2L1, RCN2, RIPK3, RPL37A, SLC39A8, SMAD5, SSBP1, TCERG, TMEM57, TNFRSF7, TXN, UXS1, VDAC1, ZA20D2, and ZNF131.

6. The method of claim 1, further comprising performing significance analysis of microarray intersection analysis and unsupervised hierarchical clustering analysis on data obtained from said hybridization, wherein said analysis classifies the subset of disease, based on the genomic signature, thereby predicting clinical outcome and survival of said individual.

7. The method of claim 6, wherein said subset classification is monoclonal gammopathy of undetermined significance-like multiple myeloma and comprises: multiple myeloma cases that cluster with cases of monoclonal gammopathy of undetermined significance.

8. The method of claim 6, wherein said subset classification is non-monoclonal gammopathy of undetermined significance-like multiple myeloma and comprises multiple myeloma cases that fail to cluster with cases of monoclonal gammopathy of undetermined significance.

9. The method of claim 6, wherein said subset classification is multiple myeloma-like monoclonal gammopathy of undetermined significance and comprises monoclonal gammopathy of undetermined significance cases that cluster with multiple myeloma and predicts high risk of conversion to multiple myeloma.

10. A method of predicting clinical outcome and patient survival in an individual diagnosed with from multiple myeloma comprising:
correlating the genomic signature of multiple myeloma with amplification of chromosome 1q21; wherein said correlation predicts the clinical outcome and survival of said individual.

11. The method of claim 10, wherein said genomic signature specific for a disease is identified by gene expression profiling; comprising:
isolating plasma cells from individuals within a population
extracting nucleic acid from said plasma cells;
hybridizing said nucleic acid to a DNA microarray; and
performing comparative analysis on data obtained from said hybridization, wherein said analysis identifies specific genomic signature for said disease.

12. The method of claim 10, wherein said genomic signature comprises: genes differentially expressed in plasma cells from precursor form of the disease in comparison to expression of said gene(s) in normal plasma cell, and/or plasma cell from the disease.

13. The method of claim 10, wherein said precursor form is monoclonal gammopathy of undetermined significance or smoldering multiple myeloma and the disease is multiple myeloma.

14. The method of claim 12, wherein said genes are ABCC10, ASK, ATP11B, ATP13A3, AVEN, BCL11A, C11orf1, C12orf11, C15orf24, C1QBP, C9orf41, CARD15, CCT3, DKC1, FOXO1A, GPI, HIST1H1C, HIST1H2AC, HIST2H2AA, HIST2H2BE, HSPA9B, IPO7, KIAA0179, KIAA049, KLF2, LARS, LOC15909, LOC550643, MED28, MRPL32, MYO6, NBEA, NIFIE14, NME1, OTUD6B, PAIC, PDE4B, RANBP2L1, RCN2, RIPK3, RPL37A, SLC39A8, SMAD5, SSBP1, TCERG, TMEM57, TNFRSF7, TXN, UXS1, VDAC1, ZA20D2, and ZNF131.

15. The method of claim 11, wherein said genomic signature is monoclonal gammopathy of undetermined significance-like multiple myeloma or non-monoclonal gammopathy of undetermined significance-like multiple myeloma or multiple myeloma-like monoclonal gammopathy of undetermined significance.

16. The method of claim 11, wherein a combined genomic signature of monoclonal gammopathy of undetermined significance-like multiple myeloma and no amplification of chromosome 1q21 predicts superior clinical outcome and survival.

17. The method of claim 11, wherein a combined genomic signature of non-monoclonal gammopathy of undetermined significance-like multiple myeloma and amplification of chromosome 1q21 predicts poor clinical outcome and survival.

18. A method of selecting treatment for an individual suffering from disease comprising:
isolating plasma cells from individuals within a population
extracting nucleic acid from said plasma cells;
hybridizing said nucleic acid to a DNA microarray; and
performing comparative analysis on data obtained from said hybridization, wherein said analysis identifies specific genomic signature for said disease and is the basis for selected treatment of said disease.

19. The method of claim 18, wherein said genomic signature comprises:
genes differentially expressed in plasma cells from precursor form of the disease in comparison to expression of said gene(s) in normal plasma cell, and/or plasma cell from the disease.

20. The method of claim 19, wherein said precursor state is monoclonal gammopathy of undetermined significance or smoldering multiple myeloma and the disease is multiple myeloma.

21. The method of claim 19, wherein said genes are consisting of ABCC10, ASK, ATP11B, ATP13A3, AVEN, BCL11A, C11orf1, C12orf11, C15orf24, C1QBP, C9orf41, CARD15, CCT3, DKC1, FOXO1A, GPI, HIST1H1C, HIST1H2AC, HIST2H2AA, HIST2H2BE, HSPA9B, IPO7, KIAA0179, KIAA049, KLF2, LARS, LOC15909, LOC550643, MED28, MRPL32, MYO6, NBEA, NIFIE14, NME1, OTUD6B, PAIC, PDE4B, RANBP2L1, RCN2, RIPK3, RPL37A, SLC39A8, SMAD5, SSBP1, TCERG, TMEM57, TNFRSF7, TXN, UXS1, VDAC1, ZA20D2, and ZNF131.

22. The method of claim 18, wherein said genomic signature is monoclonal gammopathy of undetermined significance-like multiple myeloma or non-monoclonal gammopathy of undetermined significance-like multiple myeloma or multiple myeloma-like monoclonal gammopathy of undetermined significance.

23. The method of claim 18, wherein plasma cells from an individual bearing the genomic signature of multiple myeloma-like monoclonal gammopathy of undetermined significance indicates high risk and are selected for secondary prevention trials.

24. The method of claim 18, wherein plasma cells from an individual bearing the genomic signature of monoclonal gammopathy of undetermined significance-like multiple myeloma indicates low risk and are selected for less aggressive treatment strategies.
